(19) United States
(12) Patent Application Publication
(10) Pub. No.: US 2007/0168217 A1
(43) Pub. Date: Jul. 19, 2007

(54) Method And System For Improved User Management Of A Fleet Of Vehicles

(75) Inventors: Daniel Alan Weas, St. Louis, MO (US); Mandar R. Pathak, St. Louis, MO (US); David A. Moynan, St. Louis, MO (US); Thomas A. Schuette, St. Charles, MO (US); Edward W. Spitzer, Ascot, Berkshire, England (GB)

Correspondence Address: THOMPSON COBURN, LLP, ONE US BANK PLAZA, SUITE 3500, ST LOUIS, MO, 63101, US

(73) Assignee: THE CRAWFORD GROUP, INC., St. Louis, MO (US)

(21) Appl. No.: 11/677,932

(22) Filed: Feb. 22, 2007

Related U.S. Application Data
(63) Continuation-in-part of application No. 11/243,723, filed on Oct. 5, 2005.
Application No. 11/243,723 is a continuation-in-part of application No. 10/959,925, filed on Oct. 6, 2004.

(51) Int. Cl. G05D 1/00; G06Q 99/00

(52) U.S. Cl. 705/1

(57) ABSTRACT

A system and method for managing a fleet of vehicles provides users of the system with improved functionality that may include features such as one-way rental activity tracking, user-configurable fleet definitions, monitoring vehicle eligibility for sale as a used vehicle on the basis of pre-existing agreements, the ability to designate fleet vehicles as flex vehicles, the ability to compare one subfleet's vehicle residual value estimations with another subfleet's vehicle residual value estimations, and the ability to monitor post-purchase events that may adjust a fleet vehicle's cost of continued ownership.

### CROSS-REFERENCE AND PRIORITY CLAIM TO RELATED APPLICATIONS

This application is a continuation-in-part of pending U.S. patent application Ser. No. 11/243,723, entitled “Method and System for User Management of a Fleet of Vehicles Including Long Term Fleet Planning”, filed Oct. 5, 2005 and published as U.S. Patent Application Publication 2006/0074707, which is a continuation-in-part of pending U.S. patent application Ser. No. 10/959,925, entitled “Method and System for Managing a Fleet of Vehicles”, filed Oct. 6, 2004 and published as U.S. Patent Application Publication 2006/0074702, the entire disclosures of each of which are incorporated herein by reference.

### FIELD OF THE INVENTION

The present invention relates to the field of fleet management. In particular, the present invention relates to the management of a plurality of vehicles comprising a fleet so that informed decisions can be made as to the addition of vehicles to and/or the deletion of vehicles from the fleet.

### BACKGROUND OF THE INVENTION

Companies that maintain a fleet comprising numerous vehicles are faced with a daunting challenge with respect to how to effectively track and cost manage the fleet. Among the difficult questions that face fleet managers include which vehicles to delete from the fleet and when to do so. This is a difficult task for companies that maintain a relatively small fleet of vehicles much less for companies (such as the assignee of the present invention) that maintain a large fleet of vehicles.

For example, at any given time, the assignee of the present invention maintains a fleet of approximately 650,000 vehicles (including rental vehicles and leased vehicles), a number that is constantly growing with time. Not only does this fleet population represent a vast number, but it also must be noted that this fleet is divided into numerous geographically separated subfleets, each subfleet having its own characteristics that affect management decisions relating thereto, thereby further complicating the fleet management process. To effectively operate a rental vehicle business, the rental company must effectively plan and cost manage the influx and outflux of rental vehicles from the fleet. On the basis of value depreciation, rental vehicles will need to be timely deleted from the rental fleet and shifted to the used vehicle sales (remarketing) market.

Toward this end, the assignee of the present invention had previously developed and implemented a fleet planning system that allowed users to enter residual values for vehicles in the fleet at the year, make, model, and series (YMMS) level (wherein “series” specifies a particular series, body style, version, etc. of a particular YMM), determine the cost going forward (CGF) for each YMMS based on the user-entered residual value estimations, and designate a total number of vehicles within a particular YMMS that are to be deleted from the fleet. While this system certainly provided value and efficiency to the fleet planning process, room for improvement still existed. For example, this fleet planning system did not provide any historical sales data about fleet YMMSs to users to help guide their residual value estimations. Accordingly, users had only their own business sense to rely upon when estimating a residual value for a fleet YMMS. Further still, users were unable to schedule specific vehicles for deletion from the fleet and were instead provided only the ability to designate a total number of vehicles within a YMMS that were to be deleted.

Additionally, the assignee of the present invention also previously developed and implemented a fleet data warehouse application that allowed users to submit queries to a fleet database and receive (in response to the queries) simplified arithmetic averages of raw data for past vehicle sales. However, with this previous data warehouse application, due to the nature of these simplified raw data averages, users were unable to efficiently compare year-to-year and month-to-month trends in sales price because comparing these different average values was similar to comparing apples to oranges.

### SUMMARY OF THE INVENTION

In an effort to improve upon previous efforts at fleet management, the inventors herein have previously developed a system that analyzes historical sales data for vehicles that were previously sold as used vehicles, normalizes this historical sales data to a particular value for a parameter common to the historical sales, and presents the results derived from this normalization to users, as described in the parent patent applications. By providing users with detailed historical sales data drawn from previous sales of vehicles, users are able to take advantage of normalized historical sales data to temper their own business judgments as to how a particular vehicle type's residual value can be accurately estimated, which the inventors believe will enable users to more accurately forecast future residual values. Because residual value estimations are one of the driving forces behind determining how many of a particular vehicle type are to be deleted from a fleet, accuracy in residual value estimation is highly important in the fleet management process.

Preferably, the historical sales data analysis provided by the parent invention for a particular vehicle type (such as YMMS) is based on, at least in part, the actual sales prices for previously sold vehicles of the same or similar YMMS and the actual odometer reading for those vehicles at the time of sale. From these data values, a calculation is made as to what the average odometer reading was for those vehicles at their times of sale. Thereafter, each vehicle's sale price can be normalized to this average odometer reading such that each vehicle is assigned an adjusted sales price that matches what that vehicle would have been expected to sell for if that vehicle had the average odometer reading on its odometer at the time of sale. In the U.S. and other countries that use miles as the unit of measure for distances traveled by vehicles, it is preferred that the odometer readings be expressed in terms of mileage. For countries that use kilometers as the appropriate unit of measure, it is preferred that the odometer readings be expressed in terms of kilometers. To aid in this normalization process, a table that relates vehicle value to a time of sale odometer reading, referred to herein in a preferred U.S. embodiment as a cost per mile table, can be used. These normalized sales prices can then be averaged together to determine, for vehicles within a YMMS that is the same or similar to a user-selected YMMS, an average sales price normalized to an average mileage.

Also, to further provide the user with detailed historical sales data, this average mileage determination and sales price normalization can be performed on a per month basis such that the average mileage analysis for a particular month only covers the sales of vehicles within a same or similar YMMS that occurred in that particular month, with the year of sale effectively being disregarded. The sales price normalization and averaging can be performed per YMMS per month. Having done so, users can be provided with a data table that identifies for each month of any given year: (1) an average mileage for vehicles within a same or similar YMMS that were sold in that month and (2) an average normalized sales price for vehicles within each YMMS that were sold in that month. This historical data can be generated and displayed going back several years if desired by a practitioner of the parent invention. Having historical sales values normalized to average mileages for the same or similar YMMSs sold in specific months allows users to easily compare year-to-year changes in YMMS sales price as well as month-to-month sales trends.

To aid the system in pooling historical sales data for a user-selected YMMS, a mapping program can be made available to users that allows users to group a plurality of previous year YMMSs (and possibly current year YMMSs) to a particular current year YMMS. Sales data for these grouped YMMSs will then be analyzed in accordance with the techniques described above to generate the average mileages and the average normalized sales prices. The YMMS group corresponding to a user-selected YMMS would thus comprise the user-selected YMMS and any other YMMS(S) deemed to be similar to the user-selected YMMS. An example will help illustrate this mapping process. To perform a historical sales analysis for a hypothetical YMMS of a 2004 MKE MDL SER, the system will preferably perform the above-described historical sales analysis for the 2003 MKE MDL SER, the 2002 MKE MDL SER, and so on for previous vehicles that are deemed by the user to be sufficiently similar to the user-selected YMMS. To enable this historical analysis, it is preferred that such older YMMSs (the 2003 and older MKE MDL SERS) be grouped with the current YMMS (the 2004 MKE MDL SER). Once the YMMS are so grouped into a common YMMS group, the software of the parent invention will know which sales data stored in the database should be accessed to perform the historical analysis.

The data table described above for normalized historical sales data for each month applicable to a user-selected YMMS can be displayed by the system to users via a page on the user's computer monitor. This page preferably also allows the users to enter residual value estimates for that YMMS for the current month and a plurality of future months. Once the user enters these residual value estimates, the system can perform a CGF analysis on the user-entered residual values. This CGF analysis preferably generates and displays a CGF for the user-selected YMMS.

To flag vehicles for deletion, at least partially on the basis of the user's analysis of these CGF values, the system preferably provides the user with the ability to access a list of specific vehicles within a YMMS to which the CGF analysis pertains, each vehicle preferably being listed along with its current mileage, wherein the list allows the user to select specific vehicles for deletion. Upon selection by the user of one or more specific vehicles for deletion from the list, a message can be sent to a branch manager or other person in charge of a selected vehicle that the vehicle can be timely transferred out of the rental fleet and into the used vehicle (remarketing) market. Alternatively, a flag can be added to a vehicle database record that notifies interested persons that the selected vehicle(s) is to be transferred out of the rental fleet and into the used vehicle market.

These management capabilities can be put into use for both short term (less than 6 months into the future) and long term (6 months or more into the future) fleet planning. These planning processes can be conducted at scheduled times each year, or on an ongoing rolling basis (including a daily basis), by a practitioner of the invention. For example, the parent invention can be applied toward assessing the long term vehicle needs of a rental vehicle fleet such as how many vehicles need to be purchased during a given time period to satisfy the projected fleet needs of the rental business. Typically, this long term assessment of fleet needs involves a substantial amount of guesswork that requires extensive fleet experience and business acumen from users for effective results. While this guesswork can never be entirely eliminated from long term fleet planning (LTFP), the inventors herein believe that a system can be designed that allows users to make intelligent and informed decisions when assessing future vehicle needs, when deciding which vehicles should be deleted from the rental fleet and disposed of on the used vehicle market, and when deciding how many vehicles need to purchased over a future time period to meet the expected fleet needs giving due consideration to the number of vehicles that are scheduled for deletion from the fleet in the future. In an effort to fill this need in the art, the inventors herein have designed a system configured to execute a LTFP workflow. An “LTFP workflow” as used herein refers to a plurality of discrete but interrelated tasks within a long term fleet planning process whose individual completions contribute to the determination of a total quantity of vehicles to purchase for delivery to the fleet throughout a future time period.

One of the constituent tasks of the LTFP workflow preferably comprises a task to assess the current state of the fleet (e.g., current counts of vehicles within different YMMSs and vehicle classes for the fleet). Another of the constituent tasks of the LTFP workflow preferably comprises a task to define a desired size and mix of vehicles for the fleet at a plurality of points in time during the future. Another of the constituent tasks of the LTFP workflow preferably comprises a task to assess the quantity of new vehicles that are expected to be incoming to the fleet in the future but prior to the future time period. Another of the constituent tasks of the LTFP workflow preferably comprises a task to perform a future cost estimate analysis such as a cost going forward analysis on vehicles within the fleet based on user-specified residual values to identify how many and what types of vehicles should be deleted from the fleet in the future. This task preferably includes a user interface screen that displays normalized historical sales data as described herein to aid users in the process of intelligently defining residual vehicle values. Another task of the LTFP workflow preferably comprises a task to perform a future cost estimate analysis such as a depreciation analysis and/or a cycling analysis to identify how many and what types of vehicles should be deleted from the fleet in the future. Another task of the LTFP workflow preferably comprises a task to distribute future deletions over predetermined time intervals. Yet another constituent task of the LTFP workflow preferably comprises a task to compute the total quantity of vehicles to purchase for inclusion in the fleet during the future time period. This computation is based on the results of previous tasks of the LTFP workflow.

This LTFP workflow can be implemented by a plurality of user computers that share access to a server having a software program resident thereon that executes the LTFP process. The software program preferably provides a plurality of user interface screens to the user computers for display thereon, wherein the user interface screens are configured to interact with the users to accomplish the constituent tasks of the LTFP process. In a preferred embodiment, data entry and data display for fleet vehicles via these interface screens is typically organized by vehicle class or YMMS. However, it should be noted that data entry and data display for fleet vehicles can be organized into other units, e.g., by individual vehicles, by vehicle features, by vehicle manufacturer, by customer (wherein different fleets within the overall fleet are operated by different customers of the business organization), etc.

Furthermore, the software program can be configured to allow different user computers to simultaneously access a plurality of different tasks of the workflow to promote parallelism and enhance the efficiency with which LTFP can be accomplished. The software program preferably further tracks task completion statuses to ensure that asynchronous modifications to tasks will not disrupt downstream tasks. Also, the software program can be configured to allow the LTFP process to be performed individually for different subfleets within the fleet, thereby further enhancing the distributed nature with which the LTFP process can be accomplished.

The present invention further extends the functionality and capabilities of this fleet management system. According to one aspect of the present invention, the system is configured to track and display the one-way rental activity for a rental vehicle fleet, thereby providing fleet managers with accurate and up-to-date information as to the vehicles that are arriving and departing from the fleet as a result of one-way rental activity. Such one-way rental activity may affect the fleet manager's decisions as to how many new vehicles are needed for the fleet and/or how many existing fleet vehicles should be pulled for resale on the used vehicle market. The tracking of one-way rental activity within a fleet management system one can be particularly useful for a company whose business model divides up a large fleet of vehicles into geographically separated subfleets. In such a business model, one-way rental activity may cause a rental vehicle in one subfleet to depart that subfleet for another (e.g., a Los Angeles-to-New York one-way rental).

According to another aspect of the present invention, users of the fleet management system are given a higher degree of control over defining the vehicles to be included in a specified fleet of interest. Through a filter control window, users can enter a number of criteria for retrieving vehicle data from a fleet database and controlling how that vehicle data is displayed in a graphical user interface (GUI) page. Thus, once a specific set of vehicles has been brought forward through the fleet filtering controls, users of the fleet management system can navigate back and forth to evaluate that specific fleet by reviewing their residual values, depreciation and holding costs as well modifying or saving these values and costs for future use. Further, the fleet management system in using the fleet filtering controls helps fleet managers tie and refine their high-level targets for deletion decisions at higher granular levels of fleet details. Further still, users can adjust deletion estimates at low level (e.g. vehicle detail level), wherein the fleet management system is configured to automatically reflect those changes at higher levels (e.g., a fleet-wide summary level), thereby giving users the ability to refine their original high-level targets.

According to yet another aspect of the present invention, business rules that determine a vehicle's eligibility for activation are applied to vehicle data in the database to thereby inform users as to whether a vehicle is eligible for activation. For example, many vehicles are bought from manufacturers with an agreement that the vehicle will not be resold as a used vehicle until either or both of a mileage condition and a time of ownership condition have been met. By tracking which vehicles are eligible for activation, the present invention can further enhance the decision-making capabilities of fleet managers.

According to yet another aspect of the present invention, vehicles in the fleet database can be organized and displayed by their associated “buy types”, which further enhances the manner in which fleet managers can perform their duties. Examples of vehicle “buy types” include buyback (or repurchase) vehicles, risk vehicles, leased vehicles, and vehicles purchased as used vehicles. A buyback (or repurchase) vehicle is a vehicle for which a buyer (typically the manufacturer) has already agreed to repurchase the vehicle once the vehicle has hit some pre-defined milestone(s) (e.g., age and/or mileage). These vehicles typically need to be pulled from the fleet when they approach their associated milestone(s), but close monitoring of vehicle residual value and depreciation through the fleet management system may not be necessary. A risk vehicle is a vehicle bought as a new vehicle and for which the fleet operator has assumed the risk of re-sale. Because of this risk of re-sale, risk vehicles are particularly amenable to management through the fleet management system described herein. It should also be noted that risk vehicles may be subject to hold requirements as described above that contractually limit risk vehicles'eligibility for re-sale. Preferably, the fleet management system is configured as noted above to track these hold requirements to identify a risk vehicle's eligibility/ineligibility for re-sale at various points in time. A leased vehicle is a vehicle that is leased rather than owned by the fleet operator. Because leased vehicles can be returned to the lessor at the end of the lease on pre-agreed terms, leased vehicles are fairly similar in nature to buyback vehicles with respect to fleet management. Lastly, a vehicle purchased as used is a vehicle that was purchased by the fleet operator as a used vehicle for inclusion in the fleet. Its fleet management characteristics are highly similar to that of risk vehicles in that the fleet operator has assumed the risk of resale.

According to another aspect of the present invention, users of the system are provided with the ability to define a quantity of “flex” vehicles for their fleets. A “flex” vehicle refers to a vehicle that is eligible for re-sale and for which the fleet manager will not have a “buy” against as part of the fleet planning process. Thus, even though the fleet manager is free to remove the flex vehicle from the fleet, the fleet manager does not plan on replacing that vehicle in the fleet with an incoming vehicle. Accordingly, flex vehicles can count toward the fleet's number of deletions but will not necessarily leave the fleet. Flex vehicles provide fleet managers with flexibility in managing their fleets in response to sudden changes in the market. For example, if there is a sudden drop in demand for rental vehicles, the manager of a rental fleet can then reduce his/her inventory of rental vehicles by deleting one or more flex vehicles from the fleet without negatively impacting that fleet manager's existing fleet plan and proper vehicle replacement. Preferably, the fleet management application limits a vehicle's eligibility for “flex” status to minimize the financial impact of deleting the flex vehicle if necessary. For example, the fleet management application can require that a vehicle have a current residual value that is at least $1 over its book value for that vehicle to be eligible for fleet status. Furthermore, the fleet management system can be configured to display a vehicle's flex eligibility to the user. The fleet management application thus preferably counts such flex vehicles toward the fleet's deletions without actually requiring that such “flex” vehicles be deleted from the fleet, thereby leaving it to the fleet manager's discretion whether and when the flex vehicle is actually deleted.

In accordance with another aspect of the present invention, users are provided with the ability to see how managers for different fleets within a fleet management entity have estimated the residual values for like-categorized vehicles. A user can take advantage of this comparison information to make an educated estimate of vehicle residual value. Furthermore, such comparisons can also help fleet managers determine whether any regional dissimilarities exist in estimated vehicle residual values, which may create opportunities for increasing re-sale profitability by directing used cars to the regions where their value is the highest.

According to still another aspect of the present invention, the fleet management application is preferably configured to track any events that occur after the purchase of a vehicle that affect the vehicle's ongoing costs of ownership. In this manner, the system produces more accurate information pertaining to when it will be most profitable to activate a vehicle within the rental fleet so it can be re-sold on the used vehicle market. An exemplary embodiment of this feature of the invention is disclosed herein in connection with the Vehicle Registration Tax (VRT) in Ireland. Under Ireland's VRT system, reclaims (or refunds) are periodically available for a vehicle after certain conditions are met. By tracking when vehicles receive such VRT reclaims, the fleet management system can accurately track the fleet management entity's cost basis for continued ownership (e.g., depreciation estimates, costs going forward) of the vehicle, which aids decision-making as to when the vehicle should be activated. Thus, using the system, a fleet manager can choose to delay vehicle activation until after that vehicle has received one or more VRT reclaims. For example, while the normal depreciation for a vehicle in a given month may be −$200, the cost going forward to the fleet operator may in fact be a positive $50 if the vehicle is entitled to a $250 VRT reclaim if ownership continues throughout that month, thereby affecting the fleet manager's incentives for keeping the vehicle in the fleet.

While the principal advantages and features of the invention have been discussed above, a greater understanding of the invention including a fuller description of its other advantages and features may be attained by referring to the drawings and the detailed description of the preferred embodiment which follow.

### BRIEF DESCRIPTION OF THE DRAWINGS

FIG. 1 depicts a high level overview of the system of the preferred embodiment of the parent invention;

FIG. 2 illustrates a preferred block diagram overview of the navigational path for the fleet management application;

FIGS. 3(a)-(c) illustrate respectively, a preferred log-in screen, a preferred change password screen, and a preferred session timeout screen for the fleet management application;

FIG. 4 illustrates a preferred home page for the fleet management application;

FIGS. 5(a) and (b) illustrate, respectively, a preferred unauthorized access screen and a preferred technical difficulties screen;

FIG. 6 illustrates a preferred residuals parameter entry screen;

FIGS. 7(a) and (b) illustrate preferred residual value table screens;

FIG. 7(c) illustrates a preferred printer-friendly residual table report;

FIG. 8 is a flowchart depicting a preferred technique for calculating the monthly average mileages shown in the residual table;

FIG. 9 is a flowchart depicting a preferred technique for calculating the monthly historical sales prices shown in the residual table;

FIG. 10 illustrates a preferred cost going forward parameter entry screen;

FIGS. 11(a)-(c) illustrate preferred CGF analysis results screens;

FIG. 11(d) illustrates a preferred printer-friendly CGF analysis results report;

FIG. 12 is a flowchart depicting a preferred technique for calculating the projected YMMS values in the CGF results table;

FIG. 13 illustrates a preferred activations screen;

FIGS. 14(a) and (b) illustrate preferred tools for mapping YMMSs into YMMS groups;

FIG. 15 is a flowchart depicting a preferred technique for creating a cost per mile table;

FIG. 16 depicts an exemplary fiscal year calendar during which an LTFP embodiment of the parent invention can be utilized;

FIG. 17 illustrates a flowchart for a preferred LTFP embodiment of the parent invention;

FIG. 18 illustrates a preferred home screen for the LTFP process of the preferred embodiment;

FIG. 19 illustrates a preferred vehicle class assignments screen for the LTFP process of the preferred embodiment;

FIGS. 20(a) and (b) illustrate preferred screens for user entry of desired quantities of vehicles in a rental fleet for the LTFP process of the preferred embodiment;

FIG. 21 illustrates a preferred screen for user entry of a desired rental fleet mix for the LTFP process of the preferred embodiment;

FIGS. 22(a) and (b) illustrate preferred screens for user entry of vehicle quantities that are incoming to a rental fleet for the LTFP process of the preferred embodiment;

FIGS. 23(a) and (b) illustrate preferred screens for user entry of residual values for rental fleet vehicles for the LTFP process of the preferred embodiment;

FIGS. 24(a) and (b) illustrate preferred screens for a CGF analysis of rental fleet vehicles for the LTFP process of the preferred embodiment;

FIGS. 25(a) and (b) illustrate preferred screens for user entry of optimal delete points over time for rental fleet vehicles for the LTFP process of the preferred embodiment;

FIG. 26 illustrates a preferred screen for user distribution of vehicle deletions from a rental fleet by month for the LTFP process of the preferred embodiment;

FIGS. 27(a) and (b) depict exemplary cycling and double-cycling reports respectively for the LTFP process of the preferred embodiment;

FIG. 28 illustrates an exemplary screen for user entry of a fiscal year vehicle buy forecast for the LTFP process of the preferred embodiment;

FIG. 29 illustrates an exemplary screen for user selection of any of a plurality of LTFP reports;

FIGS. 30(a)-(r) depict exemplary flows for processing and storing data for the LTFP process of the preferred embodiment as users proceed through the LTFP process;

FIGS. 31(a) and (b) depict exemplary fleet management home pages in accordance with an embodiment of the present invention;

FIG. 32 depicts an exemplary one-way summary page in accordance with an embodiment of the present invention;

FIG. 33 depicts another exemplary one-way summary page in accordance with an embodiment of the present invention;

FIG. 34 depicts an exemplary filter parameters control window in accordance with an embodiment of the present invention;

FIG. 35 depicts an exemplary residual values entry page in accordance with an embodiment of the present invention;

FIG. 36 depicts an exemplary multi-group residual values comparison window in accordance with an embodiment of the present invention;

FIG. 37 depicts an exemplary optimal delete point page in accordance with an embodiment of the present invention;

FIG. 38 depicts an exemplary cost going forward page in accordance with an embodiment of the present invention;

FIG. 39 depicts an exemplary residual value entry and multi-group residual value comparison window in accordance with an embodiment of the present invention;

FIG. 40 depicts an exemplary deletion plan page in accordance with an embodiment of the present invention;

FIG. 41 depicts an exemplary activations page in accordance with an embodiment of the present invention;

FIGS. 42 and 43 depict an exemplary windows for adding messages and/or locations to activated vehicles in accordance with an embodiment of the present invention; and

FIG. 44 depicts an exemplary CGF page with VRT reclaim information displayed therein in accordance with an embodiment of the present invention.

### DETAILED DESCRIPTION OF THE PREFERRED EMBODIMENT

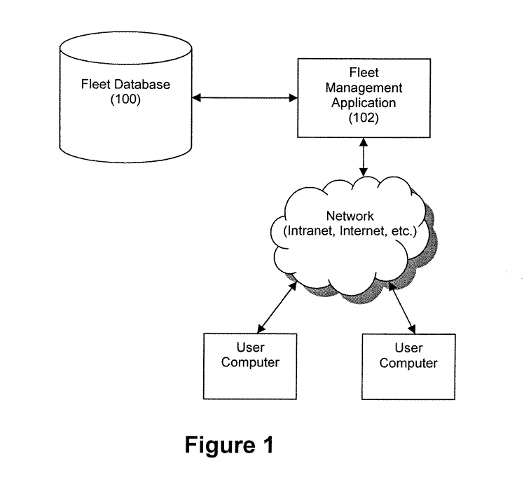

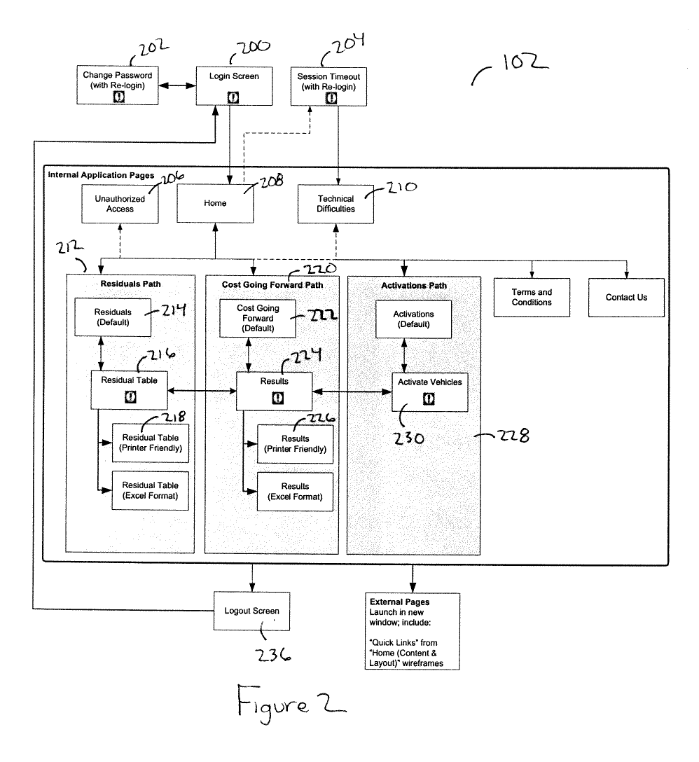

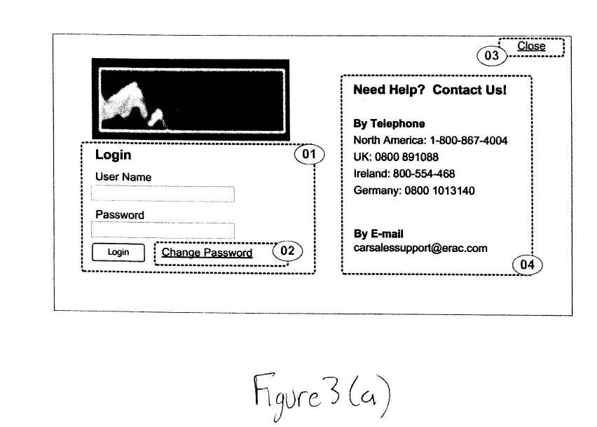

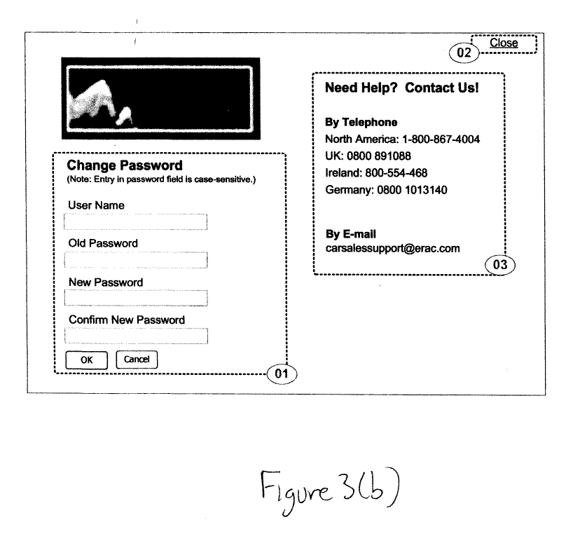

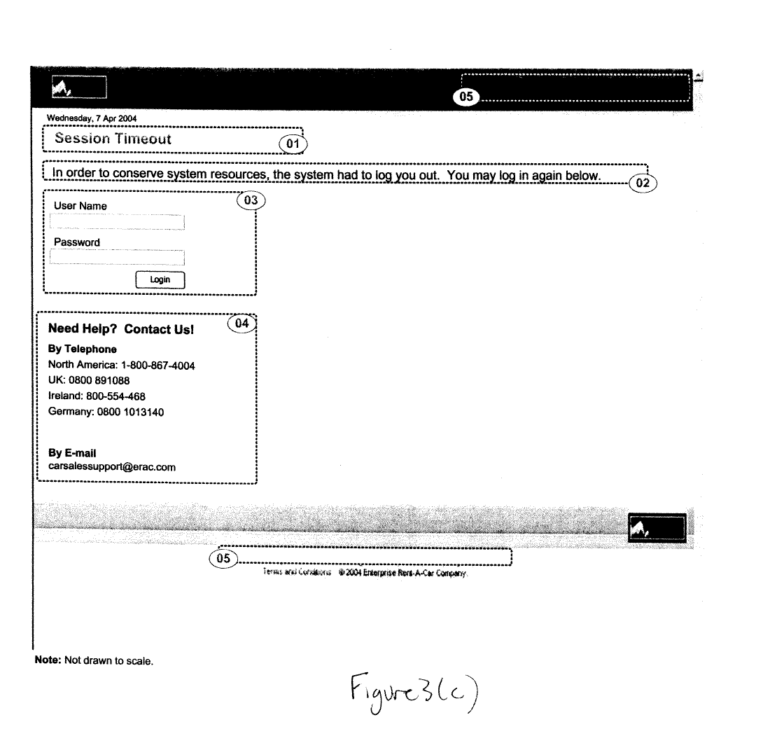

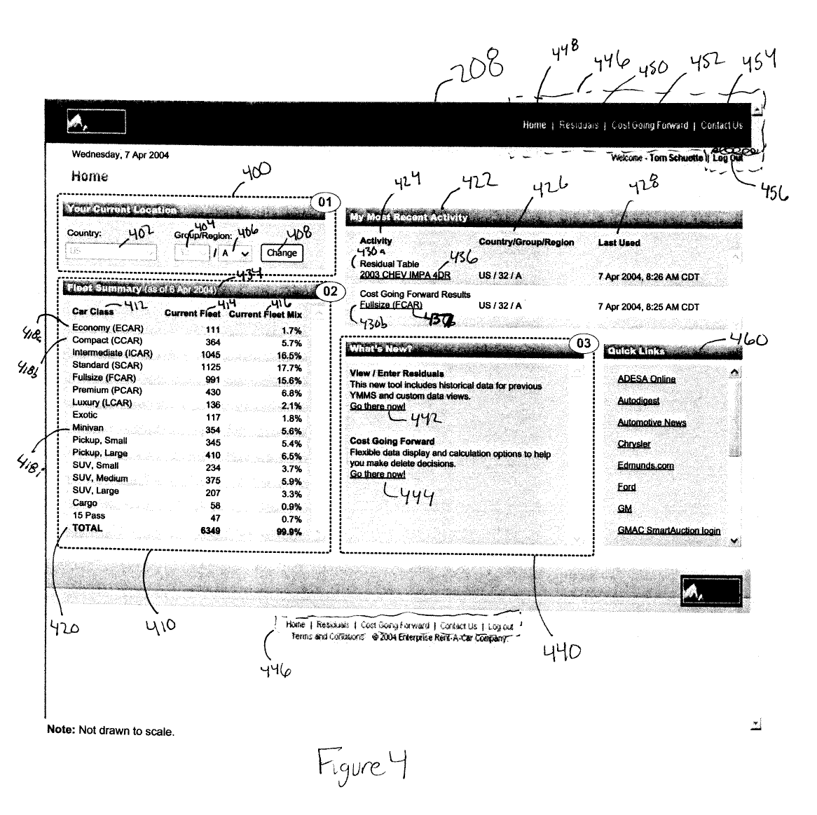

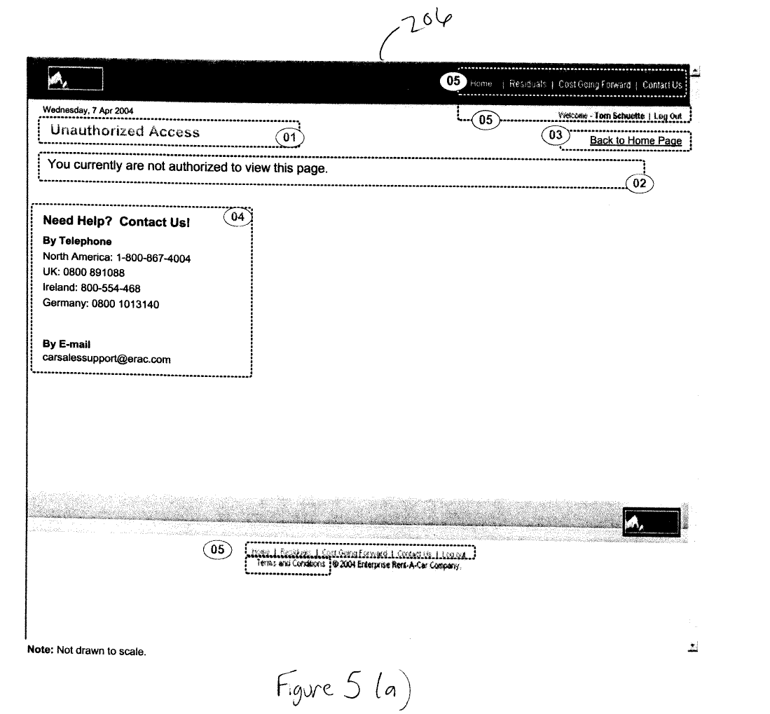

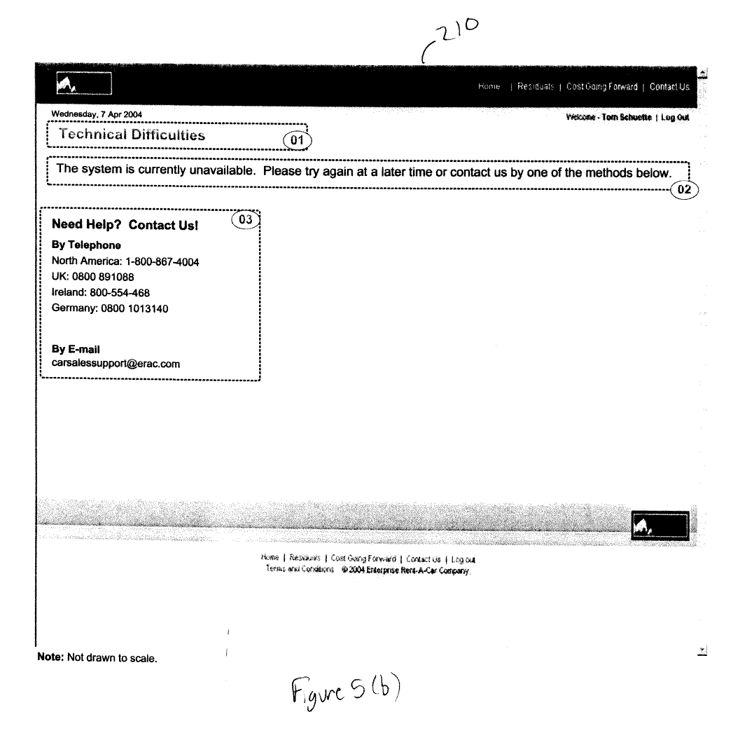

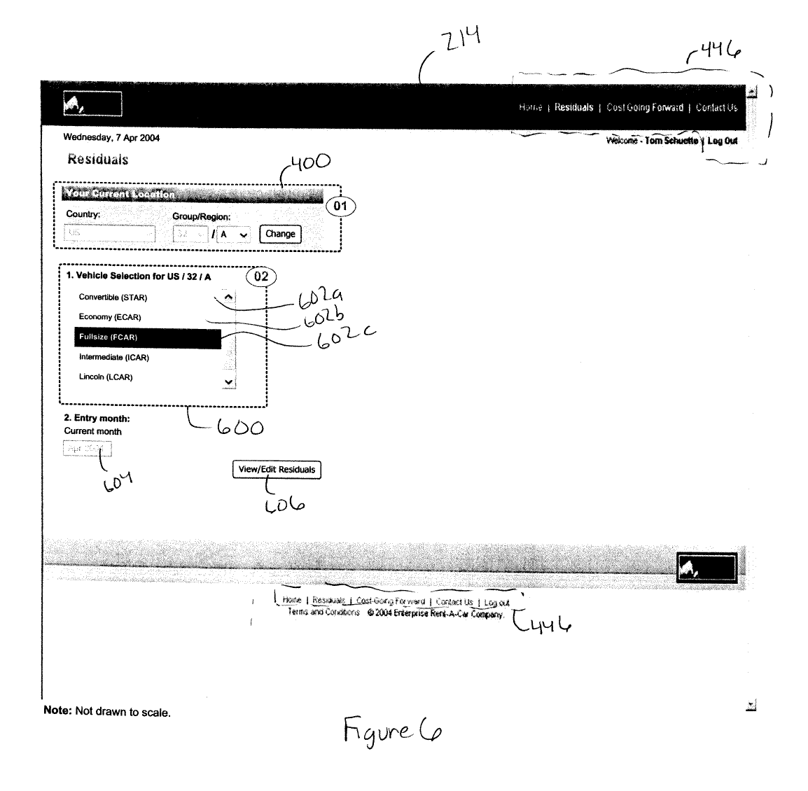

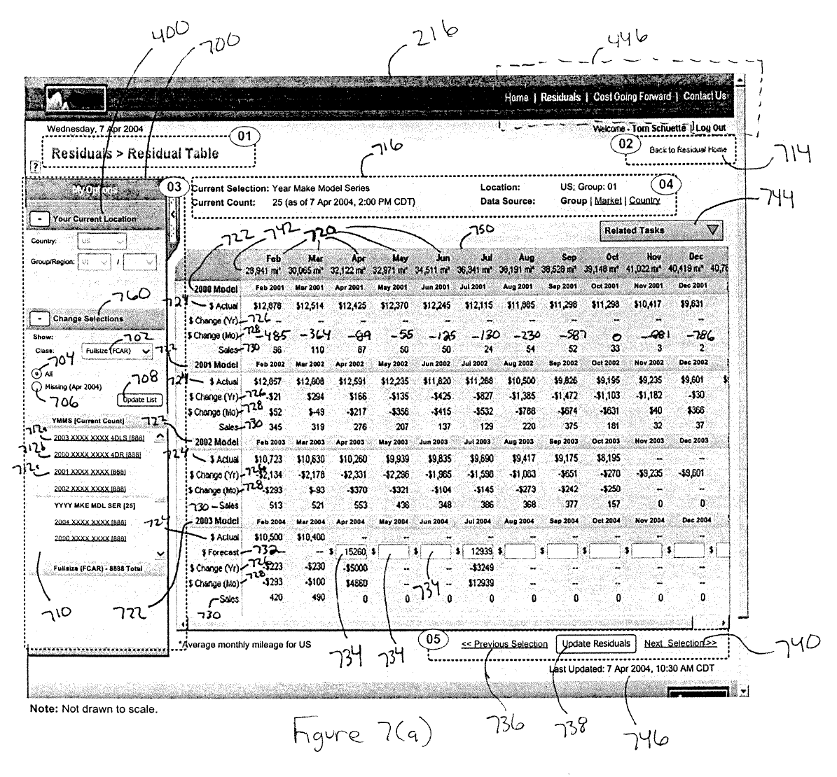

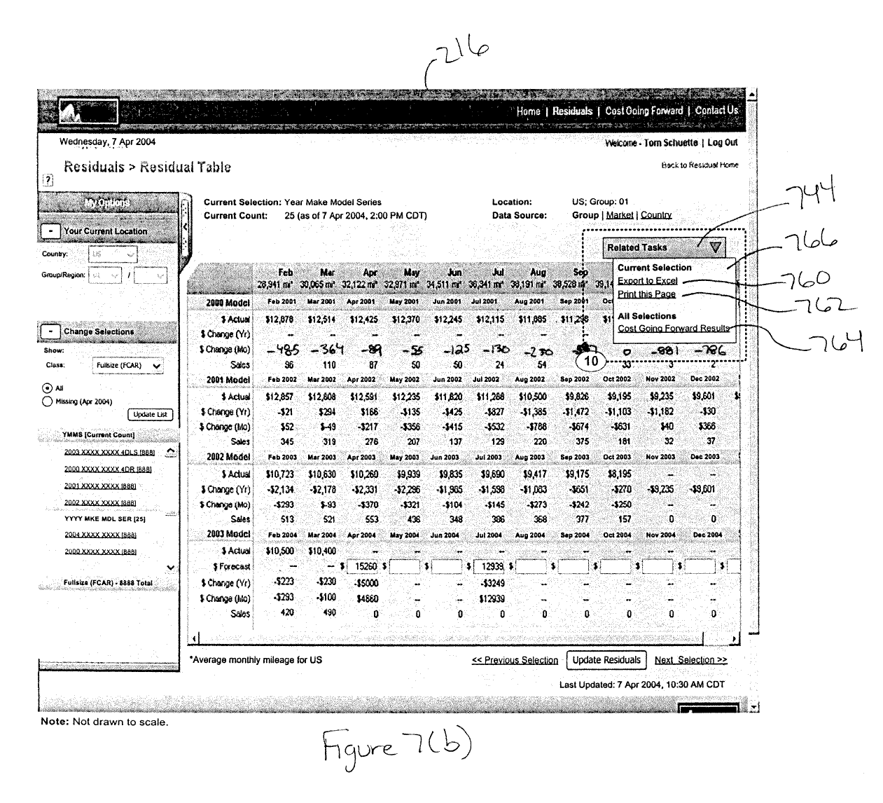

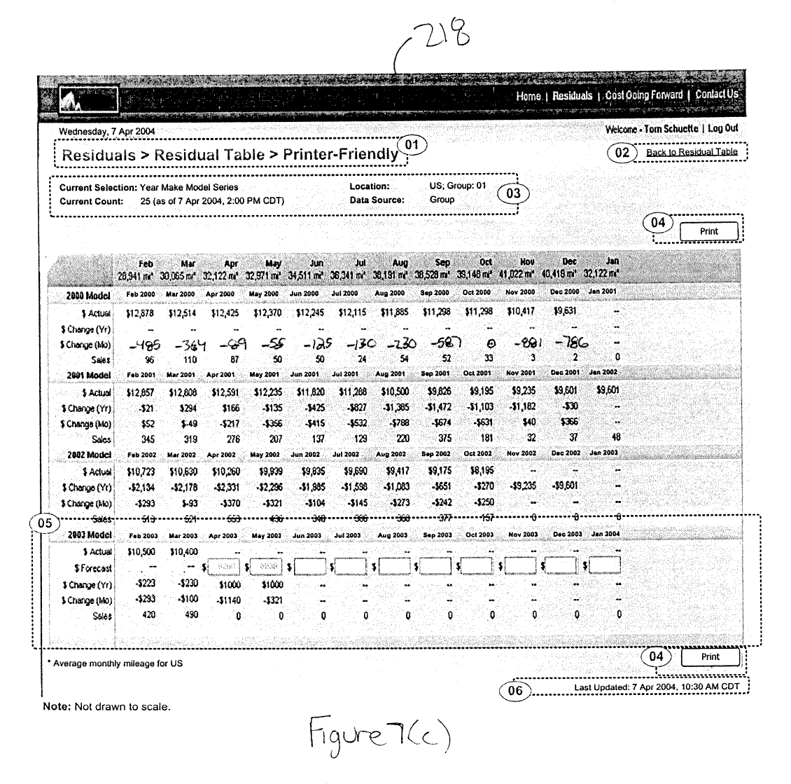

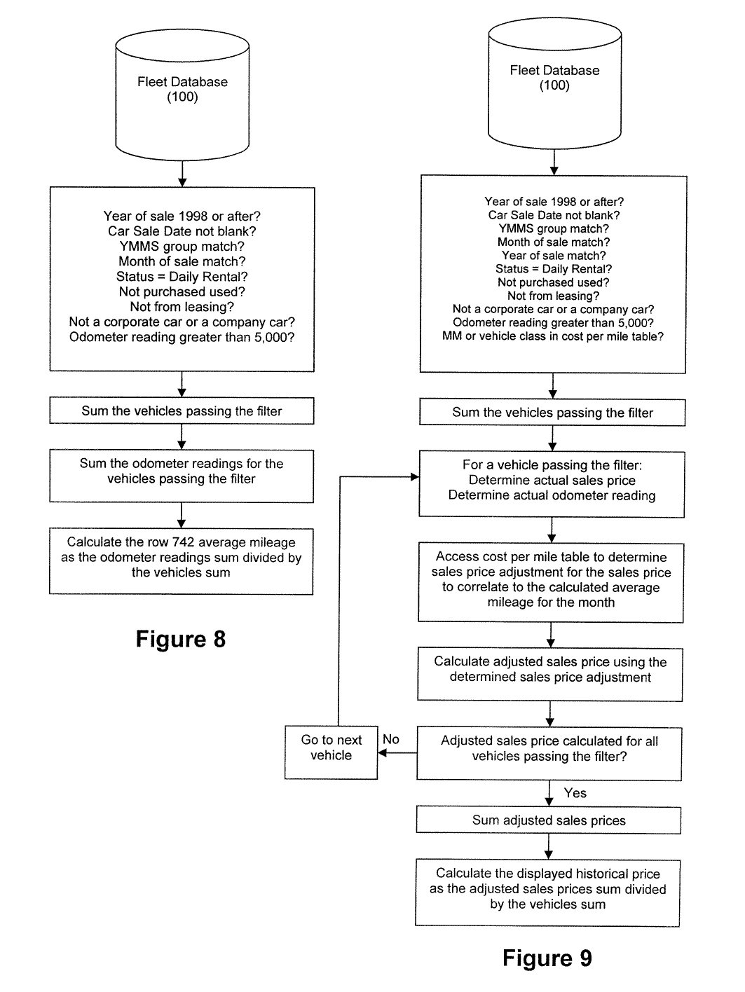

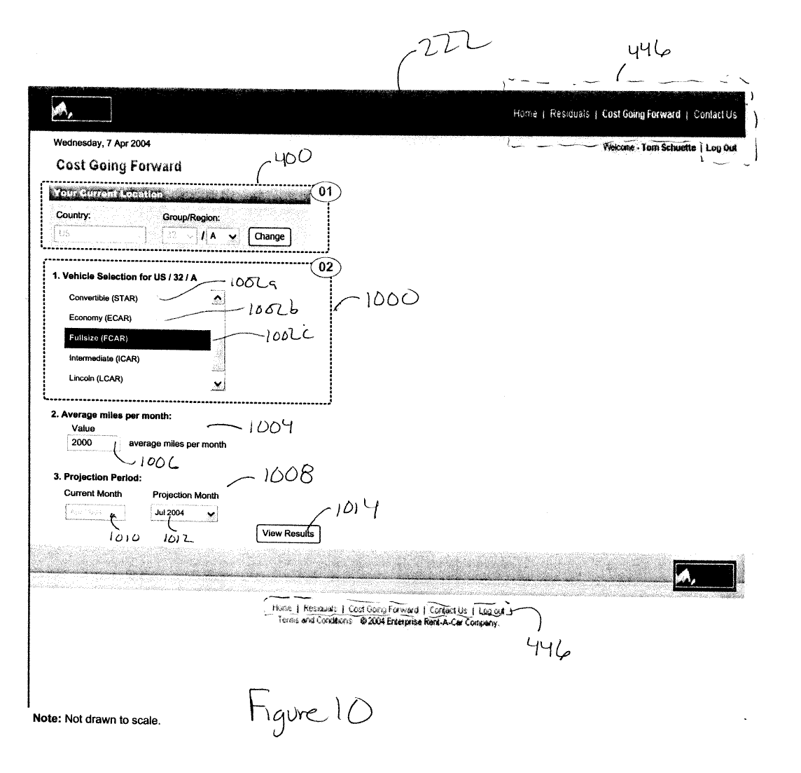

FIG. 1 illustrates a high level overview of the system of the preferred embodiment of the parent invention. In the system of FIG. 1, a fleet management application 102 is in communication with a fleet database 100. Fleet database 100 can be in communication with fleet application 102 via any technique for data communication, including but not limited to a direct communication link and a communication link via a network, wherein the network can encompass any type of network over which data is communicated, including but not limited to the Internet, an intranet, a satellite network, a wireless network, a cable network, etc. In its most preferred form, the system described herein is implemented by a rental car company that manages a fleet of rental vehicles. However, it is worth noting that it need not be a rental car company that performs the fleet management and that the vehicles in the fleet being managed need not be rental vehicles. Fleet database 100 stores vehicle data for the vehicles that are currently or were formerly part of the fleet. Fleet database 100 encompasses not only a single database but also a plurality of separate databases (internal and/or external to the entity operating the application 102) accessible by fleet management application 102. The vehicle data stored in database 100 includes historical sales data for vehicles sold from the fleet, including data such as vehicle unit number, vehicle YMMS (year, make, model, and series), sales price, mileage at the time of sale, unit cost, date of initial purchase, depreciation amount, the rental branch to which the vehicle once belonged, who purchased the vehicle, whether the vehicle was a used car, whether the vehicle is a rental vehicle or a leased vehicle, whether the vehicle is a company car, when the vehicle was sold, time in service, vehicle condition, an identification of the previous owner, and other vehicle data types described herein or considered pertinent by a practitioner of the parent invention. Further, it is worth noting that this sales date need not be limited to only sales data for fleet vehicles, but can also encompass sales data for external or non-fleet vehicles.

Fleet management application 102 can be a software application programmed to allow users to obtain (1) meaningful data about the historical sales prices for rental vehicles in the fleet that previously were sold as used vehicles, thereby enabling more accurate estimation by the user of residual values for rental vehicles in the fleet, and (2) meaningful data about the cost going forward (CGF) for rental vehicles in the fleet, thereby allowing users to make informed decisions about which rental vehicles to remove from the fleet and place into the vehicle sales market. This software can be loaded onto computer readable media such as the hard drive(s) of one or more servers accessible to user computers connected thereto via a network. This network can be any type of network over which data is communicated, including but not limited to the Internet, an intranet, a satellite network, a wireless network, a cable network, etc. For example, the software that is programmed to carry out the fleet management application can be loaded onto one or more servers accessible over a company's intranet for execution on demand by company computers that are connected to that intranet. Further, the one or more servers upon which the application 102 is loaded can be connected to the Internet to provide a wider range of users with access to its features. Further still, it is conceivable that the fleet management software and/or fleet database could be stored on other computer readable media such as a CD-ROM, a PC or laptop hard drive, PDA, any other type of mobile/portable computing technology, or the like.

FIG. 2 provides a detailed overview of the interface components comprising the fleet management application 102. Users of the application 102 are required to log in via log in screen 200, depicted in FIG. 3(a). Preferably, access to application 102 is restricted to authorized users, and such users are required to provide an ID and password to gain access thereto. Should the user wish to change his/her password, application 102 provides a “change password” screen 202, depicted in FIG. 3(b). If a logged-in user has been inactive with respect to his/her interaction with the application 102 beyond a predetermined amount of time (e.g., one hour), then the user's session times out and a session timeout/re-log in screen (FIG. 3(c)) is presented to the user. However, it should be noted that some practitioners of the parent invention may possibly deem the need to restrict users from accessing some or all of its screens unnecessary.

After successfully logging in via screen 200, the user is presented with the fleet management home page 208 depicted in FIG. 4. Home page 208 serves as the central jumping off point for the user that provides the user with access to pages for viewing historical sales values for a particular vehicle type, entering vehicle residual values, and viewing the CGF for existing rental vehicles in the fleet. The fleet management home page 208 preferably includes a current location display section 400, a fleet summary display section 410, a recent activity display section 422, a feature gateway display section 440, one or more navigation bars 446, and a quick links display section 460.

The current location display section 400 allows users to view and/or specify constraint information (preferably geographical constraint information) on the scope of vehicle data to be processed by application 102. Field 402 identifies the high level area from which the vehicle data will be drawn. Field 404 identifies a lower level area from which the vehicle data is drawn, and field 406 identifies a yet lower level area from which the vehicle data will be drawn. In the preferred embodiment, the high level area is a country or continent (e.g., US, Canada, North America, Great Britain, Germany, Europe, etc.), the next lower level area is a country/continent subregion (e.g., southern California, northeast Ohio, mid-Pennsylvania, etc.), and the lowest level area is a subregion within the subregion (e.g., the Los Angeles area within the U.S./southern California region). Numerical codes, alphabetic codes, or alphanumerical codes may be used to represent these different levels. The preferred nomenclature for this breakdown is country/group/region. However, it should be understood that different terminology, different geographical breakdowns, and different numbers of hierarchical levels can be applied to constrain the vehicle data as a matter of design choice by practitioners of the parent invention. For example, an intermediate level could be added between the highest level area and the next level area that corresponds to a larger subregion within the specified country/continent (e.g., midwest, west coast, etc.). Further still, more or fewer levels could be put in place, even down to the rental branch location level. Moreover, the criteria for constraining the data need not be broken down by geographical area at all. For example, the vehicle data can be constrained by the business entities that own or operate the vehicles, whether the vehicles are leases or rentals, by vehicle manufacturer, by whether the vehicle is a domestic or import, etc.

Also, in the preferred embodiment, different users will preferably have different levels of access to different country/group/regions depending upon their authorizations within the company. Further, each authorized user will preferably be associated with a default value for country/group/region depending upon his/her level of authorization. Preferably, a fleet manager for the midwest region will only have “delete” access to midwest level (and lower) vehicle data, and his/her default country/group/region setting would be US/Midwest (with no default value being provided by the “region” level). Similarly, a fleet manager for the St. Louis area will preferably only have access to St. Louis area vehicle data, and his/her default country/group/region setting would be US/St. Louis. The default country/group/region setting for a fleet manager for the Miami area would be US/south Florida/Miami. A corporate level fleet manager, however, may be given access to all country/group/regions of the fleet. However, it is worth noting that some practitioners of the parent invention may choose to place no authorization restrictions on users.

In a preferred embodiment, the country/group/region technique will be implemented as follows. For country field 402, the value therein will be the user's default value for country. Preferably, only corporate users are allowed to change the view to a different country. As such, for non-corporate users, the country field 402 is display only. For group field 404, the group values are displayed based on the country value in field 402. For all authorized users other than corporate users, the group value will default to the user's associated group value. In such cases, the group field 404 will be display only. Corporate users can be allowed to change the view to different group values. For region field 406, the region value is displayed based on the regionalized group value in field 404. Preferably, only corporate users or users authorized to access a group broken down into regions have the ability to change region values. For all other users, region field 406 can be display only. User control over any changes to the country/group/region values are implemented via user selection of change button 408.

Fleet summary display section 410 serves as a snapshot for the user of the current fleet status for the country/group/region identified in section 400. This display serves as a valuable tool for providing users with a near real-time view of the current mix of car classes within a fleet. The data displayed in the fleet summary section 410 is derived from the stored vehicle data in database 100 meeting the applicable country/group/region constraints. Beyond the country/group/region constraint, preferable rules for determining which vehicles in the database 100 should be displayed are as follows: (1) the vehicle's purpose within the fleet is a “daily rental”, (2) the unit's out of service date should be null, (3) trucks should be included, (4) vehicles that were purchased used should be included (although these vehicles should be excluded from any average mileage calculation), (5) vehicles whose original unit cost equals zero should be excluded, (6) vehicles whose monthly depreciation amount percentage equals zero should be excluded, (7) vehicles that are not yet officially activated within the fleet should be excluded, and (8) the vehicles must have been completely activated within the fleet.

The fleet summary can be broken down into three data category columns. A vehicle class column 412 identifies a vehicle class type (e.g., economy, compact, intermediate, full size, etc.). Each row 418a, 418b, . . . 418i corresponds to a different vehicle class. It should be noted that different companies may well use different types of vehicle classes and different criteria for assigning vehicles to vehicle classes. Current fleet column 414 identifies the number of vehicles with each vehicle class for the identified country/group/region. Row 420 includes total numbers for the current fleet column 414 and the current fleet mix column 416. The entries in column 416 identify the percentages that vehicles of the vehicle class sharing the row make up within the overall fleet for the identified country/group/region. The current fleet mix percentages can be calculated as: Current Fleet Mix (for Row k) equals 100 multiplied by the Current Fleet Value (for Row k) divided by the Current Fleet Total.

While it is preferred that the fleet summary display section 410 display fleet summary data broken down by vehicle class, it should be noted that this display section 410, if desired by a practitioner of the parent invention, could also be used to display current fleet count and current fleet mix data that is further broken down to the YMMS level.

The fleet summary preferably also includes an “as of” date identifier 434 that identifies the date for which the fleet summary data is current (e.g., the time stamped date and time that the fleet database 100 was last updated, which at minimum can be a day-to-day update).

Recent activity display section 422 summarizes the most recent activities of the user in the various sections of the fleet management application 102. Typically, section 422 will display a summary of recent reports and/or data tables created by the user as well as links 436 and 437 to such reports/data tables. Link 436 takes the user to screen 216 of the residuals path 212. Link 437 takes the user to screen 224 of the CGF path 220. Column 424 identifies the type of report/data table that the user had recently created. If the report/data table relates to a residual value table, the data displayed in column 424 will preferably identify the fact that the report/data table relates to residual values as well as identify the pertinent YMMS for the latest residual value data viewed by the user (preferably using a descriptive name for the YMMS). If the report/data table relates to a CGF table, the data displayed in column 424 will preferably identify the fact that the report/data table relates to CGF values as well as identify the pertinent vehicle class (e.g., fullsize) for the latest CGF data viewed by the user. Column 426 identifies the pertinent country/group/region for each report/data table, and column 428 identifies the date (and preferably time) upon which each report/data table was last viewed. Rows 430a and 430b identify the particular column values for each recent report/data table.

Quick links display section 460 preferably includes a plurality of links to frequently-used industry sources for vehicle data. Preferably, the links that are displayed to the user are country-specific.

Feature gateway display section 440 serves as a jumping off point for the user to access the residuals path 212 and the CGF path 220 identified in FIG. 2. Preferably, user selection of link 442 provides the user with access to residuals path 212 and user selection of link 444 provides the user with access to CGF path 220. Moreover, it is preferred that home page 208 further include one or more navigation bars 446 to provide the user with similar navigation capabilities as section 440. In the preferred embodiment, navigation bars 446 each include a link 448 back to the home page 208, a link 450 to the residuals path (link 450 corresponds to link 442 in section 440), a link 452 to the CGF path (link 452 corresponds to link 444 in section 440), a link 454 to a “contact us” page that provides pertinent contact information to the user about the fleet management application 102, and a link 456 that is operative to log the user out of the fleet management application 102.

In the event the user tries to navigate from the home page 208 to a page that he/she is not authorized to access, the “unauthorized access” screen 206 (see FIG. 5(a)) will be preferably presented to the user. In the event the user attempts to navigate to a page that is unavailable due to technical problems in the system, the “technical difficulties” screen 210 (see FIG. 5(b)) will preferably be presented to the user.

To enter the residuals path 212 and reach the residuals parameter entry screen 214 of FIG. 6, the user can select any of the links 442 or 450 on home page 208. Residuals parameter entry screen 214 includes a current location display section 400 as described in connection with the home page 208 of FIG. 4. Preferably, the current location section 400 of residuals parameter entry screen 214 will default to the country/group/region values that were present on home page 208. However, the user will preferably be free to modify those values subject to the authorization restrictions described above in connection with FIG. 4. Screen 214 also preferably includes a vehicle selection section 600 that lists a plurality of vehicle classes 602a, 602b, 602c, . . . for which the user has the ability to view historical sales calculations and enter residual value forecasts. It is preferred that upon arrival at screen 214, the vehicle class of the YMMS for the most recent residual table in section 422 of the home page 208 be highlighted. However, the user will preferably still possess the ability to select any of the listed vehicle classes. Further, it is worth noting that while in the preferred embodiment, the vehicle selection section 600 lists vehicle classes, a practitioner of the parent invention may also choose to have section 600 select vehicles by criteria other than vehicle class, for example, by YMMS.

Current month display section 604 notifies the user of the current month for residual value entry. Link 606 is provided to allow the user to proceed to a residual value table screen 216, depicted in FIG. 7(a). Upon user selection of link 606, the residual table screen 216 for the selected vehicle class and country/group/region constraints is displayed.

FIG. 7(a) depicts a preferred residual table screen 216. The preferred residual table screen 216 serves two main purposes. The first purpose is to display historical sales data for the selected YMMS and similar YMMSs within the fleet of interest. By displaying such historical sales data, the user is provided with valuable data for use in predicting the residual values for such YMMSs currently within that fleet. The second purpose is to allow the user to enter estimates for future residual values, the value of which will become apparent when the CGF aspect of the preferred embodiment is discussed.

Among the various sections of the residual table screen 216 are a user options section 700, an information section 716, a related tasks button 744, a residual table 750, and a navigational bar 446. Navigational bar 446 functions as described earlier in connection with home page 208. Also, user selection of link 714 routes the user back to the residuals parameter entry screen 214. Further, time stamp section 746 identifies the date and time the displayed table 750 was last updated (and preferably who (not shown) updated the table).

The user options section 700 preferably includes three sections therewithin: a current location section 400 that is operative as previously described, a change selections section 760, and a YMMS selection section 710. Further, it is preferred that the user be provided with the ability to minimize, maximize, and otherwise selectively size the user options section 700 within the residual table screen 216. For users who have the authorization to change the country/group/region values, it is preferred that a “change” button (not shown) be made available in the current location section 400 to provide the user with the ability to modify country/group/region values in a manner commensurate with his/her level of authorization.

Field 702 within the change selections section 760 allows the user to modify the selected vehicle class for the screen. Field 702 can be joined with a drop down menu that contains a list of the vehicle classes with the current location's fleet. Radio buttons 704 and 706 provide the user with the ability to display within YMMS selection section 710 either “all” of the YMMSs within the selected vehicle class or only those YMMSs within the selected vehicle class for which a current residual value report is “missing” for the current month. Preferably, the current month is displayed alongside “missing” radio button 706. Based on any selections by the user within change selections section 760, user selection of the “update list” button 708 will be effective to reload the residual table screen 216 with the modified entries.

The YMMS selection section 710 provides the user with the ability to select the YMMS for the residual table 750. As noted above, the YMMSs listed in section 710 will be either all of the YMMSs within the selected vehicle class for the specified current location (country/group/region) or the YMMSs within the selected vehicle class for the specified location and for which a current month's residual value report is not yet completed, depending on the user input in radio buttons 704 and 706. The sort order for the YMMSs within section 710 can be make, year, model, series (alphabetically where applicable and chronologically where applicable), although they can be descriptively displayed by YMMS. However, it should be understood that other sort orders can be used. Furthermore, it is preferred that each YMMS listed in section 710 also include an adjacent identification of that YMMS's total count or population within the current location's fleet. At the bottom of section 710, a total vehicle count for the entire vehicle class of the current location's fleet can be displayed. The YMMS row 712 for the currently displayed residual table 750 can be highlighted in some manner to help notify the user of which YMMS is applicable to the current table 750. By clicking on a row 712 of section 710, the user can choose the YMMS for which the residual table 750 is applicable.

Information section 716 preferably displays to the user a summary of the parameters for which and from which the residual table 750 was created. This summary information includes an identification of the YMMS applicable to the residual table 750, an identification of the total count for that YMMS within the current location's fleet as of a predetermined date (preferably the date that the fleet database was last updated), an identification of the current location (country/group/region) for the residual table 750, and an identification of the data source, which specifies the pool of vehicles within the fleet that will be used for the historical analysis to populate entries in the residual table 750. Through the data source links, the user will have the ability to change the pool of vehicles for which historical analysis is performed to a larger or smaller pool. For example, if a St. Louis group fleet manager feels it would be more helpful to include a larger pool of historical sales in the analysis than just those in the St. Louis area, then that fleet manager will have the capability to expand the pool of historical sales to be analyzed (e.g., to encompass the entire midwest market rather than just the St. Louis group). The preferred data source choices are Group, Market, and Country. If the “Group” choice is selected, then the historical values are calculated from YMMS vehicles within the group of the data source's fleet. If the “Market” choice is selected, then the historical values are calculated from the YMMS vehicles within the market to which the group of the data source's fleet belongs. The choices of how to place groups within larger markets is a design choice, but it is preferred that groups be assigned to their natural geographical areas such as east, south, central, and west. If the “Country” choice is selected, then the historical values are calculated from YMMS vehicles within the country of the data source's fleet. It is worth noting that, preferably, the scope of levels accessible to the user via the data source tool not be limited by the user's authorization level within the company. Further still, practitioners of the parent invention may choose different criteria for data source constraints similar in nature to the options discussed in connection with current location display 400.

Residual table 750 presents the user with a vast array of historical sales data for vehicles of a YMMS that is the same or similar to the user-selected YMMS within the data source's fleet. Residual table 750 further allows the user to enter estimations for future residual values for the user-selected YMMS, guided at least in part by the user's analysis of the historical trends displayed via the table 750.

Residual table 750 can be formatted in the following manner. The current year values for the selected YMMS vehicle appear as the last row 722 of information on the bottom of the table 750. Directly above the current year will be historical data for the previous year's YMMS, in the same format as the rows and columns for the current year. Residual table 750 preferably displays the three previous years of data for a YMMS group together with the current year's data. However, it should be understood that more or fewer than three previous years can be displayed and that the user can be given the ability to specify how many previous years are to be displayed. If there is no historical data available for a similar YMMS in a previous year, then a “−” or the like can be displayed in the pertinent row and column.

Along with each year's row, there will preferably be twelve columns corresponding to the months of the year. Preferably, the first two columns correspond to the two previous months, the third column corresponds to the current month, and the next nine columns correspond to the next nine months. The arrangement of columns can be updated by the software at midnight on the first of each month. However, other arrangements of months within columns can be used. For example, some practitioners of the parent invention may prefer that the columns be displayed in strict January through December order while others may prefer that the current month be listed first with later months following.

While it is preferred that rows in the table correspond to data for different YMMSs and the columns correspond to different months, it should be noted that practitioners of the parent invention may choose different row/column arrangements. For example, rather than having columns correspond to months, the columns could correspond to different time periods (e.g., quarterly). Also, the table can be arranged such that some rows correspond to country-level sales of a YMMS, some rows correspond to market-level sales of a YMMS, some rows correspond to group-level sales, and some rows correspond to region-level sales.

In row 742 for each month, the residual table 750 preferably displays an average mileage calculation for previous sales of the same or similar YMMSs in that month. Before explaining these average mileage calculations, it will be helpful to discuss the system's technique for pooling the appropriate historical data.

When attempting to estimate future residual values for a particular YMMS such as a 2004 MMS, it will be helpful to know how previous year MMSs have sold. In this case, a YMMS group of the same or similar YMMSs for a user-selected YMMS of a 2004 MMS would be the 2003, 2002, 2001 and so on versions of the MMS, as determined by a user. However, it may be the case that the process of grouping YMMSs into a YMMS group that corresponds to a user-selected YMMS is not so simple as finding matching MMSs for previous years. For example, in some cases, the name of the make, model, and/or series may have changed over time, despite a current YMMS still being the same “type” of vehicle as the older YMMSs. So that the fleet management application can accurately know which YMMSs to take into consideration when performing a historical analysis for a user-selected YMMS, the mapping tools of FIGS. 14(a) and (b) can be used. FIG. 14(a) depicts a mapping table 1400 for grouping current YMMSs with older YMMSs to create a YMMS group. In table 1400, the YMMS group is defined as the YMMSs that share a row 1402a, 1402b, 1402c, . . . , etc. Via fields 1410 and 1412, the user can specify a year/make combination to work on. In this example, the selected year/make combination in fields 1410 and 1412 is “2005 Chevy”. Thus, table 1400 lists all YMMSs that are 2005 Chevys. Within the cells of each column group 1404, 1406, 1408, and so on, the user can specify the older YMMSs that are to be mapped to the current YMMS sharing the row, to thereby create a YMMS group. Button 1414 is provided to save the YMMS groups to a database. Buttons 1420 are provided at the end of each row to edit the previous YMMSs that are to be grouped with a current YMMS.

FIG. 14(a) depicts what can be referred to as “horizontal” mapping (mapping older YMMSs with a current YMMS). Another mapping scenario is “vertical” mapping, as shown in FIG. 14(b), which involves matching same year YMMSs together into a YMMS group. This is typically done because, despite a formal name difference between the same year YMMSs, the user has determined that the vehicles are essentially the same for historical analysis purposes. In FIG. 14(b), the user can specify in field 1430 a YMMS that is to be mapped to another same year YMMS (specified in field 1432) to create a YMMS group. Summary section 1434 lists all same year YMMSs that have been mapped together into a YMMS group. “Delete” buttons 1438 are provided for removing particular YMMSs from this group. “Add” button 1436 is provided for adding the YMMS in field 1430 to the group.

A good case study for mapping is the Chevy Malibu. Going back to 2002, consider the following vehicle types: 2002 Chevy Malibu, 2003 Chevy Malibu, 2004 Chevy Classic, 2004 Chevy Malibu, 2005 Chevy Classic, and the 2005 Chevy Malibu. When mapping similar vehicle types together for the 2005 Chevy Classic, it is preferred that the 2002 Chevy Malibu, 2003 Chevy Malibu, and 2004 Chevy Classic be grouped therewith. When mapping similar vehicle types together for the 2005 Chevy Malibu, it is preferred that only the 2004 Chevy Malibu be grouped therewith. This mapping result arises from a change in design from Chevy wherein the 2004 Chevy Malibu was sufficiently different from previous years of the Malibu to render sales data for previous year Malibus relatively immaterial thereto. However, the Chevy Classic introduced in 2004 was sufficiently similar to the previous year Malibus so as to justify their user-defined grouping for historical sales analysis.

Once the appropriate YMMSs have been mapped into YMMS groups, a historical analysis of the average mileages by month of sale for a user-selected YMMS can be performed. This average mileage will be based on the odometer readings at the time of wholesale/retail sale for vehicles in the YMMS group corresponding to the user-selected YMMS. The formula used to calculate the average mileage is the sum of the odometer readings (at the time of sale) for all vehicles matching the YMMS group that were sold in the same month as the column in question divided by the total number of vehicles matching the YMMS group that were sold in the same month as the column in question, wherein the sales that are included in this analysis are the sales dating back to the earliest year for which reliable sales data is available (which is the year 1998 in the preferred embodiment). However, fewer years (or more years) of sales data could be used to calculate each month's average mileage.

Furthermore, to be included in the pool of past sales used in the calculation, it is preferred that a vehicle sale for a member of the YMMS group must meet these additional criteria: (1) the vehicle's sale date must not be blank, (2) the vehicle must have had a status of “daily rental” prior to the sale, (3) the vehicle was not purchased used, (4) the vehicle must not have been brought from leasing nor is a corporate or company car, and (5) the vehicle must have had more than 5,000 miles on the odometer at the time of sale. FIG. 8 is a flowchart illustrating how the average mileage is calculated for each month. While it is preferred that a single average mileage be calculated for all YMMSs in a YMMS group that were sold in a given month, it should be understood that a practitioner of the parent invention may choose to calculate and display a different average mileage for each YMMS within the group. Also, it is preferred that for any YMMS groups having no sales, that the average mileage determination be rolled up to the MM level. If no sales are found at the MM level, it is preferred that the average mileage determination be further rolled up to the vehicle class level.

In row 726 for each model year row 722, the monthly column entries will display a calculated historical sales price for each year of YMMS within the YMMS group, wherein the historical sales prices have been normalized to the corresponding average mileages in row 742. In the example of FIG. 7(a), the $12,878 value in the February column of row 724 for the YMMS displayed in section 716 represents a historical value determined in accordance with the parent invention for that YMMS that was sold in February 2001 with 26,941 miles on it (the row 742 value for February). Likewise, the $10,723 value in the February column of row 724 represents a historical value determined in accordance with the parent invention for that YMMS that was sold in February 2003 with 26,941 miles on it.

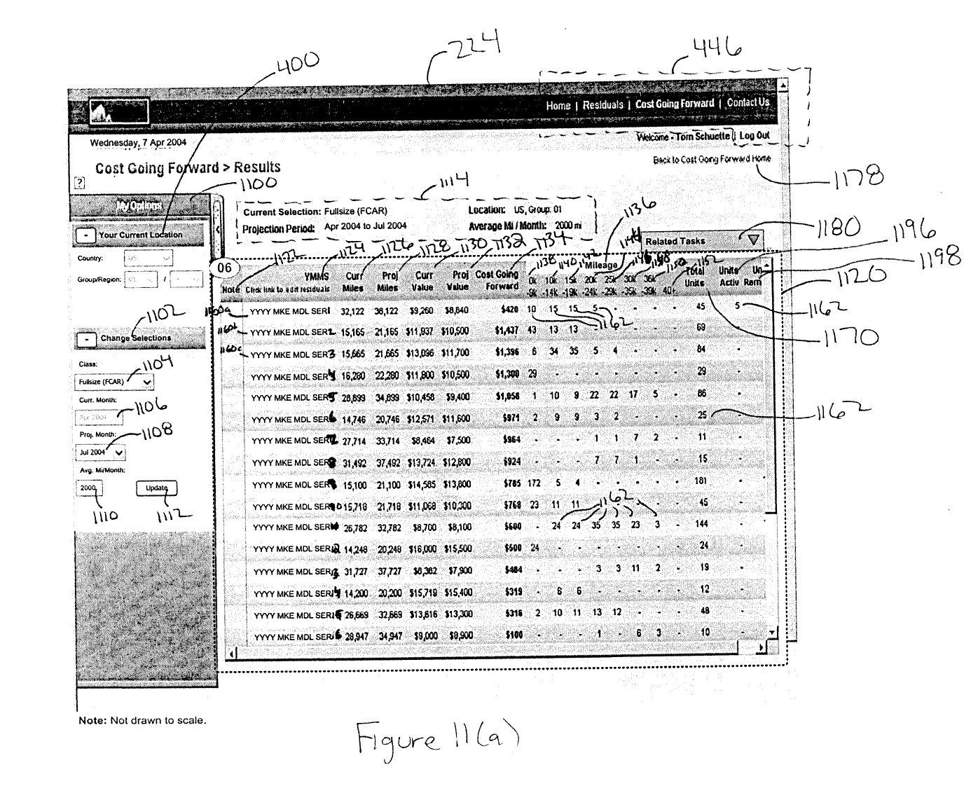

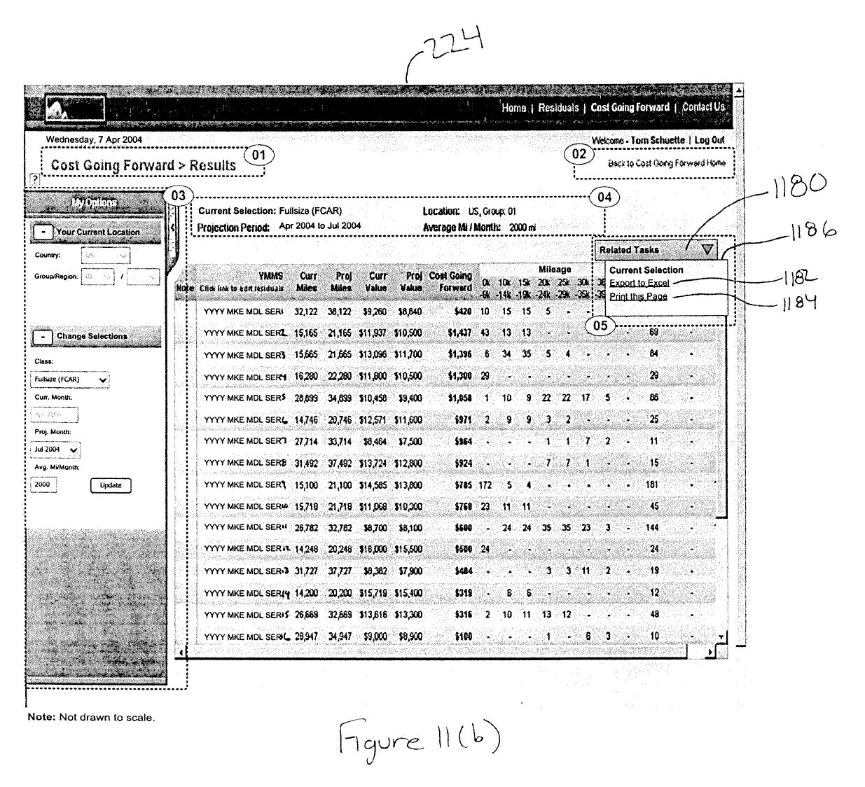

Conceptually, with this technique the actual sales price values and actual mileage values for previously sold vehicles of a particular YMMS group can be thought of as a data group. The goal of the concept is to normalize each sales price value in the data group to a “representative” data group member (the representative member preferably being the average mileage value computed in accordance with FIG. 8 from the data group's actual mileage values (or a subset thereof)). As described in greater detail below, this normalization can be achieved by adjusting each vehicle's actual sales price value corresponding to that vehicle's actual mileage as compared to the representative member (the average mileage value). To aid this adjustment, a cost per mile data table can be accessed. Once the actual sales prices have been so normalized, select subsets of the normalized sales prices can be combined to calculate appropriate average normalized sales prices. FIG. 9 illustrates a preferred implementation of this concept.

With reference to FIG. 9, for each of the vehicles passing the following filter constraints: (1) the vehicle's sale date must not be blank, (2) the vehicle must have had a status of “daily rental” prior to the sale, (3) the vehicle was not purchased used, (4) the vehicle must not have been brought from leasing nor is a corporate or company car, (5) the vehicle must have had more than 5,000 miles on the odometer at the time of sale, (6) the vehicle's year of sale must match the year in question, and (7) the vehicle's MM or vehicle class must have a matching entry in the cost per mile table (discussed below), the software will determine the vehicle's actual sale price and actual odometer reading at the time of sale (these values being stored in the fleet database 100). Thereafter, the software will seek to calculate an adjusted sales price that represents what the vehicle sales price would have been had the odometer reading at the time of sale matched the calculated average mileage in row 742. To do so, a cost per mile table can be used. The cost per mile table displays an estimated vehicle price (by vehicle type) associated with an odometer reading for a vehicle of that type. An exemplary cost per mile table is shown below:

Cost per mile Table for a YMMS:

| Miles | Cost |
|---|---|
| . . . | . . . |
| 12,000 | $7,841 |
| 13,000 | $7,795 |
| 14,000 | $7,750 |
| 15,000 | $7,704 |
| 16,000 | $7,658 |
| 17,000 | $7,613 |
| . . . | . . . |

Using this table as an example, and assuming that a vehicle's (say, a hypothetical YMMS of a 2004 xxxx yyyy zzzz) actual sales price is $8,700, that vehicle's actual odometer reading at the time of sale was 12,300 miles, and that the average mileage to which the sales price will be adjusted is 15,400 miles, then the calculation of an adjusted (or normalized) sales price will proceed as follows.

First, one would look to the cost per mile table to find an entry in the table for the vehicle's actual mileage, which in this example is 12,300. If a matching mileage entry is found in the table, then the “cost” parameter is easily set to be the cost value sharing the row with the matching mileage entry. However, if a matching entry is not found, then interpolation (preferably straight line interpolation) based on the next lower and next higher table entries can be used to find cost. In this example, interpolation will be needed. Thus, one preferably first calculates the cost per mile between 12,000 miles and 13,000 miles which comes out to $46 ($7,841-$7,795) for 1,000 miles, or 4.6 cents per mile. Using this cent per mile adjuster, the next step is to find what the appropriate entry in the table would be for a mileage of 12,300. Given that each additional mile added to the vehicle after 12,000 miles (and before 13,000 miles) is assumed to drop 4.6 cents from the vehicle's sales price, it can be determined that 300 additional miles on the vehicle would drop $13.80 (.046 times 300) from the value of the vehicle at 12,000 miles. Thus, the appropriate cost entry in the table for a 2004 xxxx yyyy zzzz at 12,300 miles would be $7,827.20.

Next, the appropriate cost entry in the table is determined for a 2004 xxxx yyyy zzzz with average mileage (15,400) thereon. If a matching mileage entry is found in the table, then the “cost” parameter is easily set to be the cost value sharing the row with the matching mileage entry. However, if a matching mileage entry is not found, then the same interpolation process described above can be followed. In this example, interpolation will be needed. The cents per mile adjuster between 15,000 miles and 16,000 miles is readily calculated to be $46 (7,704 minus $7,658) for 1,000 miles, or 4.6 cents per mile. Then the table's cost entry for 15,400 miles can be readily determined. Given that each additional mile added to the vehicle after 15,000 miles (and before 16,000 miles) is assumed to drop 4.6 cents from the vehicle's sales price, it can be determined that 400 additional miles on the vehicle would drop $18.40 (.046 times 400) from the value of the vehicle at 15,000 miles. Thus, the appropriate cost entry in the table for a 2004 xxxx yyyy zzzz at 15,400 would be $7,685.60.

Next, the table's cost difference for a 2004 xxxx yyyy zzzz with 12,300 miles (the actual mileage) and a 2004 xxxx yyyy zzzz at 15,400 miles (the average mileage) is determined. This cost difference is readily computed to be $141.60 ($7,827.20 minus $7,685.60).

Using this calculated cost difference, the actual sales price of $8,700 at 12,300 miles can be normalized to a value at 15,400 miles by reducing the actual sales price by the calculated cost difference. Accordingly, $8,700 at 12,300 miles would be normalized to $8,558.40 at 15,400 miles.

This $8,558.40 represents a normalization of the vehicle's actual sales price to the average mileage, thereby providing an indicator of what the sales price for the vehicle would have been had the vehicle had 15,400 miles on the odometer at the time of sale rather than 12,300 miles.

If the vehicle's actual odometer reading at the time of sale is less than the average mileage to which the sales price is to be adjusted, then it can be expected that the sales price adjustment will be a downward adjustment, as in the previous example. If the vehicle's actual odometer reading at the time of sale is greater than the average mileage to which the sales price is to be adjusted, then it can be expected that the sales price adjustment will be an upward adjustment, as in the following example. Assume that a vehicle's actual sales price is $8,000, that vehicle's actual odometer reading at the time of sale was 15,000 miles, and that the average mileage to which the sales price will be adjusted is 13,000 miles. In this case, the calculation of an adjusted sales price will proceed as follows.

First, one would look to the cost per mile table to find a cost entry in the table corresponding to the vehicle's actual mileage (15,000 miles), which in this example is $7,704 (no interpolation would be needed because an exact matching mileage entry is found in the table). Next, the table's cost entry for the average mileage of 13,000 miles is determined. In this example, the table's cost is $7,795 (once again, no interpolation is needed) for 13,000 miles. Once the table entries corresponding to the cost at the actual mileage and the average mileage are known, the difference between these two values can be calculated. In this example, the difference is $91. The adjusted sales price for the vehicle is then $8,091 which represents the actual sales price plus the calculated difference.

It should be noted that the cost per mile table shown above is exemplary only. Each practitioner of the invention may choose to populate the cost per mile table entries with values that correspond to their own business judgment. A preferred technique for creating the cost per mile table is described in Appendix A attached hereto. As described in the flowchart of FIG. 9, this sales price adjustment is performed for each of the vehicles qualifying for that model year's month's column in the residual table 750. Thus, with reference to FIG. 7(a), this adjustment process will operate on all 96 vehicles for model year 2000 MKE MDL SER that were sold in February 2001. After following the technique of FIG. 9, the average historical sales price in February 2001 for 2000 MKE MDL SERs was found to be $12,878 for a 2000 MKE MDL SER having an odometer reading of 28,941 miles. For all 276 vehicles for model year 2001 MKE MDL SER that were sold in April 2002, the average historical sales price was found to be $12,591 for a 2001 MKE MDL SER having an odometer reading of 32,122 miles.

After all of the entries for rows 724 have been populated with the calculated average historical sales price normalized to that month's average mileage, then the entries for rows 726 and 728 can be automatically populated. Rows 726 represent the yearly sales price changes for YMMSs within the YMMS group sold that month relative to YMMSs within the YMMS group sold that month during the previous year. Essentially, the yearly sales price change for Month M during Year Y is the calculated historical sales price in row 724 for Month M and Year Y minus the calculated historical sales price in row 724 for Month M and Year Y-−1. In the example of FIG. 7(a), it can be seen that the row 726 entry for April 2002 is the row 724 entry for April 2002 minus the row 724 entry for April 2001. Rows 728 represent the monthly sales price changes for YMMSs within the YMMS group sold that month relative to YMMSs within the YMMS group sold during the previous month. Essentially, the monthly sales price change for Month M during Year Y is the calculated historical sales price in row 724 for Month M and Year Y minus the calculated historical sales price in row 724 for Month M−1 and Year Y (although when the month in question is January, December of the previous year will be used as the reference point). In the example of FIG. 7(a), it can be seen that the row 728 entry for April 2002 is the row 724 entry for April 2002 minus the row 724 entry for March 2002.

The rows 730 within table 750 are automatically populated with total vehicle sales counts for each month, as determined by the sum of vehicles passing the filter of FIG. 9.

For any data entries for which no data is available, a “--” can be displayed in the pertinent field. For example, because the year 2000 models are the earliest models shown in table 750, it is preferred that row 726 for model year 2000 be left blank because there is no displayed model year 1999 with which to compare the yearly sales price changes.

For the current model year, an additional row 732 will be provided in which the user can input forecasted residual values in fields 734 for the selected YMMS. As this row represents a future prediction, it is present only beginning with the current month onward (and is either not present or left blank for previous months). When determining future residual value(s), not only will the user be able to look to year-to-year historical sales prices normalized to an average mileage, but the user will also be able to look to month-to-month historical sales prices. The month-to-month view will allow users to get a sense for how sales price will decrease or increase from month to month as a YMMS ages from month to month. It is believed that the combination of these beneficial historical views with the user's own business knowledge will enable the user to more accurately estimate future residual value than was available with previous known forecasting systems. These residual value forecasts will help drive the CGF analysis described below.

Once the user has completed a desired number of residual value forecasts in table 750 for the selected YMMS, user selection of “update residuals” button 738 will be operative to save the table 750 in the database and automatically populate the year-to-year and month-to-month changes in rows 726 and 728 as appropriate corresponding to the user-entered residual value(s). However, it is also preferred that table 750 be automatically saved whenever the user navigates to a new page from page 216 (although upon such navigation it may be preferred that a pop-up window ask the user if the table 750 is to be saved). If the user wishes to create/retrieve table 750 for the next YMMS listed in section 710, the user can click on the “next selection” link 740. If the user wishes to create/retrieve table 750 for the previous YMMS listed in section 710, the user can click on the “previous selection” link 736. If a residual table 750 is retrieved for which the forecasted values are more than 30 days old, it is preferred that a warning message to the effect of “values over 30 days old: please update” be displayed on screen 216, preferably just above table 750, below section 710 and to the left of the related tasks button 744

As shown in FIG. 7(b), the related tasks button 744 can be selectable by the user to call up drop down menu 766. Menu 766 preferably provides the user with a selectable link 760 that is operative to export the displayed table 750 to Microsoft Excel, a selectable link 762 that is operative to display printer-friendly page 218 for the displayed table 750 (see FIG. 7(c)), and a selectable link 764 that is operative to route the user into the CGF path 220 at CGF results screen 224 (the CGF results screen being displayed for the vehicle class applicable to table 750).

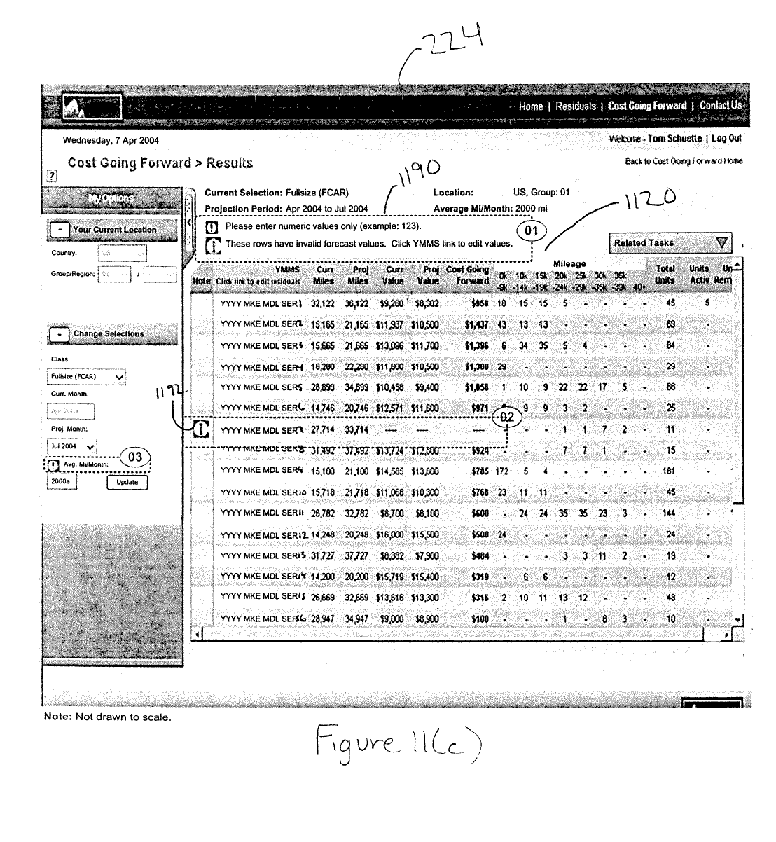

Returning to FIGS. 2 and 4, user selection of links 444 or 452 on home page 208 will cause the user to enter the CGF path 220. FIG. 10 illustrates a preferred CGF parameter entry screen 222 at the start of the CGF path 220. CGF parameter entry screen 222 preferably includes a current location section 400 as previously described for other screens, a vehicle class selection section 1000, an average miles per month input section 1004 and a projection period input section 1008. Using values entered by the user for the various parameters of screen 222, the software will preferably perform a CGF analysis for the YMMSs of a selected vehicle class.

As previously described, current location section 400 displays the current country/group/region values for the user and allows the user to modify the current country/group/region values (depending on the user's level of authorization).

Vehicle selection section 1000 presents the user with a list of selectable vehicle classes in rows 1002a, 1002b, 1002c, . . . for use in the CGF analysis. The vehicle classes can be listed in alphabetical order. Further, the vehicle class corresponding to the vehicle class of the most recent CGF analysis by the user can be highlighted upon the user's arrival to page 222.

Average miles per month input section 1004 preferably provides the user with a field 1006 in which the user can enter a forecasted monthly mileage that the user expects for vehicles of the selected vehicle class in the near future. At the beginning of each calendar month, this value can be recalculated based on past history of the selected vehicle class, and this new average is then preferably displayed as a default value in field 1006. When a user enters a new value in field 1006, it is preferred that this new value be saved as the user's preference such that the new value will be appear by default for the remainder of the month when the user re-accesses screen 222 for the selected vehicle class. Once that month ends however, it is preferred that a new default value be displayed. Preferably, the user will also be restricted from entering a value in field 1006 that is less than 1000 miles or greater than 9,000 miles. It is worth noting that section 1004 can also include a display of a suggested entry for field 1006, the suggested entry being derived from data in the fleet database 100. This entry can either be displayed to the user in a text field or it can be displayed to the user as a selectable option (together with a second field for a user-entered value). It is preferred that this suggested entry, as well as a new default value in field 1006, be calculated by averaging the monthly mileages for all vehicles in the database that meet the following constraints: (1) the vehicle must be a daily rental, (2) the vehicle must have been a daily rental for longer than 35 days, (3) the vehicle must have more than 5,000 miles on its odometer, (4) the vehicle's average monthly mileage must not be greater than 9,000 miles, and (5) the vehicle must not have been purchased used.

Projection period input section 1008 preferably allows the user to specify the projection period for the CGF analysis. Field 1010 displays the current month for the projection period. Field 1010 can be display only. The user inputs the end month for the projection period in field 1012. Preferably, the projection's end month can be from one to six months from the current month. These end months that are available for selection can be listed in a drop down menu associated with field 1012. However, it is worth noting that more or fewer months can be used in the projection period. Further, it is worth noting that this projection period need not be specified in terms of months at all. Other time periods (for example, quarters) could be used.

Once the user has entered the pertinent parameter values on page 222, user selection of the “view results” button 1014 will be effective to launch a CGF analysis for the YMMSs of the selected vehicle class for the displayed country/group/region, using the average monthly mileage in field 1006 and the projection period specified by fields 1010 and 1012. The results of this CGF analysis will be presented to the user via the CGF analysis results screen 224.

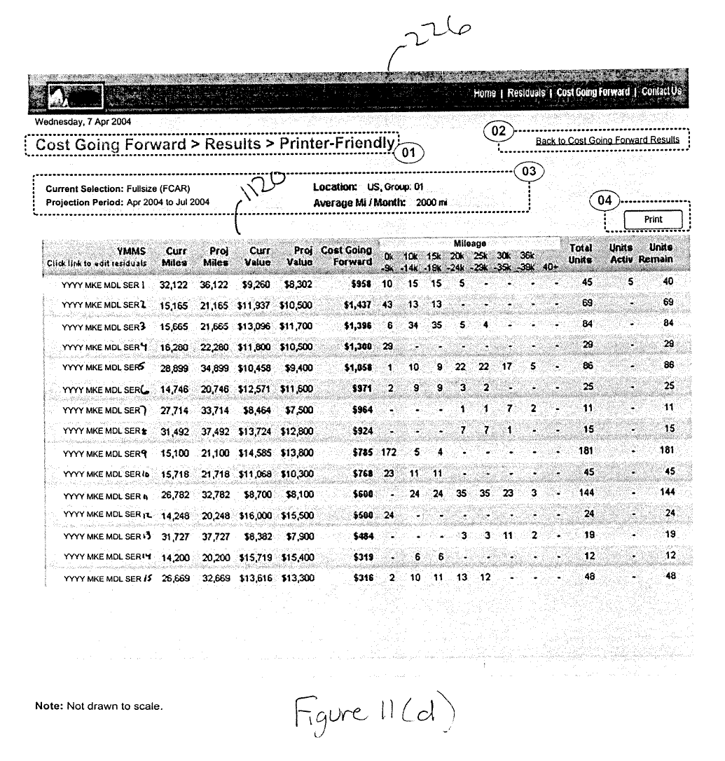

FIG. 11(a) illustrates a preferred CGF analysis results screen 224. The CGF results page 224 has two primary purposes— the first being to display the projected costs going forward for all of the YMMSs in the selected vehicle class and the second being to display the number of vehicles for each YMMS within a plurality of specified mileage ranges. Among the various sections of the CGF analysis results screen 224 are a user options section 1100, an information section 1114, a related tasks button 1180, a CGF results table 1120, and a navigational bar 446. Navigational bar 446 functions as described earlier in connection with home page 208. User selection of link 1178 routes the user back to the CGF parameter entry screen 222.

Within the user options section 1100 is a current location section 400 that is operative as previously described. Also included in section 1100 is a change selections section 1102. Section 1102 provides a field 1104 that allows the user to change the vehicle class selected for the CGF results (preferably, the vehicle class options are presented to the user via a drop down menu associated with field 1104). By default, field 1102 preferably displays the currently selected vehicle class. Section 1102 also preferably provides a field 1106 that notifies the user of the starting month (i.e., the current month) in the projection period as well as a field 1108 that allows the user to enter a new ending month for the projection period. Field 1108 can be defaulted to the currently selected end month for the projection period. Further, section 1102 preferably includes a field 1110 in which the user can enter a new average miles per month value. Field 1110 preferably defaults to the current value for the average monthly mileage. “Update” button 1112 can be provided in section 1102 to allow the user to refresh screen 224 in accordance with any updated values in section 1102.

Information section 1114 informs the user with displays of the currently selected vehicle class, the currently selected location (country/group/region), the currently selected projection period and the current value for average miles per month.

The heart of the CGF results page 224 is found in the CGF results table 1120. The CGF results table 1120 provides current value and future value projections for the YMMSs of the selected vehicle class. Each row 1160a, 1160b, 1160c, . . . in column 1124 corresponds to a different YMMS within the selected vehicle class. Each YMMS listed in row 1160 preferably also serves as a link to the most recent residual value table screen 216 for that YMMS.

For each listed YMMS in rows 1160, there can be a column 1126 for the current mileage as of the current month of the projection period. This value is the average mileage value in row 742 of residual table 750 for the current month and the YMMS in question.

For each listed YMMS in rows 1160, there is also preferably a column 1128 for the projected average mileage for that YMMS at the end of the projection period. This value is the current miles value in column 1126 for that YMMS plus the average miles per month selected for the CGF analysis multiplied by the number of months in the projection period.

For each listed YMMS in rows 1160, there is also preferably a column 1130 for the current residual value for that YMMS. This value is the residual value entered by the user in field 734 of residual table 750 for the current month.

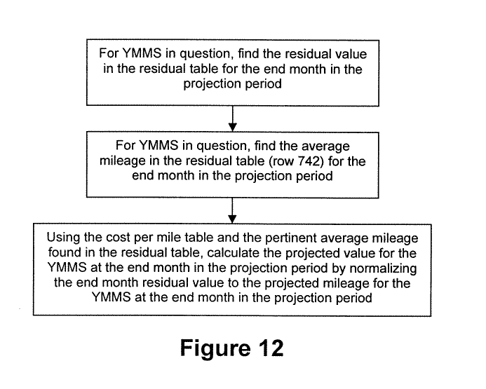

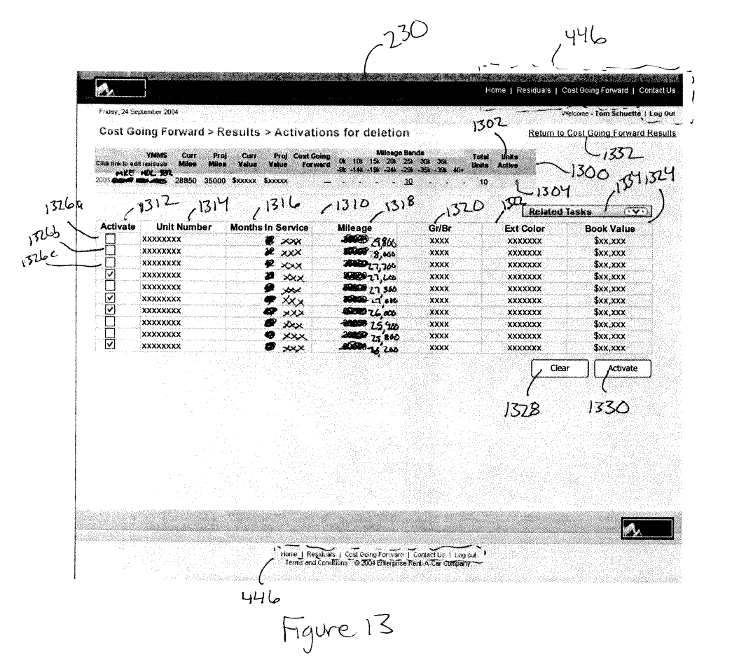

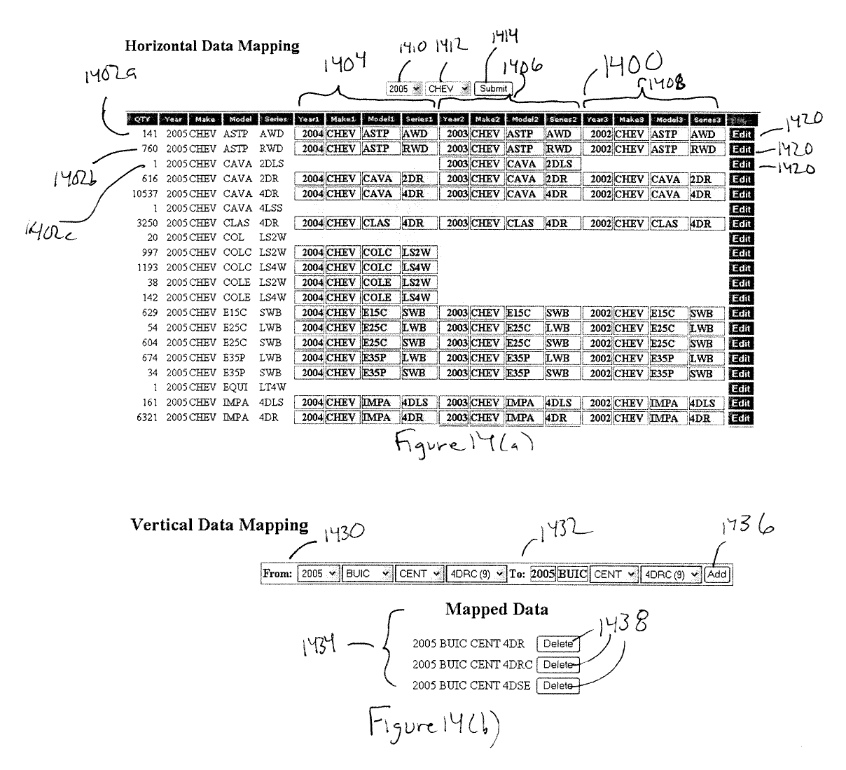

For each listed YMMS in rows 1160, there is also preferably a column 1132 for the projected residual value for that YMMS at the end of the projection period. This value is calculated using the residual value entered for that YMMS in field 734 of the residual table 750 for the end month of the projection period. This residual value is then adjusted for the projected mileage that the YMMS is expected to have at the end of the projection period in accordance with a cost per mile table that relates vehicle values on a mileage basis. FIG. 12 is a flowchart describing a preferred implementation of this normalization process.

An example will help illustrate how the projected values in column 1132 are calculated. Assume that the pertinent values in the residual table 750 for the YMMS in question at the end month in the projection period are as follows for a 2004 xxxx yyyy zzzz:

May: $9,500 for an average mileage of 12,000 miles

July: $8,400 for an average mileage of 14,000 miles Further, assume a two month projection and an average miles per month value of 2,000 miles. Further assume that the current month is May. Using these numbers, the projected mileage will be 16,000 (the base mileage of 12,000 plus two months of 2,000 miles). The goal is to calculate the projected value for a 2004 xxxx yyyy zzzz at 16,000 miles from the residual values of $8,400 at 14,000 miles in July and $9,500 at 12,000 miles in May. In making this projection, the exemplary cost per mile table shown above will be used. This table can be created and used in the same manner described above in connection with the residual table and as set forth in Appendix A.

From this table, it can be seen that the cost adjustment between 14,000 miles and 16,000 miles is a downward adjustment of $92. Accordingly, to normalize the end month residual value for the YMMS to the projected mileage, the end month residual value needs to be decreased by $92. Therefore, in this example, the projected value for the 2004 xxxx yyyy zzzz in July assuming 2,000 miles per month will be $8,308 ($8,400 minus $92).

If exact matching entries are not found in the cost per mile table for the end month average mileage and/or the end month projected mileage, then interpolation can be used as described in connection with the residual table 750 to arrive at the appropriate table cost values.

For each listed YMMS in rows 1160, there is also preferably a column 1134 for the cost going forward (CGF) for that YMMS at the end of the projection period. This CGF value is calculated as the difference between the projected value for the YMMS in column 1132 and the current value for the YMMS in column 1130. These CGF values display to the user the expected changes in value for each YMMS from the start of the projection period to the end of the projection period. The YMMSs in table 1120 can be sorted by their CGF values in column 1134 such that the YMMSs with the largest negative CGF value are displayed at the top of the table. However, this need not be the case.

An additional preferred feature of the CGF results table 1120 is the mileage band section 1136. Section 1136 comprises a plurality of columns 1138 through 1152, each column corresponding to a different range of mileage values, preferably progressing from lower mileages to higher mileages. Populating each row in column 1138 through 1152 can be a count of the number of vehicles for that row's YMMS that fall within the pertinent mileage ranges. The entries in column 1170 for each YMMS correspond to the total count of vehicles in the fleet of interest for that YMMS (subject to the country/group/region and other constraints previously described). These classifications and counts of YMMS vehicles are readily achieved by filtering data in the fleet database. In the example of FIG. 11(a), it can be seen that the count for the YMMS of YYYY MKE MDL SER5 is 86, with 1 of those falling within the 0 to 9,999 mileage range, 10 falling within the 10,000 to 14,999 mileage range, 9 falling within the 15,000 to 19,999 mileage range, 22 falling within the 20,000 to 24,999 mileage range, 22 falling within the 25,000 to 29,999 mileage range, 17 falling within the 30,000 to 35,999 mileage range, and 5 falling within the 36,000 to 39,999 mileage range. It is worth noting that these mileage band breakdowns are only preferred breakdowns. Other mileage band breakdowns can readily be used in the practice of the parent invention.

Furthermore, it is preferred that each entry 1162 in the mileage band section 1136 serve as a link to an activation page for those vehicles in the YMMS mileage band. As will be described in connection with FIG. 13, from the activation page, the user can flag specific vehicles for deletion from the fleet.

For each listed YMMS in rows 1160, there is also preferably a column 1196 for identifying a count of YMMS vehicles within the pertinent total number of column 1170 that have been activated for deletion from the current location's fleet. The entries in column 1198 for each row 1160 thus identifies a count for the remaining unactivated YMMS vehicles within the pertinent column 1170 total count.

Furthermore, it is preferred that each YMMS row in table 1120 include a column 1122 that provides warning notes to the user. For example, in rare circumstances a CGF value may be found to be positive. It is preferred that such anomalous values be flagged for the user's attention so that the user can evaluate the accuracy of the underlying data (e.g., the residual value forecasts). To do so, a warning icon 1192 can be displayed in the appropriate row of column 1122. Additionally, descriptive language for the warning icons 1192 can be displayed on screen 224 above the table 1120, below section 1114 and to the left of related tasks button 1180. Additional examples of warnings for the user can be an “invalid forecast values in the residual table” warning and a “please enter only numeric values” warning, as shown in FIG. 11(c).

As shown in FIG. 11(b), the related tasks button 1180 can be selectable by the user to call up drop down menu 1186. Menu 1186 preferably provides the user with a selectable link 1182 that is operative to export the displayed table 1120 to Microsoft Excel and a selectable link 1184 that is operative to display printer-friendly page 226 for the displayed table 1120 (see FIG. 11 (d)).

As previously mentioned, if the user selects one of the links 1162 in CGF results table 1120, the activations screen 230 of FIG. 13 can be displayed. From this screen, the user is provided with the ability to flag for deletion from the fleet specific vehicles in the YMMS meeting the mileage band constraints of link 1162. Activations screen 230 preferably includes an information section 1300, an activations table 1310, a related tasks button 1334, and a navigation bar 446. Link 1332 is selectable by the user to route the user back to the CGF analysis results screen 224 from which he/she came.

Information section 1300 provides the user with the information presented in the row 1160 in the CGF results table 1120 for the YMMS corresponding to the link 1162 that was selected by the user. However, the only mileage band count that will be shown in section 1300 can be the count for the link 1162 that was selected by the user. It is also preferred that the activated count from column 1196 for the pertinent row in CGF table 1120 be identified in column 1302.

The activations table 1310 preferably displays pertinent data about each listed fleet vehicle in the selected YMMS mileage band and further allows the user to flag specific vehicles for deletion from the fleet. Each row 1326a, 1326b, 1326c, . . . in the table 1310 corresponds to a different vehicle in the fleet meeting the YMMS and mileage band constraints. Column 1314 displays the unique identifier for each vehicle. Column 1316 identifies how many months each vehicle has been in service. Column 1318 identifies the latest odometer readings for each vehicle. Column 1320 identifies the group and branch location where the vehicle resides Column 1322 identifies the exterior color for each vehicle. Lastly, column 1324 identifies the book value for each vehicle (as determined by an accounting or financial department) Based on the user's assessment of which vehicle(s) listed in table 1310 should be deleted from the fleet and sold as a used car, the user can check individual boxes in the “activate” column 1312. User selection of the “clear” button 1328 will be effective to clear all of the checked boxes in column 1312. Preferably, page 230 also includes a “check all” button (not shown) and an “uncheck all” button (not shown) that are effective, upon user-selection, to respectively check each box or uncheck each box in column 1312 automatically. User selection of the “activate” button 1330 will be effective to flag each vehicle having column 1312 checked for deletion. Once flagged, an appropriate message can be communicated to the person in charge of the flagged vehicle (e.g., the branch manager at the branch location where the vehicle is available for rent), thereby allowing the message recipient to promptly pull the vehicle out of the rental fleet and make arrangements for its transfer to the used car market. Alternatively, a database record for an “activated” vehicle can be created that flags that vehicle for deletion. An interested party can thereafter receive a message or report from this database record to become notified of the need to delete the vehicle from the rental fleet and move it to a used car market.

Related tasks button 1334 can be selectable by the user to present the user with options to either export the data of screen 230 to Microsoft Excel or to create a printer-friendly version of screen 230 for printing.

It is worth noting that the selection of any of the links 1162 from screen 224 in columns 1170, 1196, or 1198 also navigate the user to an activations page 230. For users who arrive at page 230 from a link in column 1170, the activations tables 1310 will list each fleet vehicle within the YMMS corresponding to the selected link. For users who arrive at page 230 from a link in column 1196, the activations table 1310 will list only the fleet vehicles within the YMMS corresponding to the selected link that are scheduled for deletion. Lastly, for users who arrive at page 230 from a link in column 1198, the activations table 1310 will list only the unactivated fleet vehicles within the YMMS corresponding to the selected link.

A useful application of the parent invention is its utility for long term fleet planning (LTFP). FIG. 16 depicts an exemplary timetable during which LTFP can be performed, broken down in units of fiscal years, quarters, and months. However, it should be noted that other time intervals may be used. Also, as used herein, a fiscal year may be inclusive of a calendar year. Moreover, it should be noted that the time windows during which the various operations are performed can be adjustable as desired by a practitioner of the invention. FIG. 17 depicts a preferred workflow for LTFP that can be executed within the timetable of FIG. 16. In the preferred embodiment of LTFP, the goal is to intelligently develop a forecast of how many new cars should be purchased for inclusion in a vehicle fleet during an upcoming future time period (such as the next fiscal year). Another goal of LTFP is to intelligently delete aging vehicles from a vehicle fleet. An example of a vehicle fleet for which the preferred embodiment will be described is a rental vehicle fleet.

In the example of FIGS. 16 and 17, a preferred LTFP process is initiated at some point in time prior to the upcoming future time period (the next fiscal year FY x+1), such as in month 7 of the current fiscal year (FY x). During month 7 of FY x, a snapshot of the current vehicle fleet is taken (operation 1602 of FIG. 16 and step 1702 of FIG. 17). This fleet snapshot operation comprises accessing the data stored in database 100 to gather pertinent data about the current state of the rental vehicle fleet.

Another step in the preferred LTFP process involves users of the system entering the short term vehicle needs for the rental vehicle fleet for the remainder of the current fiscal year and the longer term needs for the next fiscal year (operations 1604 and 1606) and optionally beyond. Within the flow of FIG. 17, these operations preferably begin with user assignment of YMMSs to vehicle classes (step 1704). Preferably, these operations also involve defining not only the quantity of rental vehicles in a desired rental vehicle fleet during the current fiscal year and over the next fiscal year (step 1706) and optionally beyond but also a desired mix of rental vehicles across multiple vehicle class types (e.g., 10% economy class vehicles, 40% full size class vehicles, etc.) (step 1708).

Another step 1710 in the preferred LTFP process involves users of the system updating the fleet database 100 to reflect the quantity and types of vehicles that will be incoming to the fleet during the remainder of FY x. With respect to FIG. 16, this operation 1608 will be based on deliveries 1618 expected during the remainder of the current fiscal year. Preferably, these incoming vehicles are new (or possibly used) vehicles that the rental vehicle service provider business has previously purchased from one or more vehicle sources (e.g., manufacturers, dealers, etc.) and for which delivery is expected throughout the remainder of FY x.

Yet another aspect of the preferred LTFP process involves system users performing a CGF analysis on the vehicles within the fleet to assess how many vehicles should be deleted from the fleet during the remainder of the current fiscal year (operation 1612 in FIG. 16 and step 1714 in FIG. 17) and forecasting vehicle deletes over the course of the next fiscal year FY x+1 (and optionally beyond) (operation 1614 in FIG. 16 and steps 1716 and 1718 in FIG. 17). Preferably, another aspect of the LTFP process includes distributing the forecasted deletes over time.

After one or more users has performed these operations, a gross vehicle buy for the next fiscal year FY x+1 can be assembled at step 1720 that is based on an intelligent assessment of fleet needs in terms of desired fleet size, desired fleet mix, and cost-effective vehicle deletions (operation 1610 in FIG. 16). Thereafter, a business such as a rental vehicle service provider can negotiate with various vehicle sources to purchase new vehicles for FY x+1 based on the gross vehicle buy forecast. After the buy orders are placed with the manufacturers, a process of receiving vehicle deliveries during FY x+1 takes place (1620).

It should be noted that while in a preferred LTFP process, the gross buy forecast is only undertaken once per fiscal year, it should be noted that this need not be the case. For example, LTFP can be undertaken on other time intervals, including but not limited to twice per year, three times every two years, or on a rolling incremental basis. Moreover, the forecasting process can optionally be repeated on a smaller scale at some point during a midquarter in the next fiscal year (as shown in operation 1616), which identifies an incremental buy undertaken during the next fiscal year to address changed circumstances that were experienced during the next fiscal year or to correct underestimates of vehicle needs that were entered during the previous fiscal year's LTFP process. Further still, the scheduling of the LTFP process can be segmented by vehicle groups or manufacturers. For example, the LTFP process can be run during M7 of FY x for vehicles that are members of Vehicle Class A (or YMMS X, or manufactured by Manufacturer 1) and during M8 of FY x for vehicles that are members of Vehicle Class B (or YMMS Y, or manufactured by Manufacturer 2).

Preferably, the plurality of LTFP tasks shown in FIG. 17 have a hierarchical order. This hierarchical order is defined by which tasks must be completed before downstream tasks should be undertaken. Within this order, if Task 1 is upstream from Task 2, and Task 1 has been completed, then a user can begin to work on Task 2. Once Task 2 is completed, a user can still perform additional work on Task 1, but any modifications to Task 1 may require that Task 2 be revisited to account for the modifications in the upstream task. An example of this scenario can be the optimal delete point process task (1716) and the deletion distribution task (1718), wherein the optimal delete point process task must be completed for a fleet before a user can begin work on the deletion distribution task. Similarly, if both the optimal delete point process task and the deletion distribution task have been completed by users, but then a user modifies the data entry in the optimal delete point process task, then the deletion distribution task will need to be revisited by a user to assess whether the modifications in the optimal delete point process task necessitate changes in data entry for the deletion distribution task.

Other tasks in the workflow share the same hierarchical order and can be completed independently of each other. For example, the collective tasks of operations 1704, 1706, and 1708 share the same hierarchical order as the task of operation 1710 and the task of operation 1712. However, within the collective tasks of operations 1704, 1706, and 1708, the task of operation 1704 is upstream from both the tasks of operations 1706 and 1708 (wherein the tasks of operations 1706 and 1708 are parallel with each other). Thus, presuming that users have completed the tasks of operations 1704, 1706, 1708, 1710 and 1712, and subsequent to these completions, a user modifies data entry for operation 1704, then users will need to revisit operations 1706 and 1708, but not operations 1710 or 1712. However, it should be noted that the operation 1704 task can be optionally rendered non-modifiable by the software once it has been completed. Also, it should be noted that tasks of operations 1706 and 1708 can be ordered hierarchically such that operation 1706 is upstream from operation 1708.

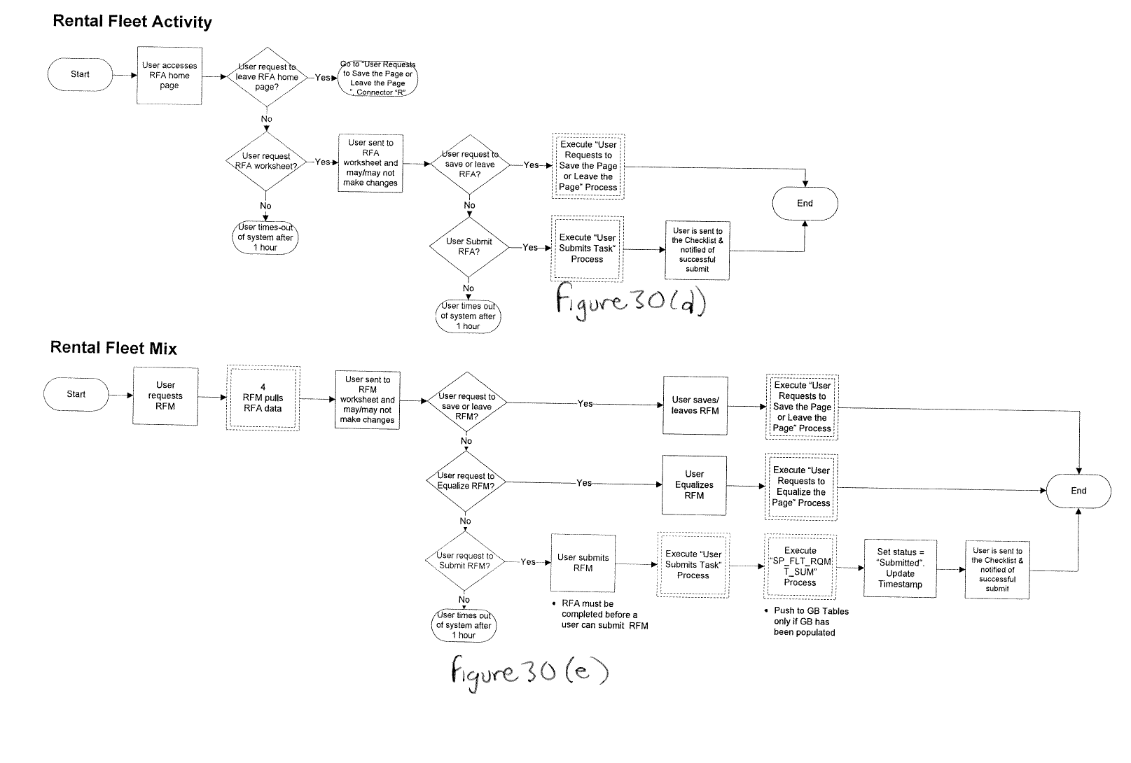

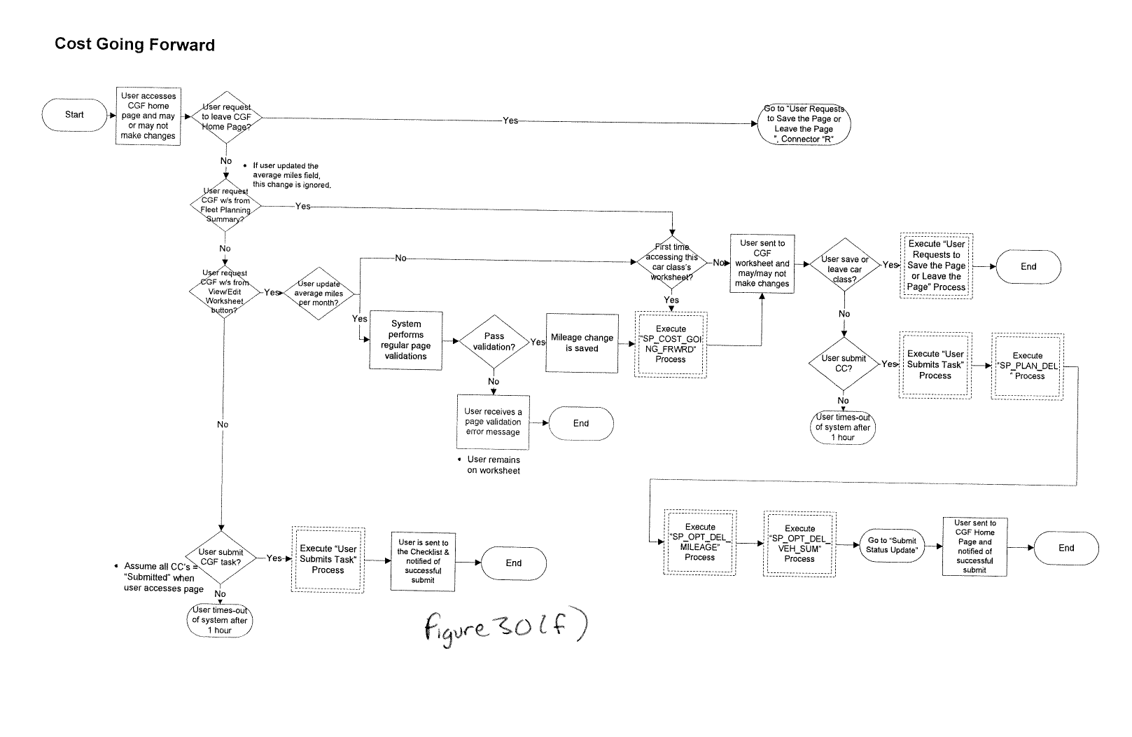

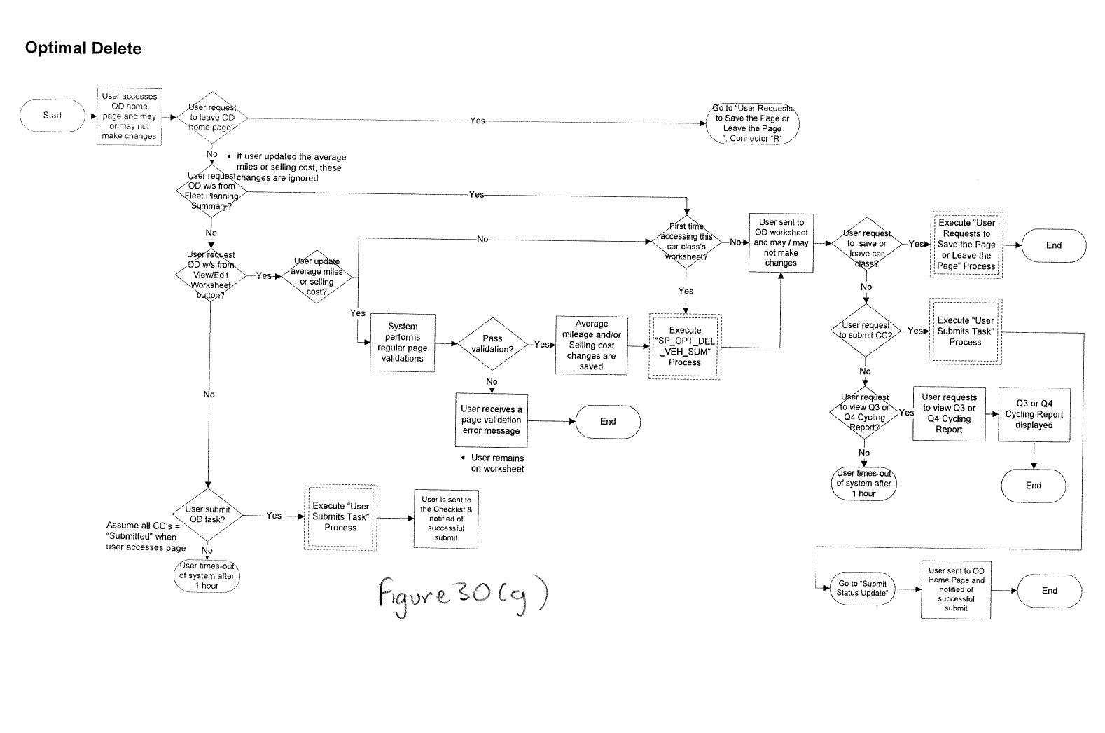

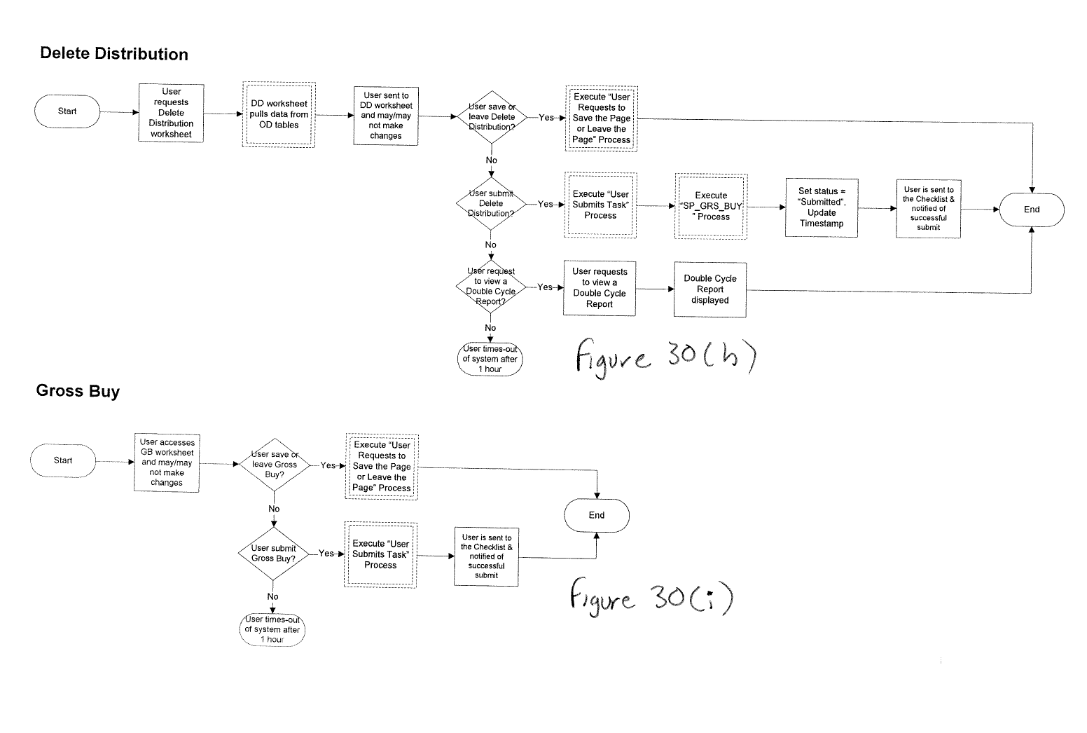

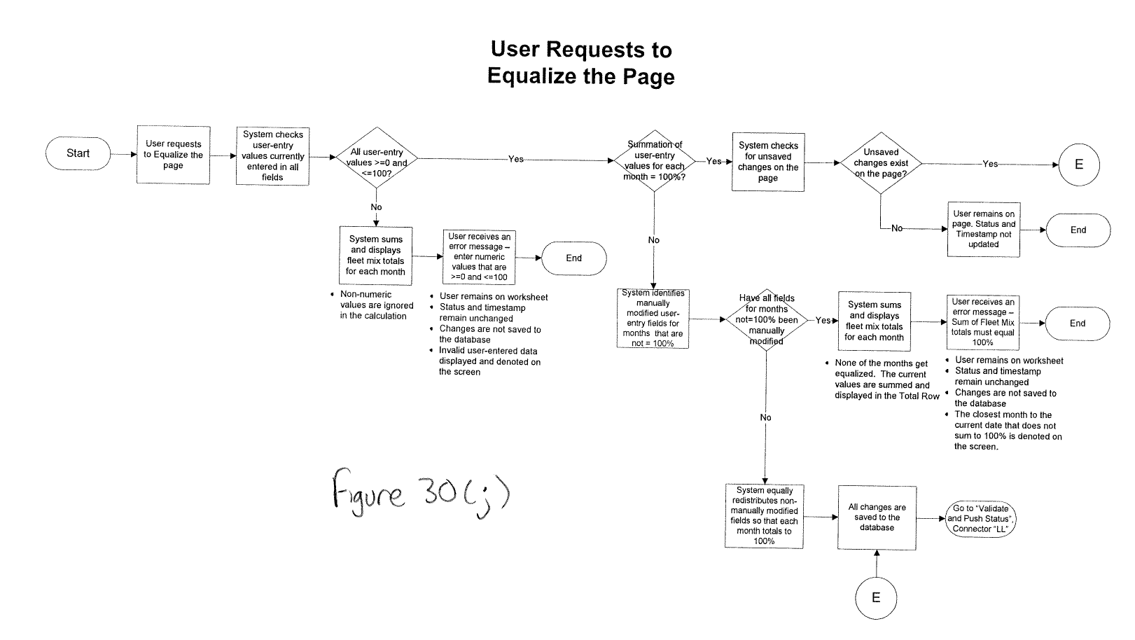

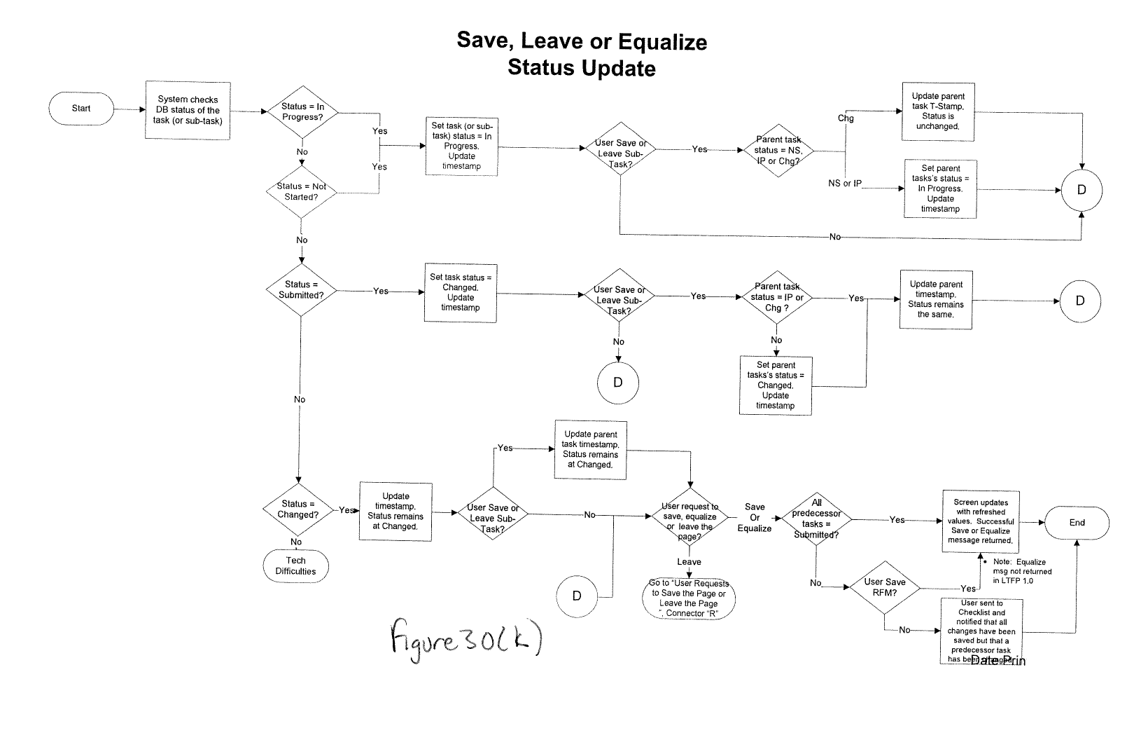

To keep users apprised of workflow task completion, each operation can be assigned a status by the planning software that is indicative of each task's progress toward completion. Preferably, these statuses include an identifier that signifies a task is completed and no more work needs to be done thereon, an identifier that signifies that work has not yet begun on a task, an identifier that signifies work is in progress on a task, and an identifier that signifies that modifications to an upstream task have triggered a need to re-evaluate a task. FIG. 30(r) and the related process flows describe this aspect of the invention in greater detail. Because of the planning software's ability to manage task statuses, users have the ability to enter data simultaneously for a plurality of tasks. Further still, because of the ability to segment task completion by different groups, regions, etc., the LTFP process of FIG. 17 can be accessed simultaneously for a plurality of subfleets within the fleet.

FIG. 18 depicts a preferred start screen 1800 for the LTFP process of FIG. 17. Through field 400 of screen 1800, the user 1802 can define the relevant fleet of interest for which some aspect of the LTFP process will be performed. User entry within field 400 preferably operates as previously described. Screen 1800 also preferably includes a display section that is arranged in a plurality of columns—a column for describing the different planning steps of LTFP, a column with links for accessing various screens dedicated to various steps of the LTFP process, a column 1822 with links 1824 for accessing reports based on the screens of the LTFP process, a column 1830 which identifies a due date for users to complete the various steps of the LTFP process, and a column 1832 that identifies a status of user action in connection with each step. FIG. 30(r) depicts a preferred state diagram for the different statuses that may exist. If no users have taken action on a task, the status is displayed as “not started”. If a user has accessed a screen dedicated to an LTFP task and saved/updated his/her work but has not submitted data for use downstream in the LTFP process, the status is displayed as “in progress”. Once a user has actually submitted data through a screen for use downstream in the LTFP process, the status is displayed as “submitted”. Lastly, if a user reopens a screen dedicated to a step/task whose status is “submitted” and saves data changes to that task, then the displayed status changes to “changed”, a status at which it will remain until another submission is performed. This status of “changed” may propagate to upstream or downstream tasks whose status was previously “submitted” if the saved changes would trigger a need to reevaluate those upstream or downstream tasks. FIGS. 30(j)-(q) depict various process flows for updating task statuses in response to user interaction with the system.

FIG. 19 depicts an exemplary screen 1900 for user input to assign YMMSs to vehicle classes. The user can reach screen 1900 in response to selection of link 1804 in screen 1800. Screen 1900 preferably includes a current location display section 400 that functions as previously described. Furthermore, section 1902 provides a user with a view of the general task he/she is performing, the vehicle class into which the screen is configured to assign YMMSs and the user's current location in the fleet. Through field 1904 and “change” button 1906, the user can control the vehicle class into which assignments will be made. Preferably, through field 1904, the user can access a drop down menu that lists the plurality of vehicle classes that are available for selection. Once a vehicle class has been selected, section 1910 will list the YMMSs that are currently members of the selected vehicle class. Section 1912 will list any YMMSs that have not yet been assigned to a vehicle class. If the user wants to remove an assigned YMMS from the selected vehicle class, he/she can do so by selecting that YMMS from within section 1910 and then selecting the “Unassign Selected” button 1914, which will operate to move that YMMS out of section 1910 and into section 1912. If the user wants to assign an unassigned YMMS to the selected vehicle class, he/she can do so by selecting that YMMS from within section 1912 and then selecting the “Assign Selected” button 1916, which will operate to move that YMMS out of section 1912 and into section 1910. Once a user has entered any desired changes for the YMMS-to-vehicle class assignments, the user has an option to select the “save/update” button 1918 or select the “submit for fleet planning” button 1920. Button 1918 is effective to save any changes that the user has made, but is not effective to push those changes such that they will affect downstream tasks in the LTFP process. Essentially, selection of the “save/update” button 1918 will be effective to change the task's status to “in progress”. Button 1920 is effective to submit the user's YMMS-to-vehicle class assignments such that those assignments will affect downstream process(and/or upstream processes where appropriate). FIGS. 30(a), (1), and (m) illustrate this flow in greater detail.

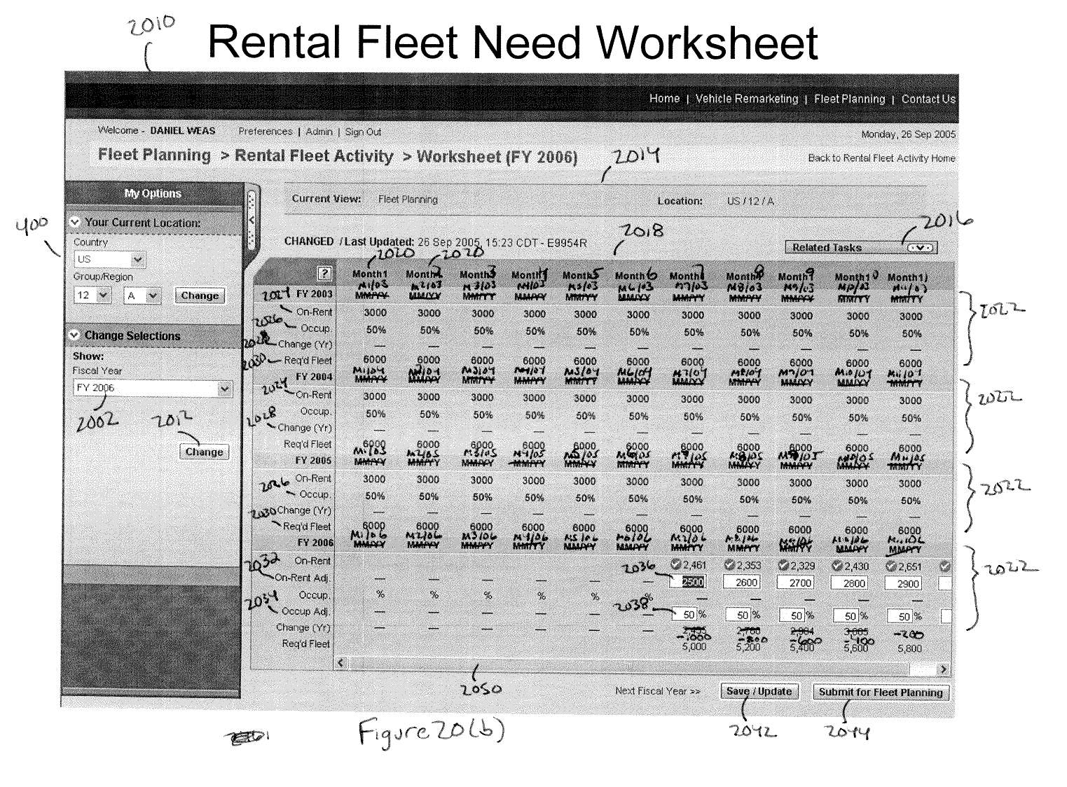

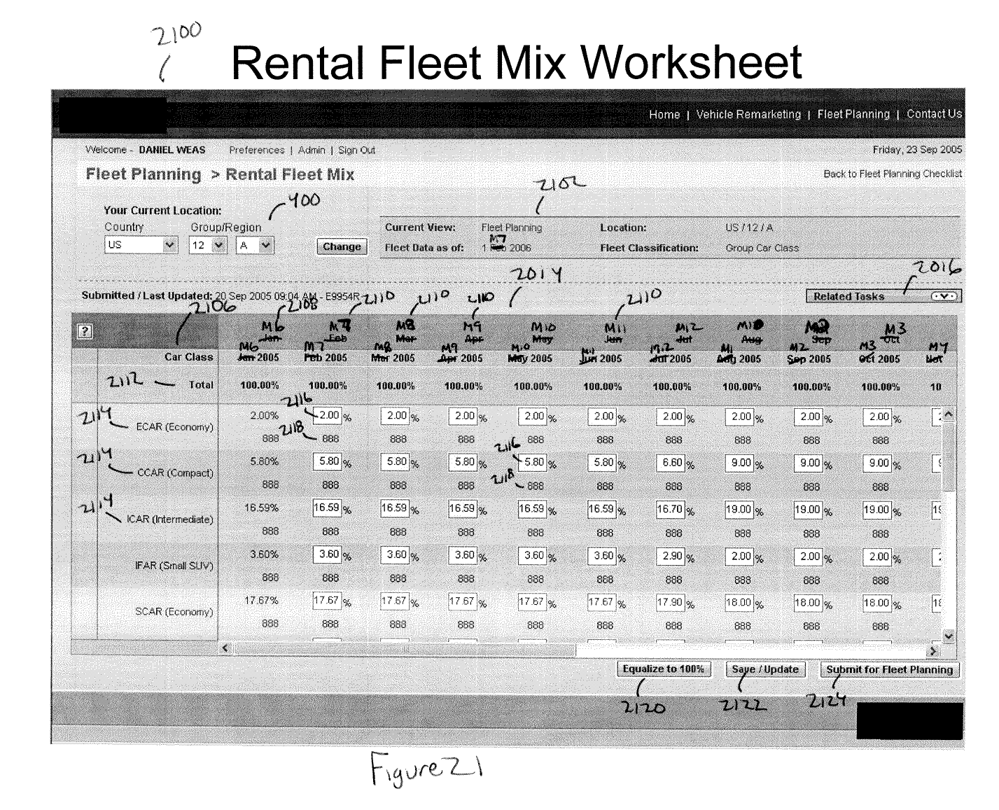

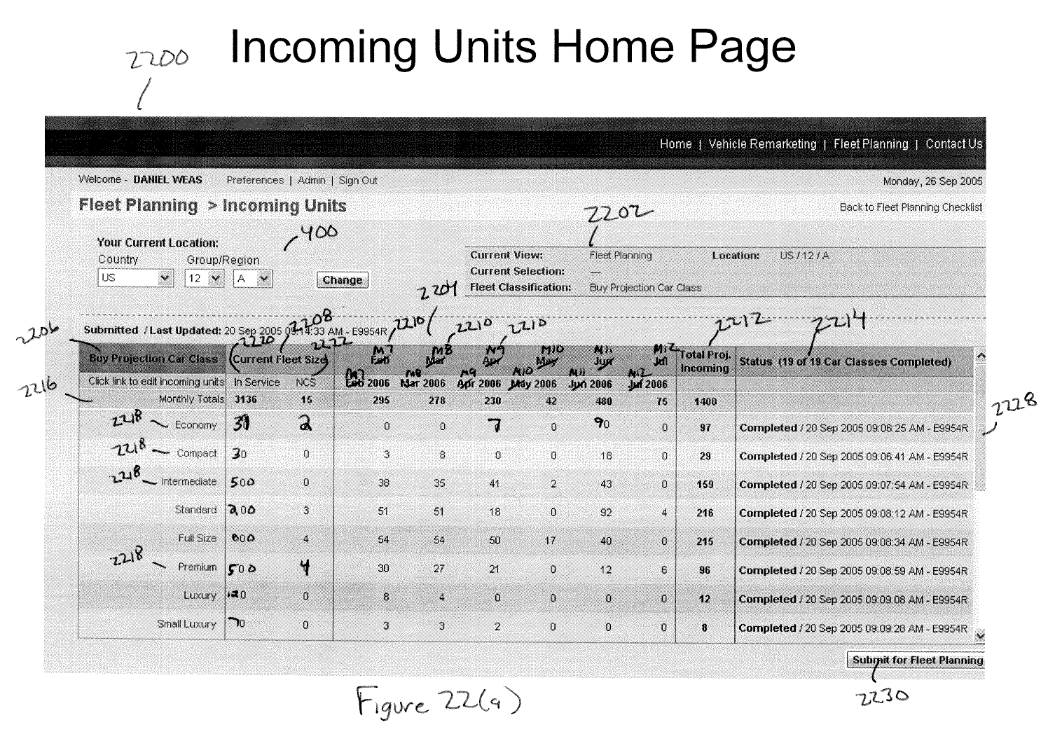

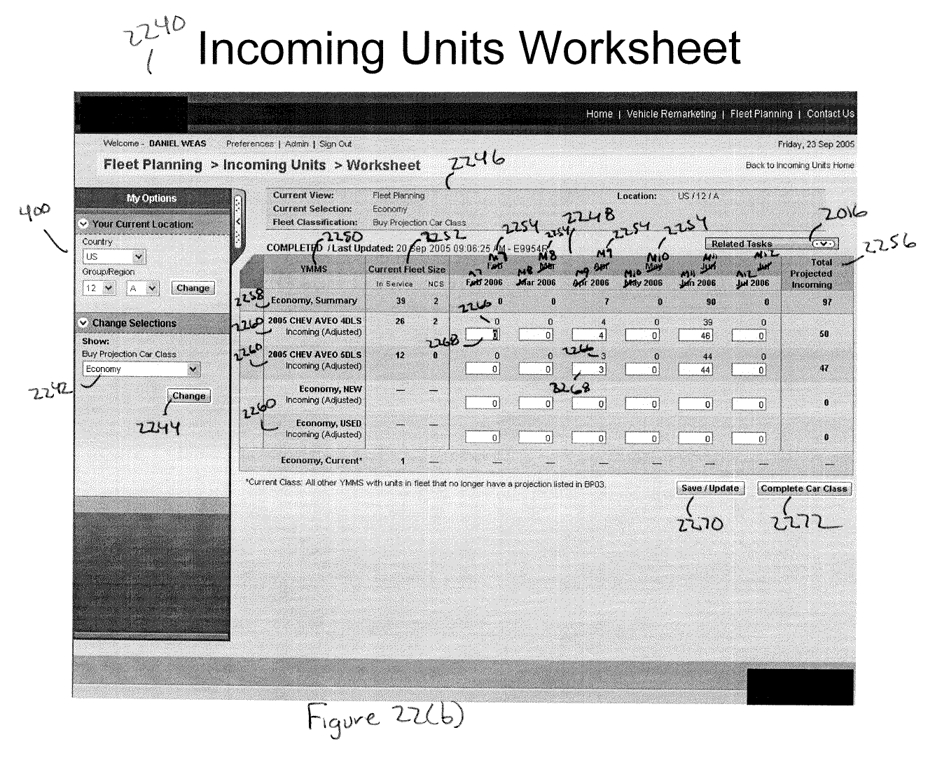

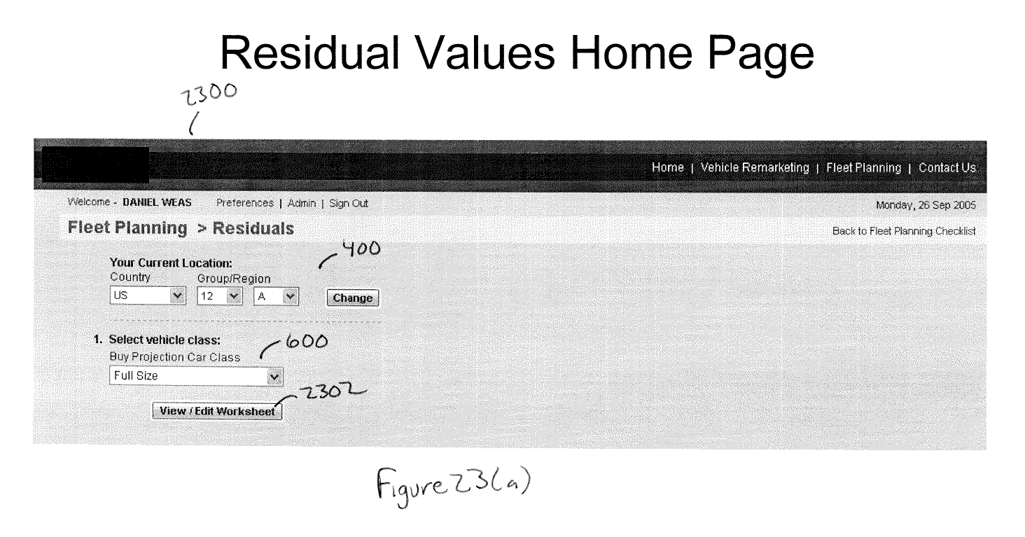

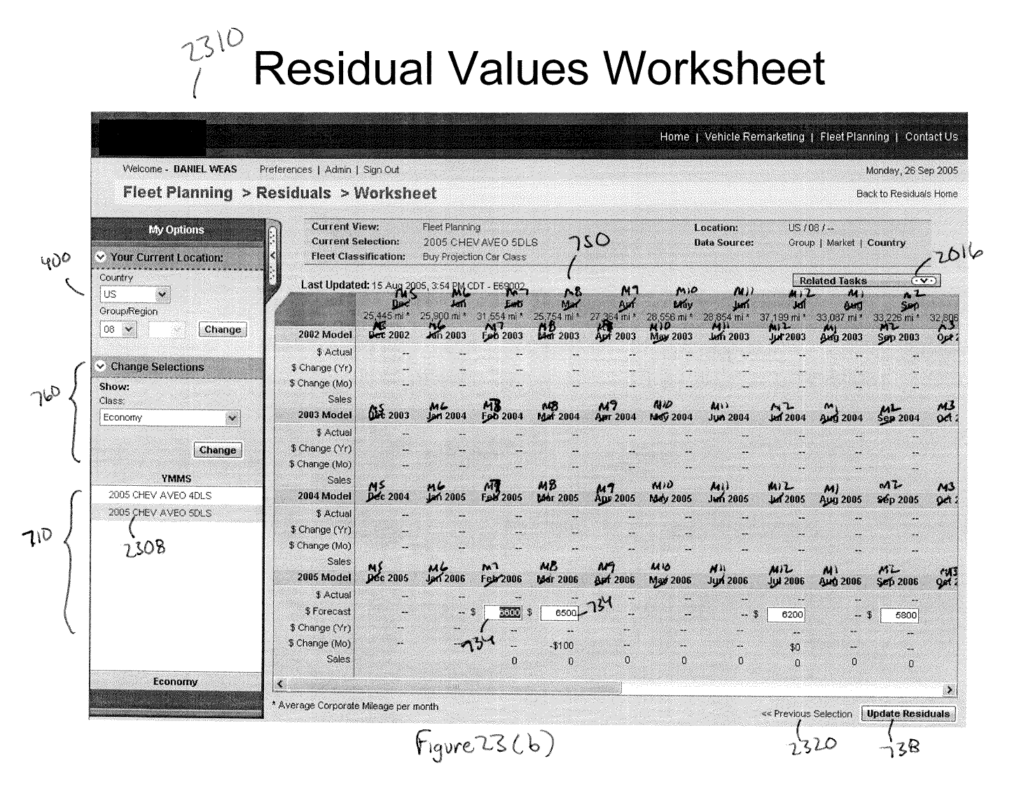

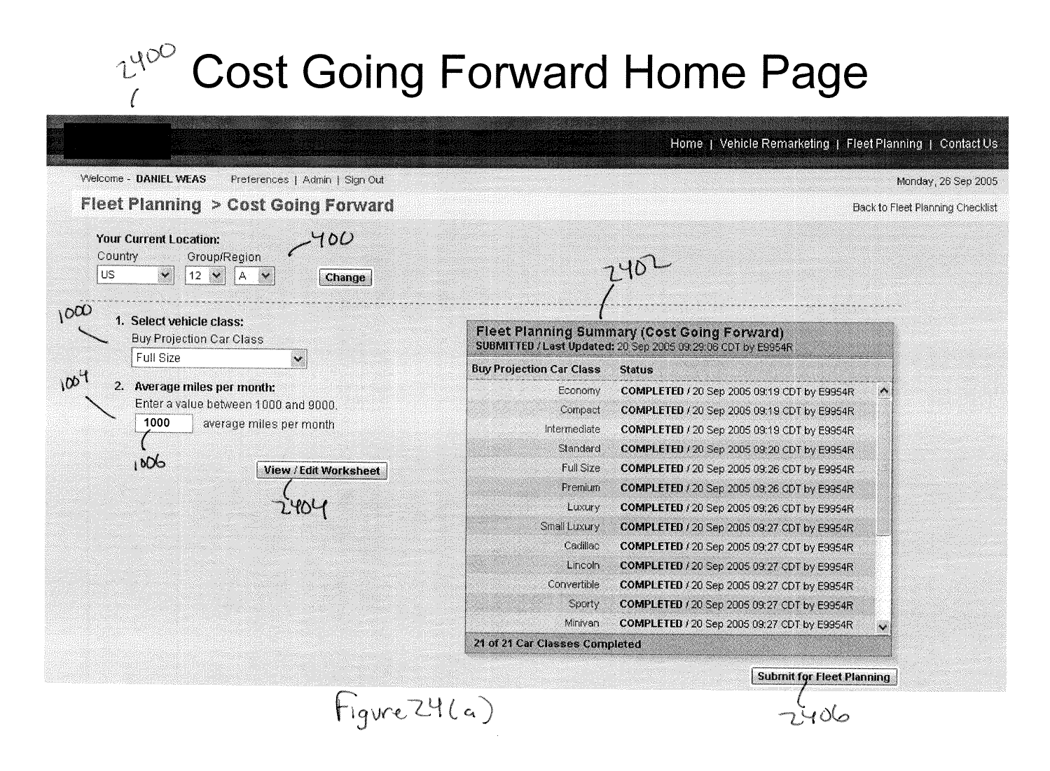

Once appropriate vehicle class assignments have been made, the user can choose to work on either task 1706 or task 1708. If the user wishes to work on task 1706, he/she can do so by selection of link 1806 in screen 1800. User selection of link 1806 is effective to display screen 2000 of FIG. 20(a). Screen 20(a) is a home page for initiating the process of a user to define a desired quantity of vehicles in the rental fleet. User entry in section 400 is effective to define the fleet that will be subject to this process. Furthermore, through field 2002, the user can specify the time period (preferably in terms of fiscal years) for which the user will define the desired fleet size. Preferably, field 2002 includes a drop down menu that can be accessed by the user to list a plurality of fiscal years that are available for selection. Once the user has defined the fleet and specified the appropriate fiscal year via section 400 and field 2002, user selection of button 2004 is effective to display screen 2010 of FIG. 20(b).

Screen 2010 is configured to allow the user to enter a desired fleet size for various time subperiods within the time period specified via field 2002. Preferably, these time subperiods are months within the specified fiscal year. From screen 2010, the user has the option to change the specified time period via user entry in field 2002 coupled with selection of the change button 2012. Section 2014 of screen 2010 summarizes the currently defined fleet. Through scroll bar 2050, the user can scroll section 2018 to display any months in the fiscal year that do not fit in a single scroll position.

Section 2018 of screen 2010 is a data table that displays historical fleet size and rental activity data and includes fields for user entry of desired fleet sizes for future months within the specified fiscal year. Preferably, section 2018 is organized in a plurality of rows and a plurality of columns. Columns 2020 correspond to the different months within the specified fiscal year. Row sections 2022 correspond to previous fiscal years progressing to the specified fiscal year. Within each fiscal year row section 2022, there can be a row 2024 corresponding to an average daily count of “on rent” vehicles for each day during a particular month. As used herein, an “on rent” vehicle refers to a vehicle that was rented to a customer. Row section 2022 also preferably includes a row 2030 corresponding to an average daily count of the total number of vehicles within the fleet during a particular month. Row section 2022 also preferably includes a row 2026 corresponding to an occupancy percentage for the vehicles within the fleet. This occupancy value represents each month's percentage of on rent vehicles (row 2024) to total vehicles (row 2030). Lastly, row section 2022 also preferably includes a row 2028 corresponding to the change in the row 2030 values from year-to-year for that month. In the example of FIG. 20(b), wherein the sample data shows the same number of vehicles in row 2030 for each month of each year, the values in row 2028 are all zero. However, in typical real world situations where the row 2030 values will fluctuate over time, the row 2028 values will typically be non-zero values.

The display of this historical data in section 2018 allows the user to identify trends in rentals that may help that user to intelligently assess the needs of the rental fleet in terms of quantity. Contributing to the ability to intelligently assess the vehicular quantity needs of the rental fleet is section 2018's tabular arrangement, which allows the user to efficiently identify both successive month trends in rental activity and monthly year-to-year trends. That is, the user can easily identify the direction of rental activity over consecutive months (for example, to identify whether rental activity has been increasing or decreasing over the past 6 months). The user can also identify whether certain months are particularly busy, quiet, or trending one way or the other (for example, the table may show that rental activity is typically high during May and July but slow during April, regardless of the year).

In the row section 2022 corresponding to the fiscal year specified in field 2002, the row 2024 values for future months are computed as forecasted on rent values based on historical on rent and occupancy data. Any of a variety of techniques can be used to compute these forecasts. However, a preferred technique comprises an on rent forecast calculation based on a state space model that captures and correlates historic patterns in growth trends and seasonality. These values can be coupled with an indicator 2040 (for example, a checkmark) to notify the user that these are forecasted values rather than actual historical data. Also, in the row section 2022 corresponding to the fiscal year specified in field 2002, there can be a row 2032 that includes fields 2036 for user entry of desired number of “on rent” vehicles for the month. Through field 2036, the user can adjust the forecasted “on rent” value shown in row 2024 for that month and year. Furthermore, in the row section 2022 corresponding to the fiscal year specified in field 2002, there can be a row 2034 that includes fields 2038 for user entry of an expected occupancy percentage for the month. Through field 2038, the user can adjust the forecasted occupancy percentage value shown in row 2026 for that month and year. The user may wish to use field 2036 and 2038 to adjust the “on rent” and occupancy percentage values based on his or her business judgment with regard to the needs of the fleet. The row 2028 and 2030 values for the row section 2022 corresponding to future months of the fiscal year specified in field 2002 are automatically computed and displayed based on the values in rows 2032 and 2034.

Once the user has completed his/her estimation of the rental fleets needs via screen 2010, the user can either save/update his/her work via button 2042 or submit his/her work for use downstream in the fleet planning process via button 2044. FIGS. 30(d), (1), and (m) illustrate this flow in greater detail. Furthermore, the user has the option to export the data on screen 2010 to a spreadsheet program such as Microsoft Excel through selection of button 2016 and/or print the screen.

In an LTFP operation, the user preferably enters the fleet need data in screen 2010 not only for the remainder of the current fiscal year, but also for the next fiscal year (and optionally beyond). As noted, the user display a screen 2010 for entering rental fleet needs for a different fiscal year through appropriate user entry in field 2002.

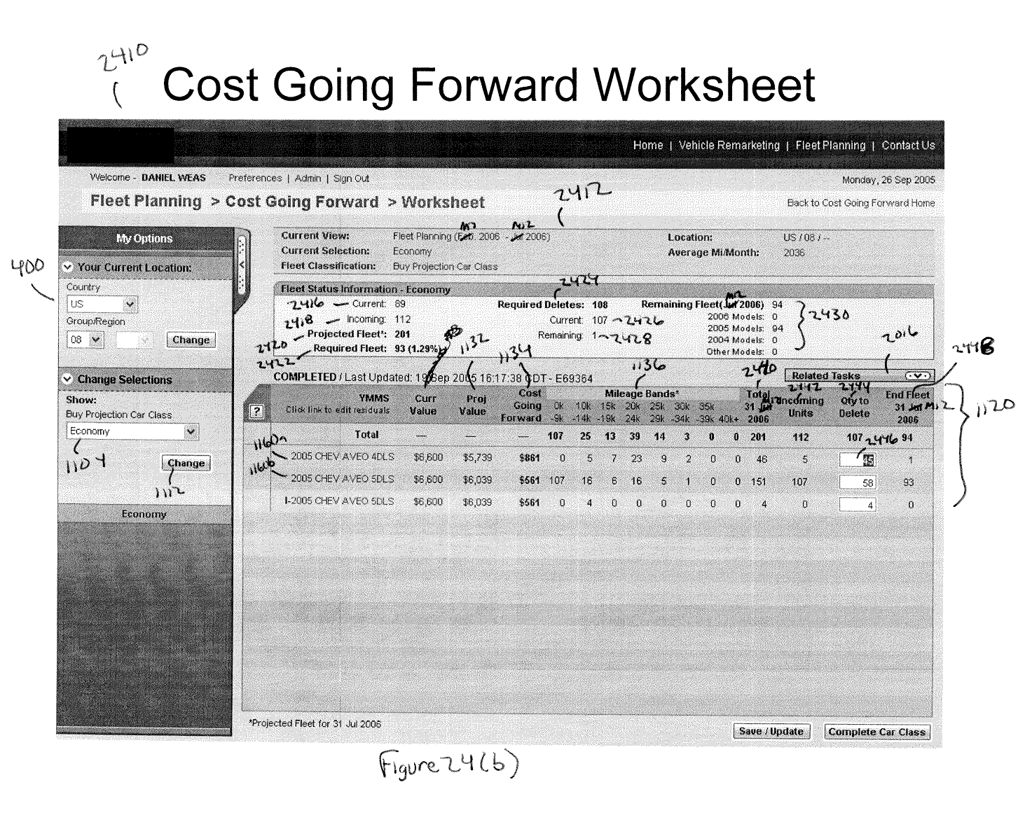

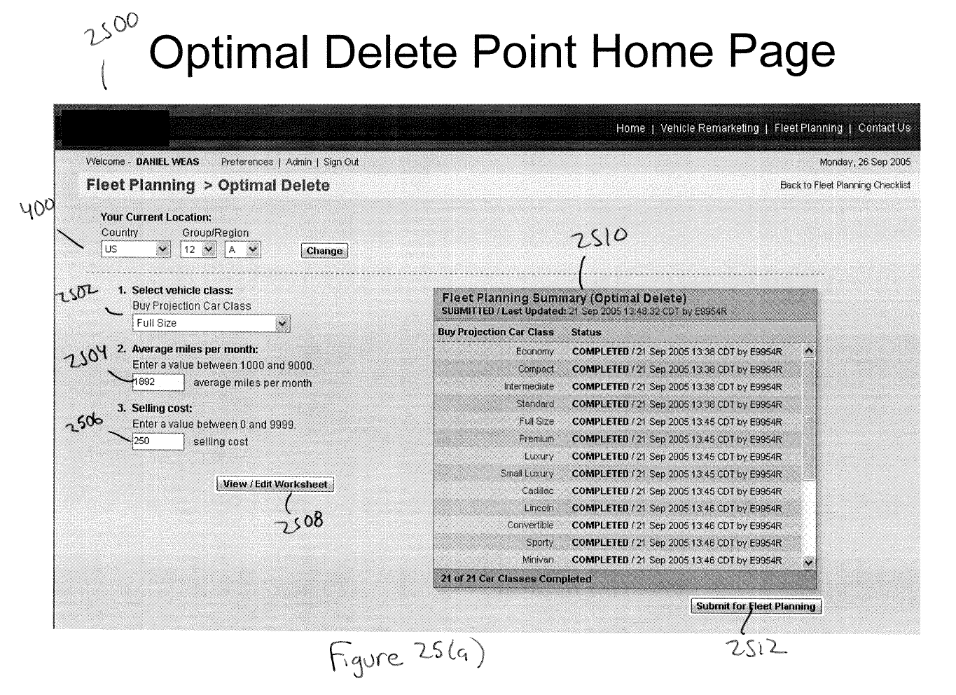

In addition to defining a desired quantity of vehicles in a fleet for future time periods, it is preferred that users also define a desired mix of vehicles in the fleet for future months across vehicle classes. To define this desired vehicle class mix, the user can select link 1808 in screen 1800. Upon user selection of link 1808, screen 2100 of FIG. 21 is displayed. Screen 2100 preferably includes a current location display section 400 and a view section 2102 that summarizes what the user is working on.

Screen 2100 also preferably includes a section 2104 for user entry of a desired fleet mix for a future time period. As used herein “fleet mix” refers to an allocation, for each of a plurality of vehicle classes, of a quantity of vehicles of a particular vehicle class within a fleet that comprises vehicles of a plurality of vehicle classes. The future time period encompassed by screen 2100 preferably covers the remainder of the current fiscal year and the entire next fiscal year (and optionally beyond). However, it should be noted that other time periods could also be used in the practice of the parent invention. Section 2104 preferably divides this future time period into a plurality of subperiods, preferably months. However, once again, it should be noted that other time subperiods such as quarters or weeks could also be used. Preferably, a user has completed and submitted data for the time period of interest via screen 2010 before screen 2100 is accessed; however, this need not be the case.

Section 2104 preferably comprises a table arranged in a plurality of rows and a plurality of columns. Column 2106 corresponds to a vehicle class. Column 2108 corresponds to the most recent month immediately prior to the time period of interest. Columns 2110 correspond to the different months of the time period of interest. Row 2112 corresponds to a total sum of the fleet mix percentages entered in the table. Row sections 2114 correspond to different vehicle classes. Each row section 2114 preferably includes two rows—row 2116 and row 2118. In column 2108, row 2116 displays the percentage of vehicles within the fleet that are vehicles of the same class as the vehicle class corresponding to that row section. Row 2118 in column 2108 displays the total count of vehicles within the fleet that are members of the vehicle class corresponding to that row section. The YMMS-to-vehicle class assignments that are made via screen 1900 aid this process. The data in the table at column 2108 serves as historical values that can be used as a baseline for assessing what the future fleet mixes should be. Row 2116 in columns 2110 preferably comprises a field in which the user can enter a desired fleet mix for each vehicle class. The fields in row 2116 can optionally be pre-populated with the mix percentage for that row section in column 2108, which can alleviate the data entry burden on the user if the user desires to adjust less than all of the fields. Row 2118 displays the vehicle quantity for that vehicle class within the fleet based on the specified fleet mix percentage in row 2116. This value can be computed as follows: the row 2118 value for Month x in Fiscal Year y equals the row 2030 value for month x in fiscal year y times the row 2116 percentage value for month x in fiscal year y. In instances where this computed number is not a whole number, the process preferably rounds the computed value to the nearest whole number.

The values in row 2112 represent the sums of the fleet mix percentages in rows 2116 for each month. This sum should equal 100%. In the example where the row values are prepopulated based on the historical data in column 2108, user adjustments in any of the fields for row 2116 may cause the row 2112 sum to depart from 100% for one or more months. The user has an option to correct this deficiency by manually adjusting one or more of the fleet mix percentages until the percentage sum for that month returns to 100%. However, the user also has the option to automatically equalize the fleet mix percentages for the different vehicle classes in a given month via user selection of the “equalize to 100%” button 2120. User selection of button 2120 operates to automatically adjust the unadjusted fleet mix percentages for a month whose fleet mix numbers have been adjusted to cause a departure from the 100% sum to effectuate an equal redistribution of the unadjusted fleet mix percentages such that the fleet mix percentage sum is once again 100%. To perform this equalization, the equalized fleet mix percentages for a given month will be those fleet mix percentages within that month that were not manually adjusted by the user. The equalized fleet mix percentages for a particular vehicle class in a particular month can be calculated as follows:

$${y}^{′} = y ( 1 + \frac{a}{b} )$$

wherein y′ represents the equalized fleet mix percentage value for that class and that month, wherein y represents the unequalized fleet mix percentage value for that class and that month plus, wherein a represents the sum of differences between the modified fleet mix percentage values for that month and that class and the previous values for the modified fleet mix percentage values for that class and that month (a may be a positive or negative number depending on the direction of the modification), and wherein b represents the sum of unequalized fleet percentage values for that month and that class. The table below provides an example of how this equalization process works in an example where the fleet mix percentage value for “Class 1” is modified from 25% to 40%. When equalization is performed, the fleet mix percentage values for Classes 2-6 are recalculated to values as shown below.

| | | Modified | Modified |
|---|---|---|---|
| | | and | and |
| | Original | Unequalized | Equalized |
| | Fleet Mix | Fleet Mix | Fleet Mix |
| | % s | % s | % s |
| Class 1 | 25% | 40% | 40% |
| Class 2 | 20% | 20% | 16% |
| Class 3 | 20% | 20% | 16% |
| Class 4 | 20% | 20% | 16% |
| Class 5 | 10% | 10% | 8% |
| Class 6 | 5% | 5% | 4% |
| Fleet Mix | 100% | 115% | 100% |
| Sum | | | |

FIG. 30(j) illustrates this equalization process in greater detail.

Using the scroll bars shown in section 2104, the user can adjust section 2104 to display any months and/or vehicle classes in the specified time period that do not fit in a single scroll position. Once the user has completed any data entry that he/she wishes to enter through screen 2100, the user can either save/update his/her work via button 2122 or submit his/her work for use downstream in the fleet planning process via button 2124. FIGS. 30(e), (k), (1), and (m) illustrate this flow in greater detail. Furthermore, the user has the option to export the data on screen 2100 to a spreadsheet program such as Microsoft Excel or print the screen through selection of button 2016.

Thus, through interaction with screens 2010 and 2100, users have the ability to define the desired size and mix of their fleets for future months, thereby completing one aspect of the LTFP process. While in the embodiment described herein, total quantity forecasts and fleet mix forecasts were performed through separate user interfaces, it should be noted that these two tasks could be combined into a single interface if so desired by a practitioner of the parent invention.

Also, it is worth noting that the tasks defined by the screens of FIGS. 20(a), 20(b), and 21 can be performed at a group and/or region level (defined by section 400) within the fleet. For some businesses, each group/region may utilize a different mapping of YMMSs to vehicle classes. In such instances, it is preferred that a global mapping operation be performed after the completion of tasks 1706 and 1708 to re-map each group/region's YMMS assignments into a global (business organization-wide) assignment of YMMSs to vehicle classes. This re-mapping can be performed automatically based on a global assignment of YMMSs into vehicle classes via a screen such as described for FIG. 19. Thus, consistency to a degree can be maintained when performing a gross buy for multiple groups/regions. However, in a preferred system, each group/region will utilize the same mappings of YMMSs to vehicle classes. In the exemplary preferred embodiment described herein, it will be presumed that each group/region utilizes the same mapping of YMMSs to vehicle classes.

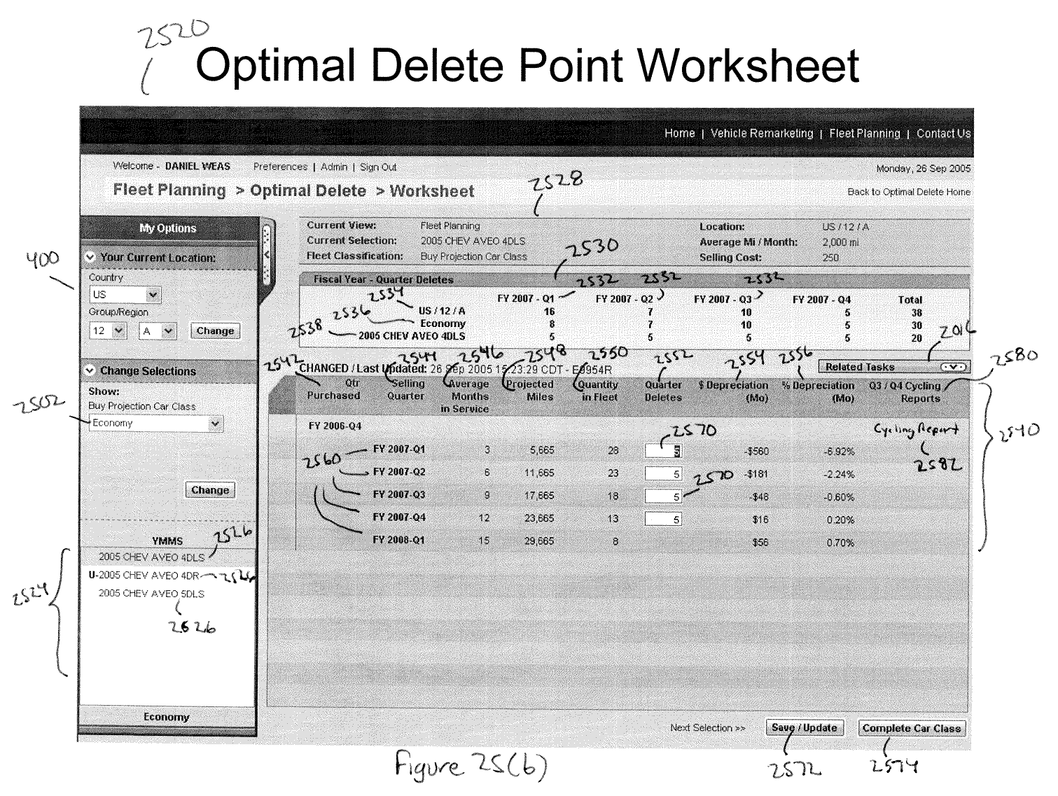

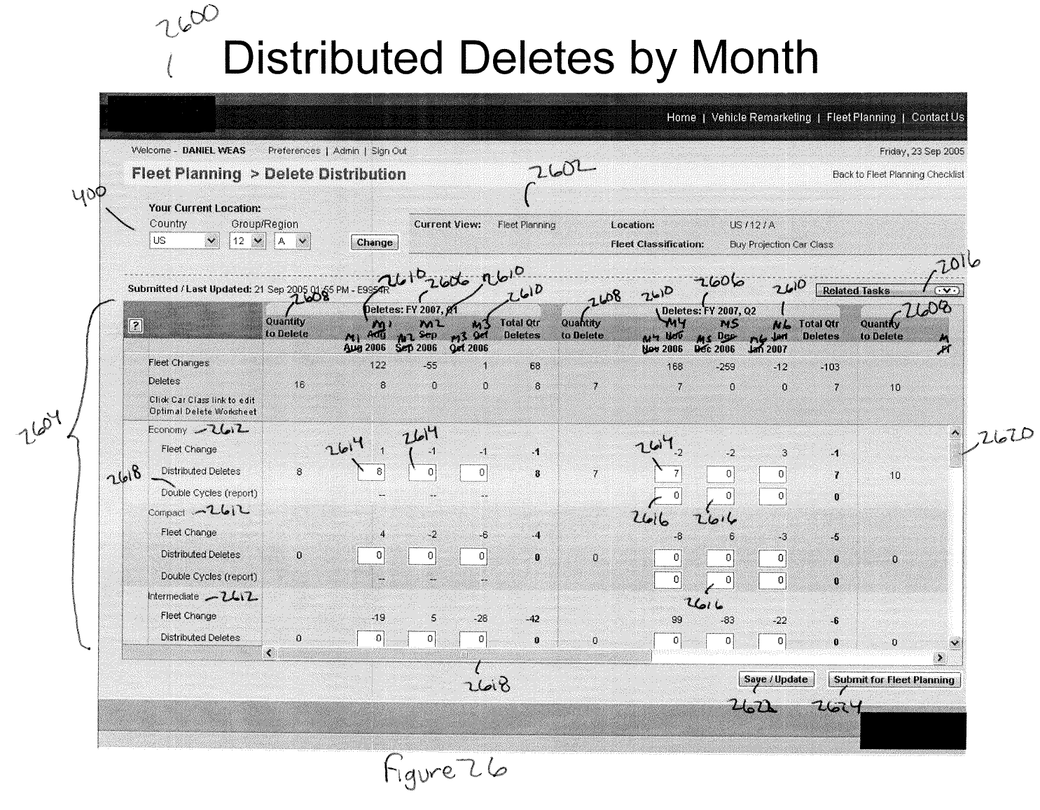

Another aspect of the LTFP process involves users forecasting when incoming vehicles will arrive for use in the fleet during the remainder of the current fiscal year. As used herein, an “incoming vehicle” refers to a vehicle that has been ordered for the fleet but has not yet been delivered to the fleet. Typically, the rental vehicle service providers will take delivery of newly ordered vehicles throughout a fiscal year. Therefore, during any given month, it can be expected that one or more new vehicles will arrive for inclusion within a fleet. Through process 1710 of FIG. 17, users of the inventive LTFP system can quantify these expected incoming vehicles for the remainder of the current fiscal year so that the LTFP process may take this important data into consideration. To begin step 1710, a user selects link 1810 in screen 1800. Upon user selection of link 1810, screen 2200 of FIG. 22(a) is displayed.

Screen 2200 serves as a home page for the incoming vehicles planning process. Current location display section 400 operates as previously described. Section 2202 provides a summary view of the task at hand for the user. Section 2204 summarizes the total number of expected incoming vehicles for each vehicle class within the fleet, as retrieved from database 100 and/or entered by users (a process which will be described below in connection with FIG. 22(b)). Section 2204 can be arranged in a plurality of rows and columns. Column 2206 corresponds to the different vehicle classes for the fleet. Column section 2208 corresponds to the current number of in service vehicles (column 2220) and new car stock (NCS) (column 2222) for each vehicle class. An NCS vehicle is a vehicle that has been received into the fleet and counts toward the current fleet size, but has not yet been put into use in the fleet. Columns 2210 correspond to months of the remainder of the current fiscal year. Column 2212 corresponds to a sum of the total number of expected incoming vehicles over all of the months comprising the remainder of the current fiscal year, and column 2214 corresponds to a status for user entry of incoming vehicle counts for each vehicle class. These statuses are also subject to the state diagram shown in FIG. 30(r), with the “completed” status taking the place of the “submitted” status. The values in row 2216 of section 2204 correspond to summation values for each column's displayed data values across the multiple vehicle classes. Each row 2218 corresponds to a different vehicle class, with the data values populating the column 2210 entries in rows 2218 corresponding to a total number of expected incoming vehicles for each vehicle class during each month. Scroll bar 2228 can be used to scroll down to additional vehicle class rows that may be present in section 2204. Each vehicle class in row 2218 that is listed in column 2206 can be user selectable to display a screen 2240 as shown in FIG. 22(b) that corresponds to that vehicle class.

As shown in FIG. 22(b), screen 2240 is configured to allow the user to enter an expected number of incoming vehicles of the selected vehicle class for each month during the remainder of the current fiscal year. Field 2242 identifies the selected vehicle class and is configured to allow the user to change the selected vehicle class to a different vehicle class (in conjunction with “change” button 2244). Section 2246 provides a summary view of where the user is in the process.

Section 2248 of screen 2240 comprises a table that lists, under column 2250, the YMMSs in row sections 2260 that are members of the selected vehicle class. The data values in column section 2252 identify the current quantity of vehicles for each YMMS that are in service for the fleet (column 2262) and the current quantity of new car stock (NCS) vehicles for each YMMS that are in the fleet (column 2262). Each column 2254 corresponds to a different month during the remainder of the current fiscal year. For each YMMS, column 2254 includes two rows. Row 2266 displays an initial estimate of the total number of incoming vehicles that are members of that YMMS for that month. The row 2266 values are retrieved from fleet database 100 which stores such values based on a previously conducted assessment of expected incoming vehicle deliveries. Row 2268 for each YMMS comprises a field in which the user can enter an adjusted estimate of the total number of incoming vehicles that are members of that YMMS for that month. The values in the fields of each row 2268 can be prepopulated to match their corresponding row 2266 values.

The data values in row 2258 represent the summations of each column's data values across all of the YMMSs. The data values in column 2256 represent summations of the row 2268 values for each YMMS across the remaining months of the current fiscal year.

Once the user has completed any data entry that he/she wishes to enter through screen 2240, the user can either save/update his/her work via button 2270 or submit his/her work for use downstream in the fleet planning process via button 2272. FIGS. 30(c), (1), and (m) illustrate this flow in greater detail. Furthermore, the user has the option to export the data on screen 2240 to a spreadsheet program such as Microsoft Excel or print the screen through selection of button 2016.

User selection of button 2272 is effective to update section 2204 (shown in FIG. 22(a)) to reflect the monthly incoming vehicle values newly entered for that vehicle class by the user. Before the user can submit the full incoming vehicles plan to the system for downstream use in the LTFP process, the user needs to complete screen 2240 for each vehicle class listed in section 2204. Once the status value in column 2214 for each listed vehicle class is “completed”, then the user can select button 2230 to submit the incoming vehicles plan for the fleet to the system for downstream use in the LTFP process.

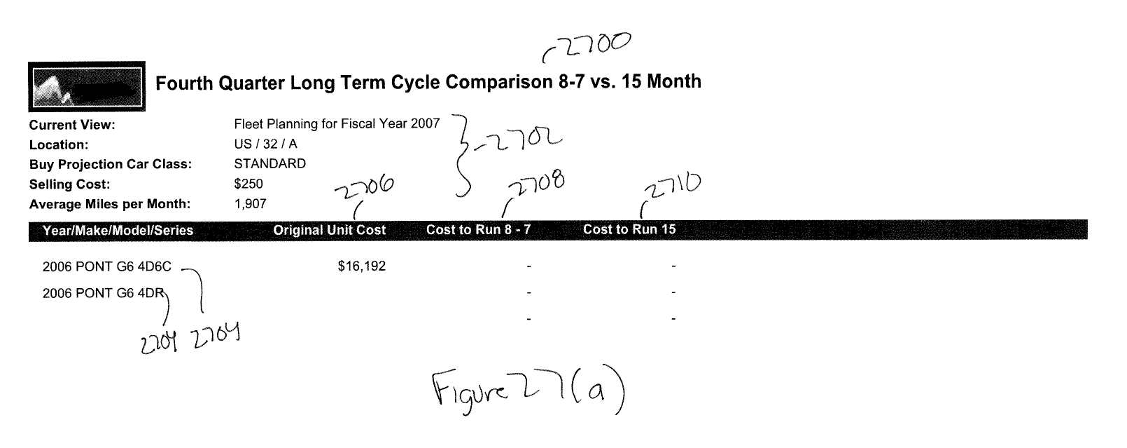

Another aspect of the preferred LTFP process involves the user performing a CGF analysis on the YMMSs corresponding to vehicles within the fleet to assess which vehicles should be deleted from the fleet during the remainder of the current fiscal year. As a beginning step in this process, the user enters residual value forecasts for the YMMSs within each vehicle class in a manner as described above in connection with FIGS. 6 and 7. To initiate residual value entry, the user selects link 1812 from screen 1800, thereby causing screen 2300 of FIG. 23(a) to be displayed. Screen 2300 operates in the manner described above for screen 214 of FIG. 6. Screen 2300 also includes a “view/edit worksheet” button 2302 that is effective, upon user selection, to display screen 2310 of FIG. 23(b).

Screen 2310 operates in the manner described above for FIG. 7(a). However, unlike the example of FIG. 7(a) which provides for user entry of residual values for 12 months into the future, screen 2310 of FIG. 23(b) preferably provides for user entry of residual values for the selected YMMS 2308 for the remainder of the current fiscal year and throughout the next fiscal year. With respect to the historical data that is displayed in table 750 of screen 2310 in FIG. 23(b), it matches that of FIG. 7(a). Optionally, rather than requiring the user to enter a residual value estimate for each month into the future, screen 2310 can be configured to include residual value entry field 734 for only a select subset of the future months, in which case the entered residual values will be used to define residual values for multiple months (including applicable months for which the user did not enter a residual value), or interpolation can be used to define the residual values for the unentered months using the user-entered residual value data. Once the user has completed residual value entry for a selected YMMS, the user can jump to a screen for another YMMS in the selected vehicle class via link 2320 (or select another YMMS in list 710). Once all of the YMMSs for that vehicle class have had their residual values entered by a user, the “update residuals” button 738 can be selected to continue the CGF aspect of the LTFP process. FIGS. 30(b) and (l) illustrate this flow in greater detail.

A user can begin the CGF aspect of the LTFP process by selecting link 1814 in screen 1800. User selection of link 1814 is effective to display screen 2400. Screen 2400, which operates in the manner described for screen 222 of FIG. 10 serves as a home page for the CGF process. Screen 2400 also includes a summary display section 2402 that lists the CGF analysis status for each vehicle class within the fleet. Once the user has completed the CGF analysis for all of the vehicle classes within the fleet, the user can select button 2406 to submit the CGF analysis results for downstream use in the LTFP process. To perform a CGF analysis on the YMMSs of a vehicle class, the user can select a vehicle class via section 1000 and then select the “view/edit worksheet” button 2404 (or select one of the vehicle classes listed in section 2402).

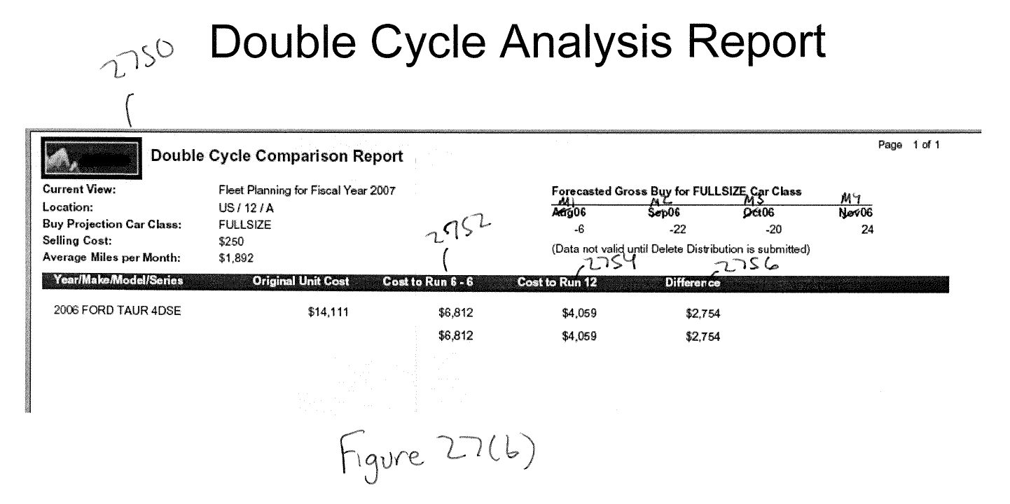

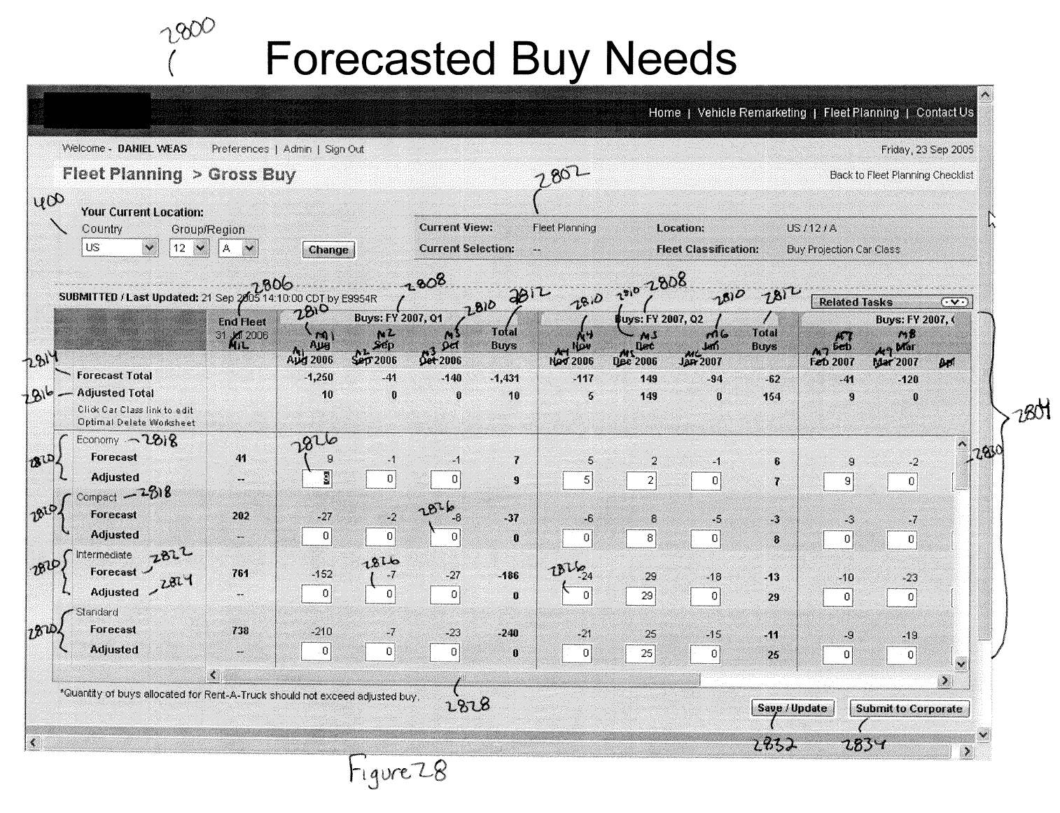

User selection of button 2404 is effective to display screen 2410 of FIG. 24(b). Section 2412 summarizes the task at hand for the user, including an identification of the time period covered by the CGF analysis (preferably, the remaining months of the current fiscal year). Section 2414 summarizes a variety of data relevant to the CGF analysis. Item 2416 in section 2414 identifies the current count of vehicles that are members of the selected vehicle class in the fleet. This value will match the value shown in row 2118, column 2108 for that vehicle class in FIG. 21. Item 2418 in section 2414 identifies the count of estimated incoming vehicles to the fleet that are members of the selected vehicle class. This value will match the value shown in row 2258, column 2256 of FIG. 22(b) for the selected vehicle class. Item 2420 in section 2414 identifies the projected fleet size for vehicles of the selected vehicle class. This value will match the sum of the values for item 2416 and 2418. Item 2422 in section 2414 identifies the desired fleet size for vehicles that are members of the selected vehicle class at the end of the last month of the current fiscal year. This value will match the value shown in row 2118 of month 12 for the current fiscal year for the selected vehicle class. Item 2424 in section 2414 identifies the total number of vehicle deletions that are planned for the selected vehicle class by the end of month 12 for the current fiscal year. This value will be the difference between the item 2420 value and the item 2422 value. Item 2426 in section 2414 identifies a current count of vehicles that have been flagged for deletion within section 1120 of screen 2410. Item 2428 in section 2414 identifies the difference between the item 2424 value and the item 2426 value. Preferably, the item 2428 will reach zero once the user has completed data entry within screen 2410. Section 2430 of section 2414 breaks down the count of model years within the selected vehicle class that will remain in the fleet following the deletions entered by the user in section 1120.

Section 1120 of screen 2410 preferably operates in the manner described in connection with FIG. 11(a). The YMMSs that are listed in section 1120 can be sorted by CGF value such that the YMMSs with the highest CGF are listed higher than YMMSs with a lower CGF value. The data values in column 2440 identify the total number of vehicles that are members of each listed YMMS as of the end of month 12 of the current fiscal year. These values can be determined as the sum of vehicles listed in the same row's mileage bands. The data values in column 2442 identify the number of those vehicles in the vehicle counts of column 2440 that are incoming vehicles. These data values can be determined from the corresponding entries in column 2256 for each YMMS. Through fields 2446 of column 2444, the user can identify a quantity of vehicles for each YMMS that are to be deleted from the fleet by the end of month 12 of the current fiscal year. Because of the CGF-oriented display of section 1120, the user can make an informed decision as to how many of each YMMS should be deleted to cost effectively manage the business. The values in column 2448 of section 1120 represent the total number of vehicles that are members of each listed YMMS that will remain in the fleet at the end of month 12 of the current fiscal year after taking into consideration the planned deletions. The values will match the difference between the column 2440 value and column 2444 value for each listed YMMS.

Once the user has completed any entry of desired deletes in screen 2410 for each of the YMMSs within the selected vehicle class, the user can either save/update his/her work via button 2450 or submit his/her work for use downstream in the fleet planning process via button 2452. FIGS. 30(f), (l), and (m) illustrate this flow in greater detail. Furthermore, the user has the option to export the data on screen 2410 to a spreadsheet program such as Microsoft Excel or print the screen through selection of button 2016.

User selection of button 2452 is effective to update section 2402 of screen 2400 (shown in FIG. 24(a)) to reflect the CGF analysis conducted for the selected vehicle class. Before the user can submit the full report of planned deletes for the remainder of the current fiscal year to the system for downstream use in the LTFP process, the user needs to complete screen 2410 for each vehicle class within the fleet. Once the status value in column section 2402 for each listed vehicle class is “completed”, then the user can select button 2406 to submit the planned deletes for the remainder of the current fiscal year to the system for downstream use in the LTFP process.

Another aspect of the LTFP process preferably comprises simulating aging of the vehicles within the fleet during the course of the next fiscal year (including the expected incoming vehicles for the next fiscal year) and identifying preferred deletion points within the next fiscal year for removing some number of vehicles from the fleet, referred to herein as an “optimal delete point” process. To begin this task, the user preferably selects link 1816 in screen 1800.

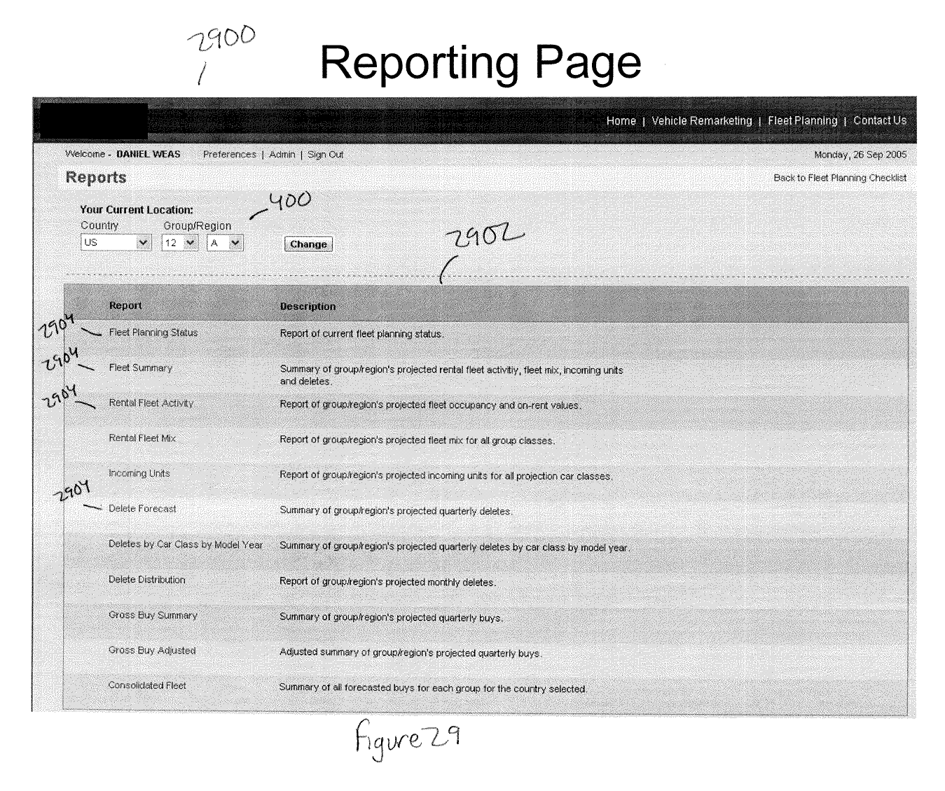

User selection of link 1816 is effective to display screen 2500 of FIG. 25(a). Through screen 2500, the user can define, via section 400, the fleet for which the optimal delete point process will be applied. Furthermore, in field 2502, the user can select the vehicle class for which the optimal delete point process will be applied. Through field 2504, the user can define an average number of miles per month that he/she expects that vehicles of the selected vehicle class will experience over the course of the next fiscal year. This value will affect the aging simulation on the fleet vehicles. Lastly, through field 2506, the user can define an expected selling cost for a vehicle that represents the expected overhead costs that will be incurred when attempting to sell a deleted vehicle on the used vehicle market.

Section 2510 of screen 2500 lists the status of the optimal delete point process for each vehicle class within the fleet. Once the user has entered the necessary information in section 400 and fields 2502, 2504, and 2506, the user can select the “view/edit worksheet” button to display screen 2520 of FIG. 25(b). Alternatively, the user can select on the vehicle classes listed in section 2510 to begin the optimal delete point process for that vehicle class.

Screen 2520 is configured to allow users to define a desired number of deletions from the fleet over the course of the next fiscal year. In the preferred embodiment, these deletions are specified on a per quarter basis; however, it should be noted that other intervals may be used (e.g., monthly). Section 2524 of screen 2520 lists the YMMSs 2526 that have been assigned to the selected vehicle class. Preferably, the user selects one of these YMMSs and projects the deletions for each of the YMMSs within the selected vehicle class.

Section 2528 provides a summary view of defining parameters for the optimal delete point process. Section 2530 provides a running summary of the deletions that have already been scheduled for the upcoming fiscal year for the specified fleet (row 2534), within the selected vehicle class of the fleet (row 2536), and within the YMMS that is currently selected via section 2524 (row 2538). The columns 2532 of section 2530 break these deletions down by quarters for the upcoming fiscal year, with the final column displaying the fiscal year deletion sum for each row.

The user inputs the number of vehicles to be deleted via section 2540. The subject YMMSs of section 2540 are broken into groups on the basis of the quarter and fiscal year in which they were purchased. Rows 2560 in section 2540 correspond to different quarters in the upcoming fiscal year during which the fleet vehicles can be sold (see column 2544). The data for each row in column 2546 corresponds to an average number of months in service for the YMMSs purchased in the pertinent quarter and fiscal year. Thus, as shown in FIG. 25(b), for YMMS vehicles purchased in Q4 of FY06, the average number of months in service for those vehicles at the end of Q1 FY07 will be 3 months. Similarly, the average number of months in service for those vehicles at the end of Q2 FY07 will be 6 months, and so on for the remainder of the upcoming fiscal year. The data values in column 2548 represent the projected number of miles that the YMMS vehicles will have on them at the end of the corresponding quarters. This average mileage is calculated as the average months in service value multiplied by the average mileage value entered in field 2504 of screen 2500. The data values in column 2550 represent the count of vehicles that are members of the selected YMMS and were purchased in Q4 of FY06. The count for the first quarter of the upcoming fiscal year represents the number of vehicles that are projected to be members of the selected YMMS as of that quarter. Such counts are readily determinable from previous entries in the LTFP process. The count for subsequent quarters will be reduced by the number of quarterly deletes defined by the user in fields 2570. The data values in column 2554 of section 2540 identify the expected depreciation amounts that the subject YMMSs will experience for the corresponding quarter. These depreciation amounts can be calculated as the difference between the known average unit cost for vehicles of the applicable YMMS that were purchased during the applicable quarter and fiscal year and the applicable residual value for the applicable YMMS purchased during the applicable quarter divided by the applicable average months in service. The data values in column 2556 express these depreciation amounts divided by the unit cost (i.e., in terms of depreciation percentages).

A useful tool for assessing how many and when vehicles are to be deleted is cycling analysis. As used herein, “cycling analysis” refers to a process of comparing the costs to maintain a vehicle in the fleet for a time duration with the costs to cycle new vehicles into the fleet at different points in time during that time duration. By selection of link 2582 in column 2580, the user can access a report that details a cycling analysis. FIG. 27(a) depicts an exemplary cycling analysis report 2700. Section 2702 of this report summarizes some of the parameters that control the cycling analysis. Rows 2704 identify the YMMSs for which the report is applicable. The values in column 2706 identify the known average original unit cost for each listed YMMS. The data values in column 2710 identify the cost to maintain a vehicle that is a member of the listed YMMS for a full time period (15 months in this example). This value can be calculated as the original unit cost for that YMMS (column 2706 value) minus the residual value for that YMMS as of the final month of the specified time period. As used herein, original unit cost refers to the price that was paid to purchase the vehicle for the fleet. The data values in column 2708 identify the cost to delete and cycle a new vehicle into the fleet at some point during the specified time period (after 8 months in this example). This value can be computed as the original unit cost for that YMMS (column 2706 value) minus the residual value for that YMMS as of the first sell month of the specified time period plus the selling cost entered by the user in field 2506 plus the expected unit cost for a replacement vehicle minus the residual value for the replacement vehicle as of the final month of the specified time duration. The expected unit cost may be the same as the original unit cost or it may include an adjustment to the original unit cost that is based on an assessment of market conditions. Optionally, the report can also include a column that identifies the difference for each YMMS's column 2708 and 2710 values. Also, it should be noted that while the example herein discloses an 8 month/7 month versus 15 months cycling analysis, other time durations and time divisions could be used. For example, a 6 month/6 month-to-12 month cycling analysis, a 9 month/9 month-to-18 month cycling analysis, etc.

Based on the user's business judgment, as aided by the displayed depreciation data, the user can specify in fields 2570 a total quantity of deletes for the subject YMMSs by quarter. Once the user has completed this task for a YMMS, he/she can select link 2576 to move on to the next YMMS in section 2524 to repeat this process.

Once the user has completed any entry of desired deletes in screen 2520 for each of the YMMSs within the selected vehicle class, the user can either save/update his/her work via button 2572 or submit his/her work for use downstream in the fleet planning process via button 2574. FIGS. 30(g), (l), and (m) illustrate this flow in greater detail. Furthermore, the user has the option to export the data on screen 2520 to a spreadsheet program such as Microsoft Excel or print the screen through selection of button 2016.

Returning to FIG. 25(a), user selection of button 2574 is effective to update section 2510 of screen 2500 to reflect the optimal delete point process conducted for the selected vehicle class. Before the user can submit the full report of planned deletes for the upcoming fiscal year to the system for downstream use in the LTFP process, the user needs to complete screen 2520 for each vehicle class within the fleet. Once the status value in section 2510 for each listed vehicle class is “completed”, then the user can select button 2512 to submit the planned deletes for the upcoming fiscal year to the system for downstream use in the LTFP process.

Having forecasted a number of deletes for the next fiscal year by quarter, step 1718 of FIG. 17 operates to distribute those quarterly deletes over each quarter's months. This process is referred to herein as the “deletion distribution” process. To begin the deletion distribution process, the user selects link 1818 from within screen 1800.

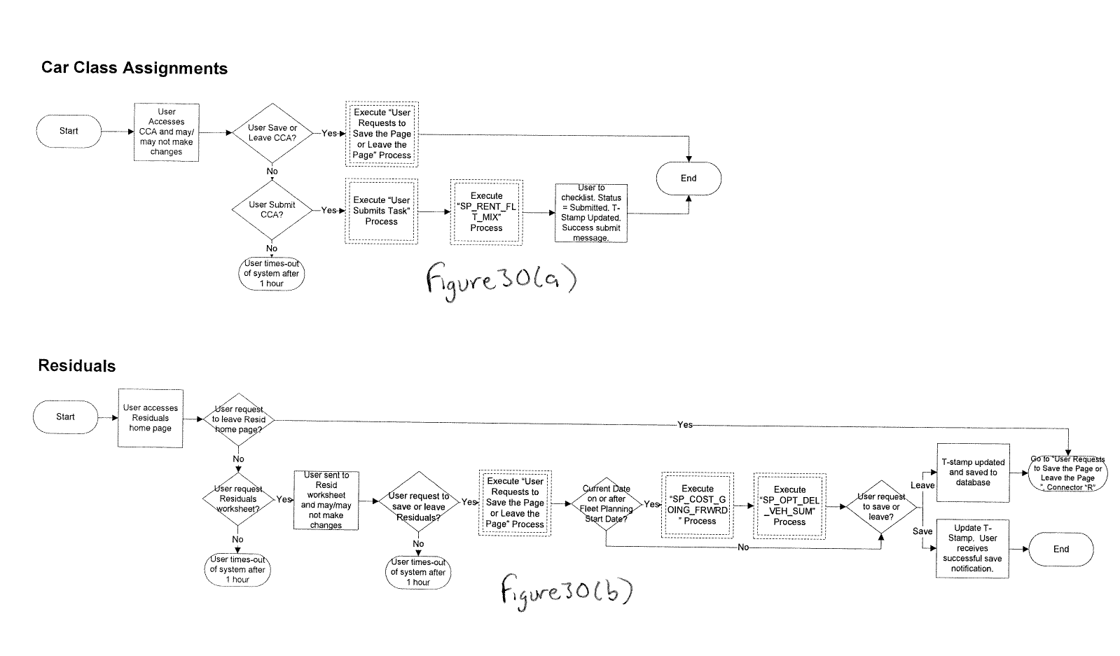

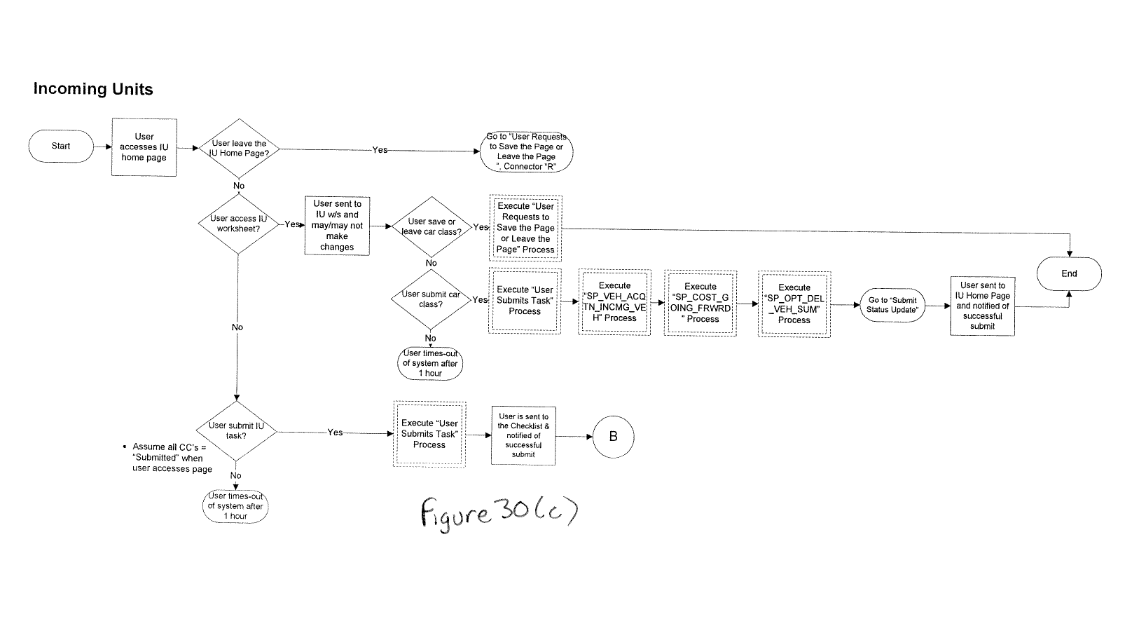

Upon user selection of link 1818, screen 2600 of FIG. 26 is displayed. Section 2602 of screen 2600 provides users with a summary view of select pertinent information. Within section 2604 of screen 2602, the user can distribute quarterly deletes over each quarter's months as shown via field 2614. Section 2604 can be arranged with row sections 2612 that correspond to the different vehicle classes within the fleet. Scroll bar 2620 can be used to access fields 2614 for additional vehicle classes within the fleet that are not shown in the initial section view. Section 2604 also includes column sections 2606 that correspond to the different quarters of the upcoming fiscal year. Scroll bar 2618 can be used to access subsequent quarters that are not shown in the initial section view. Each column section 2606 includes columns 2608 corresponding to the total number of deletes for the quarter that are to be distributed, columns 2610 corresponding to the different months of the quarter, and a column that identifies the total number of deletes that the user has in fact distributed among the months of each quarter.

Each row section 2604 preferably includes a row in which the change in fleet size for the pertinent vehicle class is identified from month to month, based on data previously determined by upstream components of the LTFP process. This data serves as an aid to the user when the user decides how to distribute the deletions. Another row in each row section is dedicated to field 2614 in which the user specified each month's deletion totals. Lastly, a row 2618 can be provided in each row section 2612 corresponding to a count of vehicles that are to be double-cycled. As used herein, “double-cycling” refers to the practice of deleting a vehicle in the same fiscal year that it was received into the fleet and replacing that vehicle within the fleet during the same fiscal year. Generally, double-cycling will not occur in the first quarter of a fiscal year, so row 2618 in the column section 2606 for the first quarter of the upcoming fiscal year is left blank. However, for subsequent quarters in the upcoming fiscal year, fields 2616 are provided in row 2618, through which the user can specify a desired number of vehicles to be double-cycled for each month.

To aid the user in assessing how many vehicles should be double-cycled in a given month, the user can preferably access a double-cycling analysis report 2700 as shown in FIG. 27 via selection of a “report” link in rows 2618 for each vehicle class. Preferably, report 2750 computes and displays a comparison between the expected cost to run an exemplary YMMS that has been assigned to a vehicle class of interest for the full 12 months of the upcoming fiscal year versus the cost to sell that YMMS after 6 months of the upcoming fiscal year, buy a new vehicle of that YMMS and run it for the remaining 6 months of the upcoming fiscal year. In cases where the user believes that it will be more cost effective for the business to double cycle some number of vehicles, he/she can then do so via field 2616 in screen 2600. The 6-6 double-cycle cost of column 2752 can be calculated as (unit cost of the current fleet vehicle minus the residual value at 6 months plus the selling cost (as entered by the user in field 2506)) plus (the expected unit cost of the replacement vehicle at month 6 minus the residual value at 6 months for that vehicle). The 12 month run cost in column 2754 can be calculated as the unit cost of the current fleet vehicle minus the residual value at 12 months for that vehicle. The difference value in column 2756, which equals the column 2752 value minus the column 2754 value, can be a valuable indicator to users with respect to whether double-cycling should be implemented.

Once the user has completed the deletion distribution process in screen 2600, the user can either save/update his/her work via button 2622 or submit his/her work for use downstream in the fleet planning process via button 2624. FIGS. 30(h), (l), and (m) illustrate this flow in greater detail. Furthermore, the user has the option to export the data on screen 2600 to a spreadsheet program such as Microsoft Excel or print the screen through selection of button 2016.

While the preferred LTFP process divides the optimal delete point process and the deletion distribution process into separate interface screens, it should be noted that the functionality of these two processes can be consolidated into a single process.

After the user has completed the deletion distribution process, a user is now ready to forecast the gross vehicle buy amount for the fleet during the upcoming fiscal year. This operation, which is shown as step 1720 in FIG. 17, can be initiated by user selection of link 1820 from within screen 1800.

Upon user selection of link 1820, the screen 2800 of FIG. 28 is displayed. Section 2802 of screen 2800 provides the user with a summary display of various select information. The user can also specify the fleet of interest via appropriate interaction with section 400.

Section 2804 displays the forecasted vehicle buy for the upcoming fiscal year broken down by quarter and month. Row sections 2820 correspond to different vehicle classes within the fleet. Column sections 2808 correspond to different quarters of the upcoming fiscal year. Each column section is further divided into month columns 2810 and a quarterly total buy column 2812. Row 2814 corresponds to buy totals for the different quarters that has been summed across all vehicle classes within the fleet. Row 2816 corresponds to user-adjusted buy totals for the different quarters that has been summed across all vehicle classes within the fleet. Each row section 2820 can be divided into a row 2822 corresponding to the computed vehicle buy forecast and a row 2824 corresponding to a user-adjusted vehicle buy forecast. Scroll bars 2828 and 2830 can be used to adjust the views within section 2804.

The data values for each row section 2820 within column 2806 represents the forecasted fleet size for each vehicle class at the end of the previous fiscal year. These values can be readily calculated in view of the known current fleet size, the specified incoming vehicles for the remainder of the current fiscal year, and the planned deletes for the remainder of the current fiscal year. Furthermore, the monthly data values in row 2822 for each vehicle class can be readily calculated as x+y+d-z, wherein z represents the known end fleet size for the previous month, wherein x represents the desired monthly quantity of vehicles for each vehicle class as defined via screen 2100 of FIG. 21, wherein y represents the planned monthly deletes as defined by the deletion distribution process of FIG. 26, and wherein d represents the quantity of double-cycles (row 2616) for the applicable month. The data values in columns 2812 for rows 2822 represent the quarterly sum of forecasted vehicle buys for each quarter's constituent months.

Through fields 2826 within rows 2824 of section 2804, the user preferably has the option to adjust the forecasted number of monthly vehicle buys for the upcoming fiscal year. The user can make these adjustments based on his/her business judgment as to the needs of the fleet. Once the user is satisfied as to the quality of the forecasted vehicle buys for the upcoming fiscal year, he/she can submit this vehicle buy data for downstream processing via selection of “submit to corporate” button 2834. If the user does not yet wish to submit the buy forecasts, but does want to save the work done in screen 2800 (such as any adjustments that may have been made), the user can do so by selecting “save/update” button 2832. FIGS. 30(i), (l), and (m) illustrate this flow in greater detail.

Upon completion and submission of the data in screen 2800, a user will have effectively completed the LTFP process. From this point, the forecasted gross buy forecasts can be used by persons within a vehicle acquisition unit of the business to begin the process of negotiating the placement of vehicle orders with vehicle sources. In some instances, the personnel of the vehicle acquisition unit may begin such a process after gross buy forecasts are submitted for all groups within the business. Through the LTFP process of the parent invention, businesses can thus intelligently and effectively pursue the vehicle acquisition process in a consolidated rather than piecemeal manner.

Another aspect of the LTFP process that bears discussion is the ability to generate reports that detail the data submissions involved in LTFP's constituent tasks. FIG. 29 depicts an exemplary screen 2900 from which such reports can be accessed via user selection of links 2904 in section 2902.

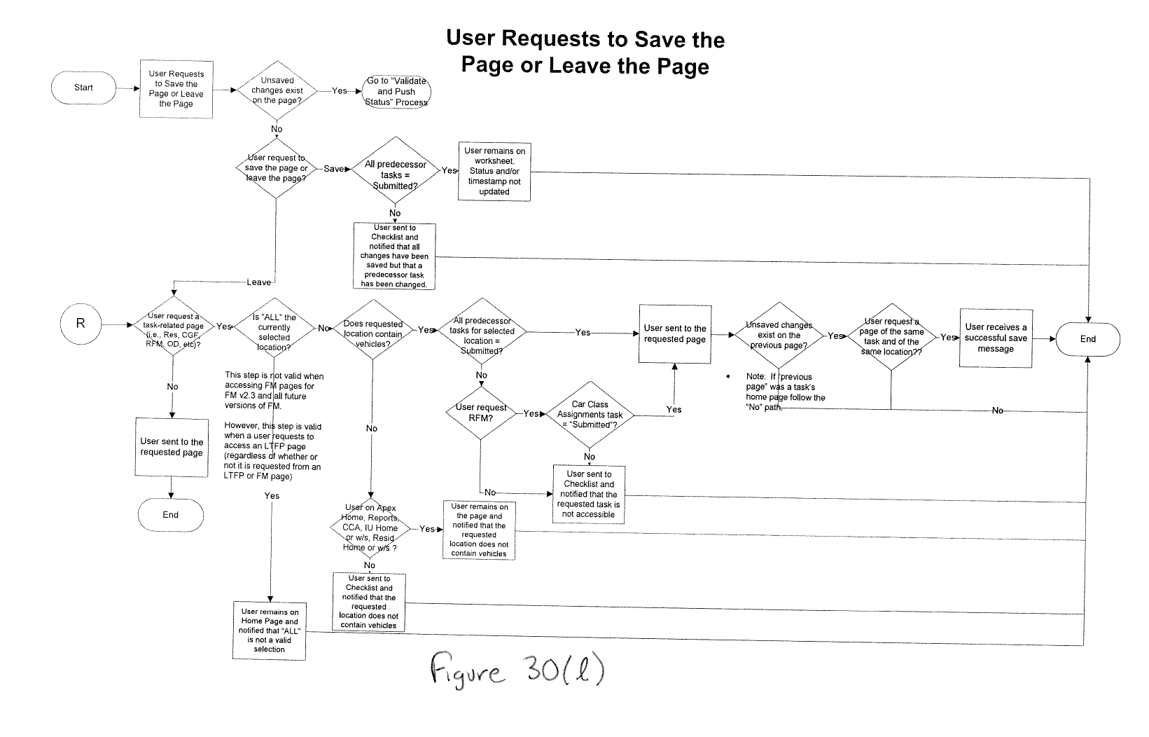

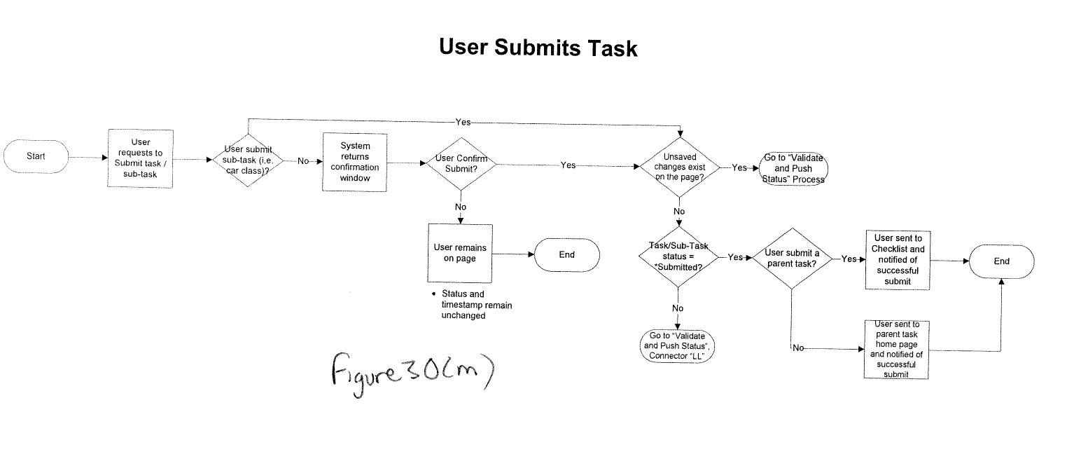

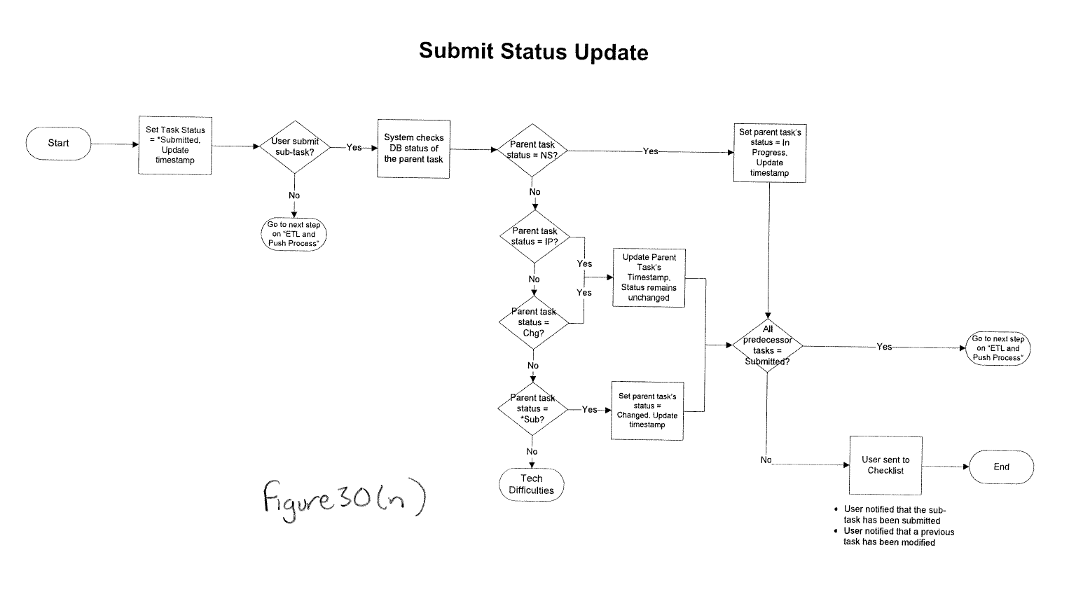

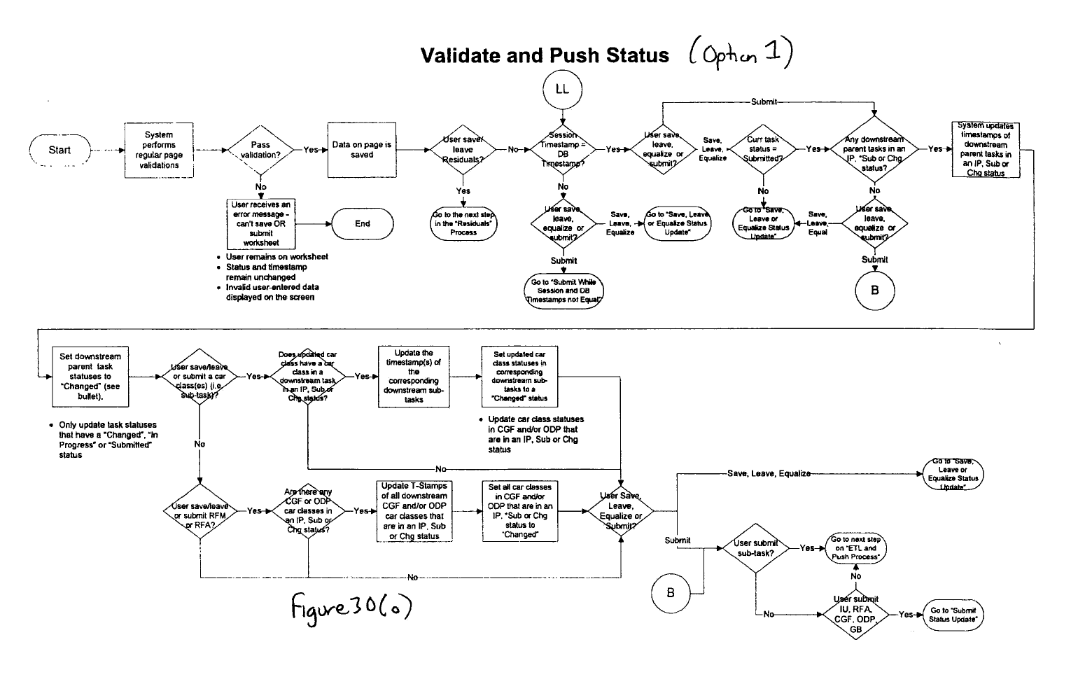

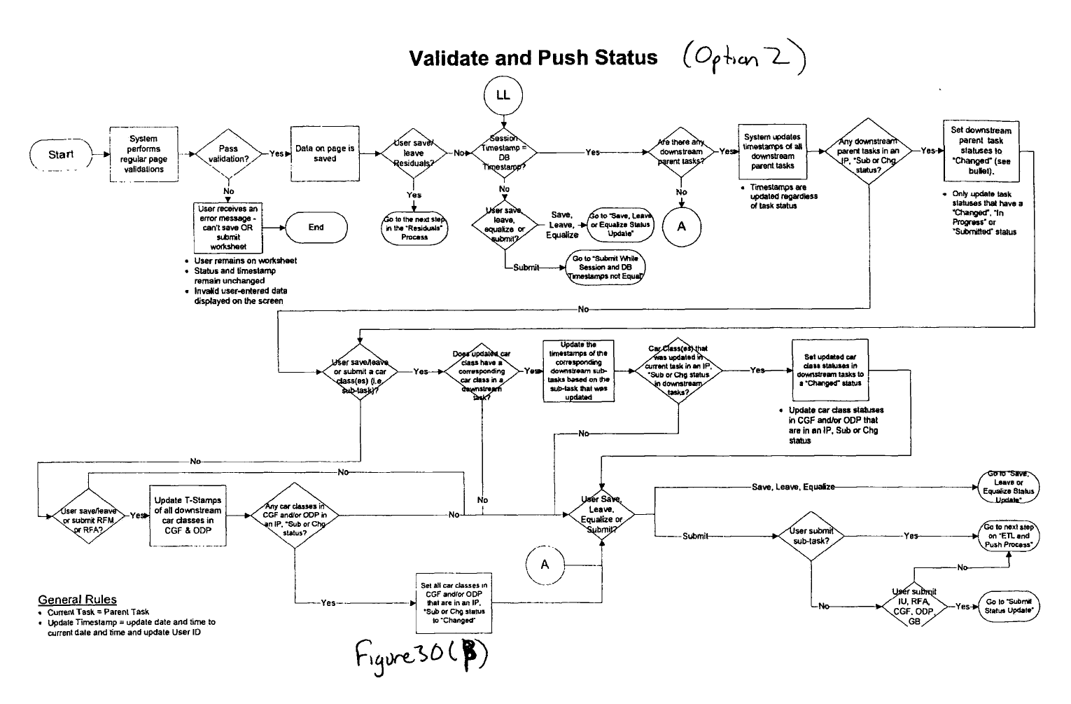

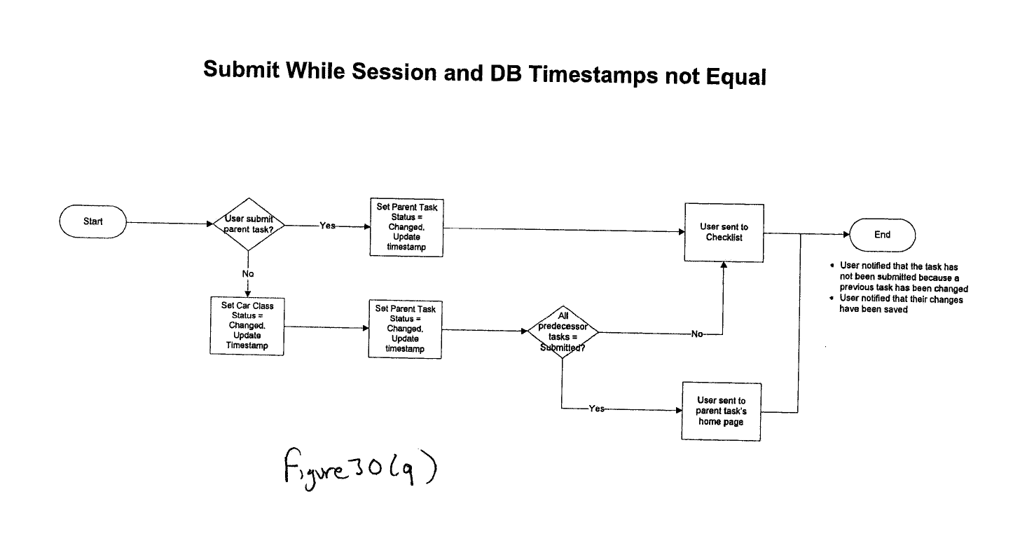

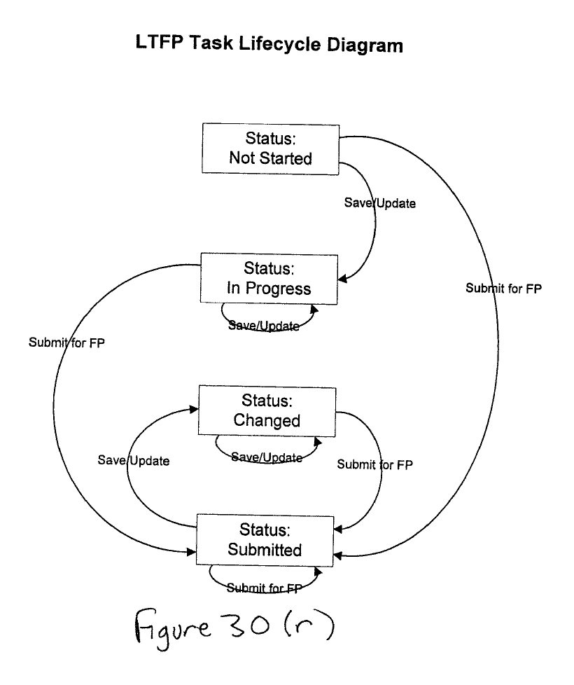

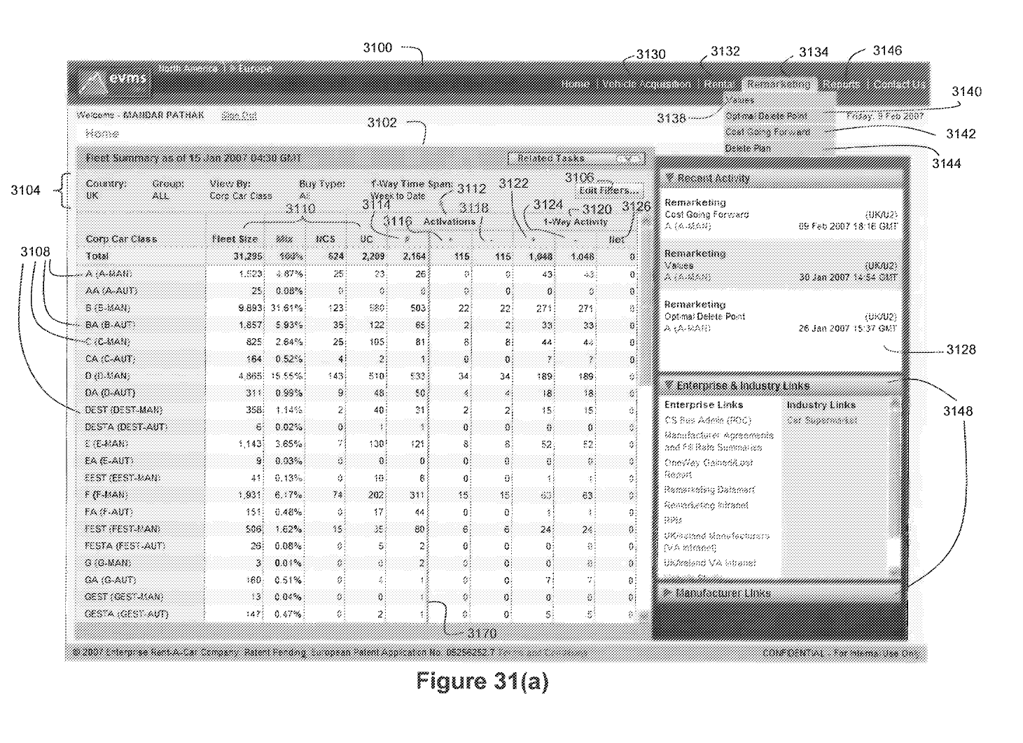

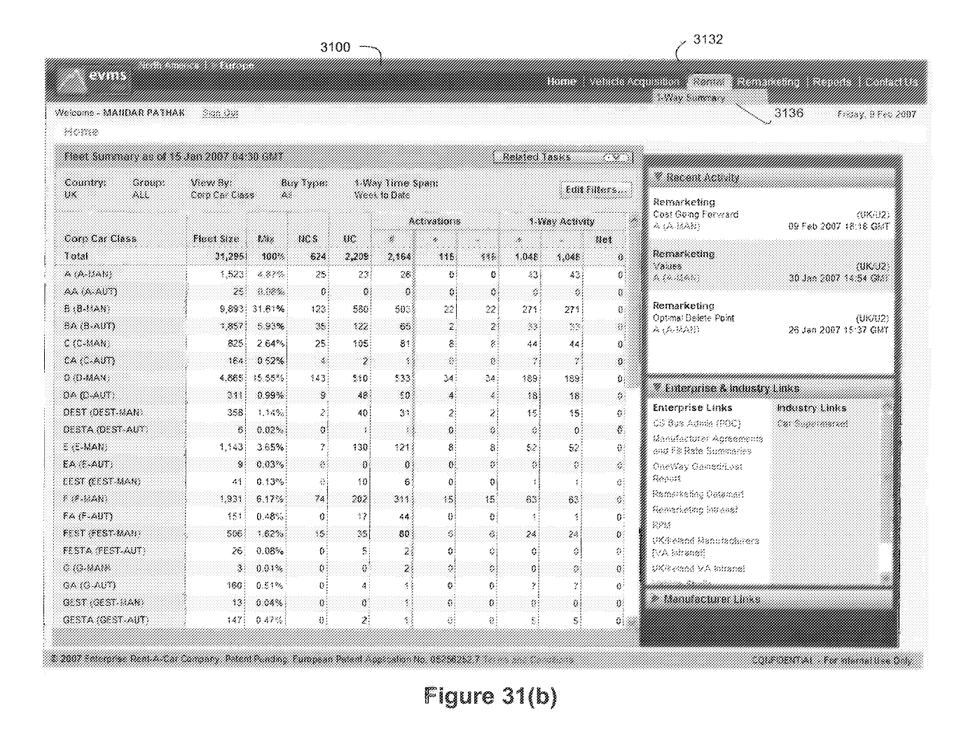

In accordance with one aspect of a preferred embodiment of the present invention, FIG. 31(a) depicts an exemplary fleet management home page 3100, wherein the home page includes a summarization of one-way rental activity for the rental vehicle fleet. Similar in nature to section 410 of FIG. 4, page 3100 includes a summary display area 3102 within which various data items are displayed for the vehicle fleet defined by the field constraints 3104. If the user wishes to change the fleet definition parameters, he/she can do so upon selection of the “Edit Filters” button 3106, which is effective to allow the user to define different constraints for retrieving vehicle data from the fleet database 100, as explained below. In this example, the defined fleet parameters are a country/group definition of UK/Ul, wherein all buy types of vehicles are listed, wherein the fleet view is arranged by vehicle class, and wherein the one-way summary time span is “month-to-date”. It should be readily understood that different constraints and/or different constraint fields could be used in the practice of this embodiment of the invention.

Display area 3102 includes several rows 3108 that list different vehicle classes within the rental vehicle fleet defined by section 3104. The columns in area 3102 are broken down by several different criteria. Section 3110 includes columns that identify a fleet size, fleet mix percentage, and new car stock (NCS) count for each vehicle class within the defined fleet. Also displayed in section 3110 is a used car (UC) count of standing inventory that needs to be sold by the country/group. The columns in area 3112 detail the activations for each vehicle class in the defined fleet.

The columns in area 3120 detail the one-way rental activity for each vehicle class within the defined fleet. Line 3170 in area 3102 separates one-way rental data from more general fleet data—the columns to the right of line 3170 specifically pertain to one-way rental data for the fleet while the columns to the left of line 3170 contain data more general to the fleet. Column 3114 identifies a count of activations for each vehicle class within the defined fleet (general as to the entire fleet). To the right of line 3170, columns 3116 and 3118 identify how many of those total number of vehicles activated for deletion have either been added to the fleet as a result of one-way rental activity (column 3116) or have departed the fleet as a result of one-way rentals. Thus, it can be seen that a vehicle's status flag as to activation for deletion preferably follows that vehicle even as it changes locations as a result of one-way rental activity. Large values in either column 3116 or 3118 may indicate to the fleet manager that his/her fleet plan needs to be updated in view of one-way rental activity changing the characteristics his/her fleet population (e.g., more vehicles may need to be ordered to repopulate the fleet, some vehicles may need to be deactivated, etc.).

Column 3122 identifies the number of incoming one-way rentals that have arrived within the defined fleet within the time span defined within section 3104 (in this example, the time span is month-to-date). As such, the vehicle counts in column 3116 are preferably a subset of the vehicle counts in column 3122. An incoming vehicle counted by column 3122 is a rental vehicle whose drop-off location was not the same as the pick-up location, wherein the drop-off location was in the country/group shown in section 3104, and wherein in the pick-up location was in a different country/group than the country/group for the drop-off location (e.g., a rental that was picked up in Los Angeles and dropped off in New York City). As such, the incoming one-way vehicle represents a vehicle that was not previously a part of the country/group's rental fleet until a renter's one-way rental activity. Column 3124 identifies the number of outgoing one-way rentals that have departed from the defined fleet within the time span defined within section 3104. As such, the vehicle counts in column 3118 are preferably a subset of the vehicle counts in column 3124. An outgoing vehicle counted by column 3124 is a rental vehicle whose drop-off location was not the same as the pick-up location, wherein the drop-off location was in a country/group other than that shown in section 3104, and wherein in the pick-up location was in the country/group shown in section 3104. As such, the outgoing one-way vehicle represents a vehicle that has left the country/group's rental fleet because of a renter's one-way rental activity. Column 3126 identifies the net one-way rental activity for the defined fleet, wherein a positive number indicates a net influx of vehicles into the defined fleet and a negative number indicates a net outflux of vehicles from the fleet. The information in section 3120 of display area 3102 can provide valuable information to fleet managers whose fleets may experience changes in size due to one-way rental activity.

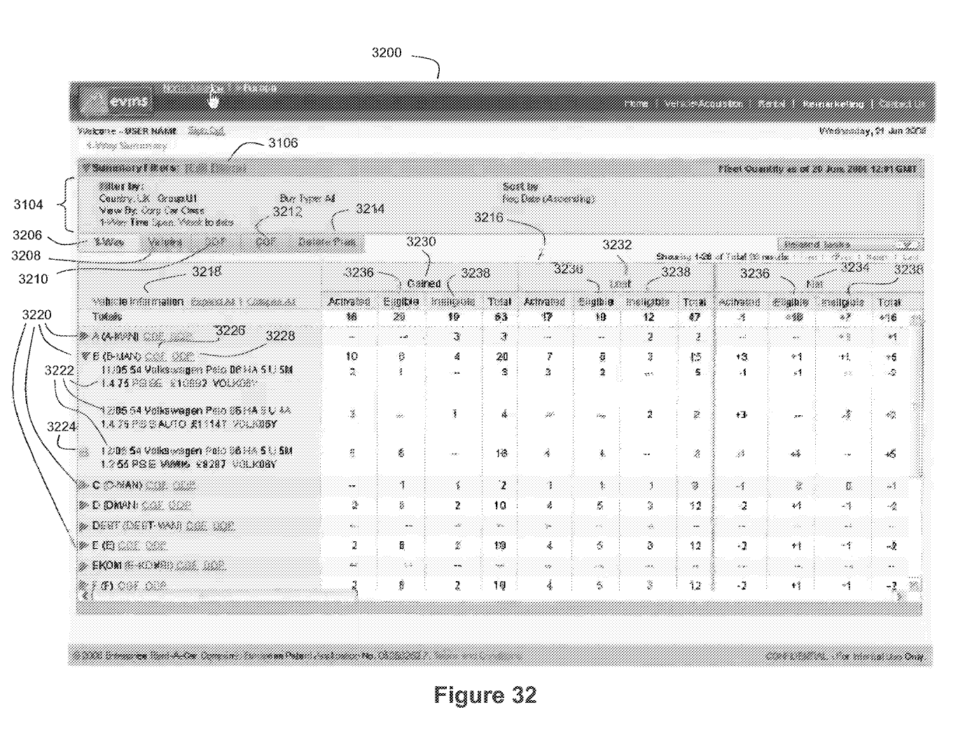

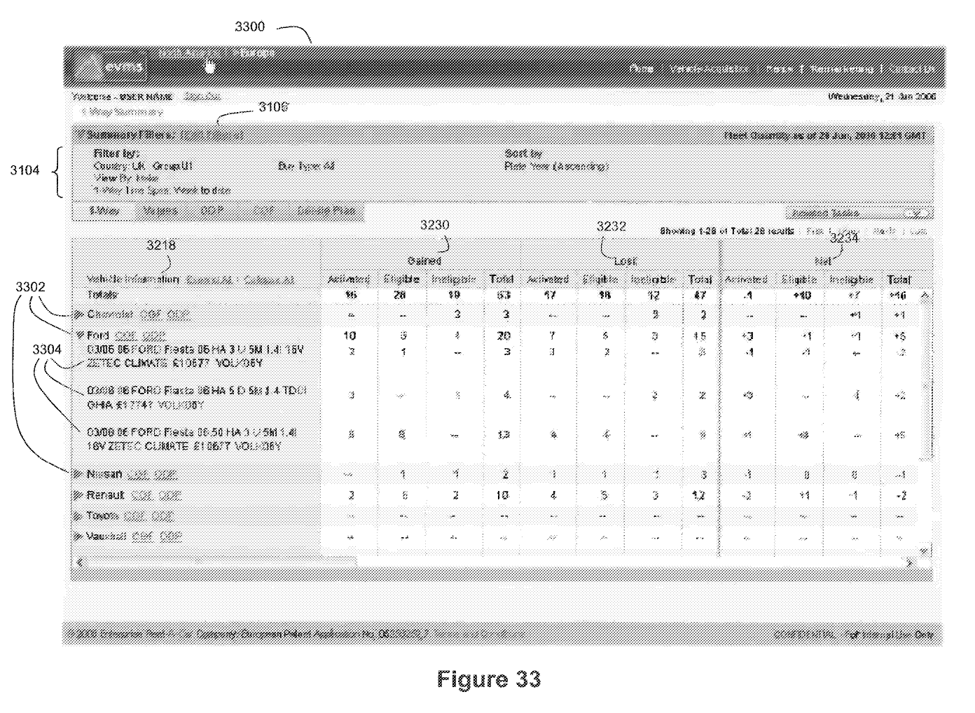

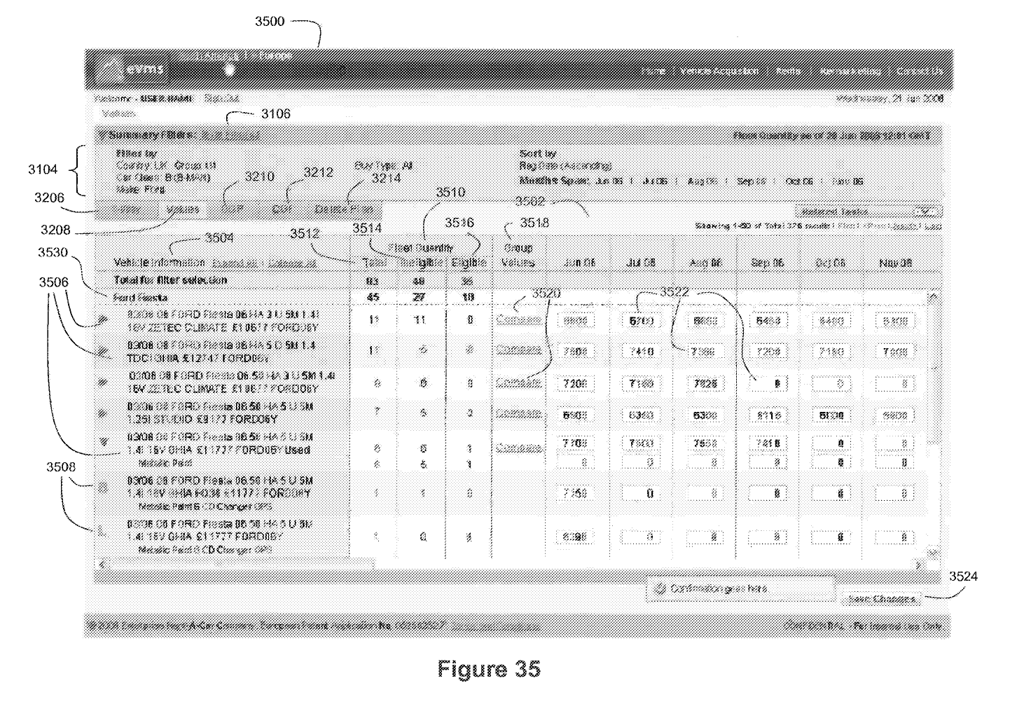

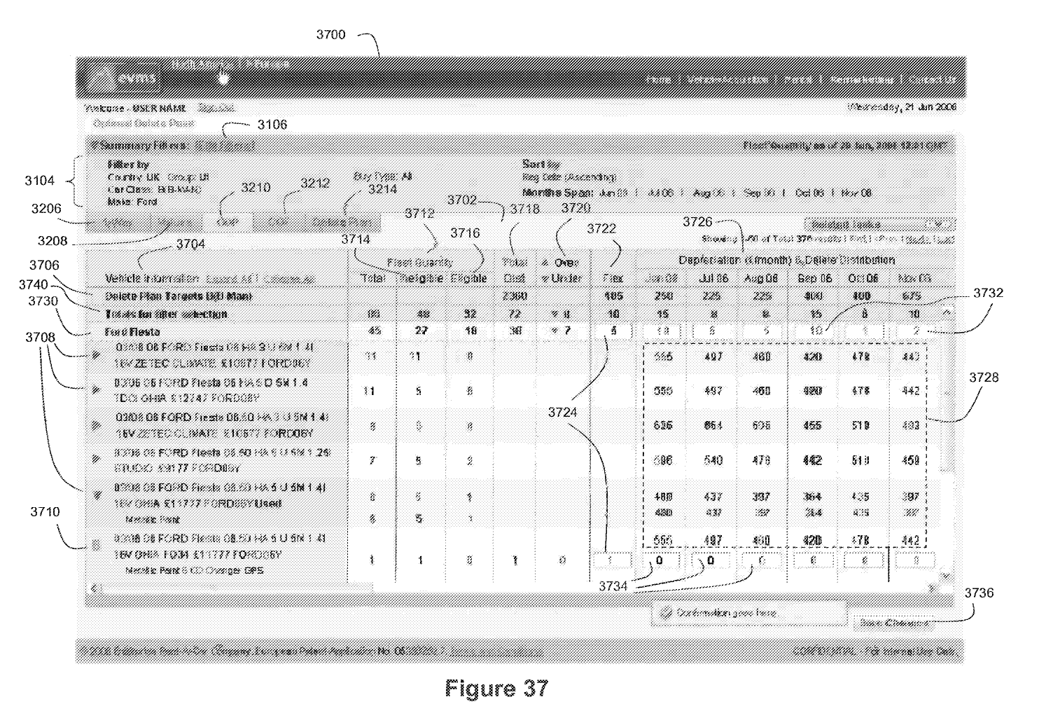

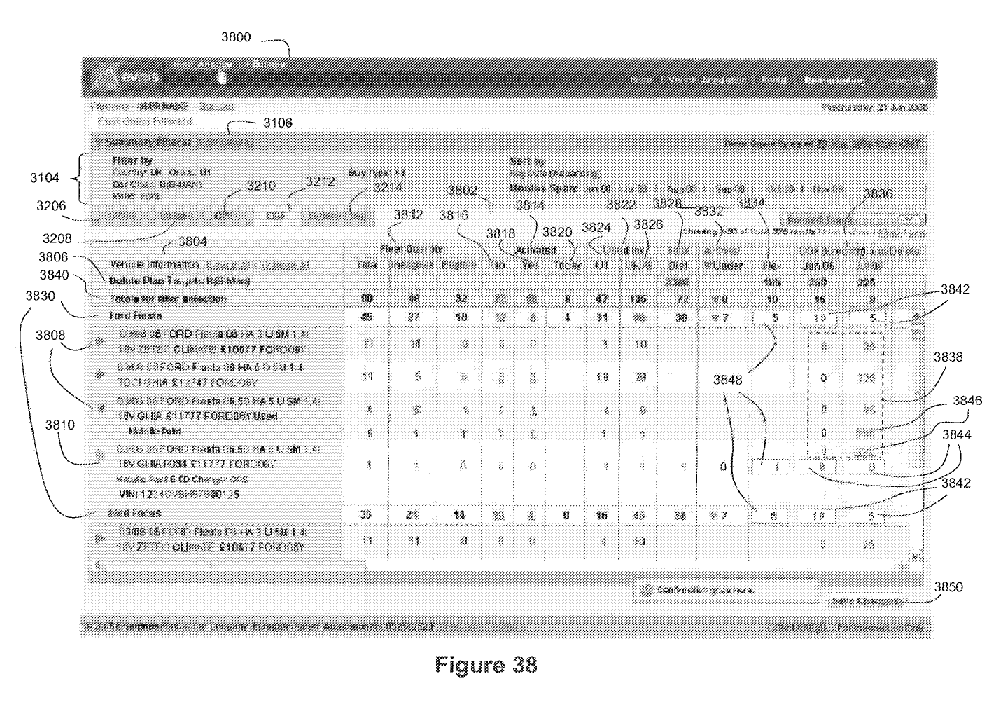

Display area 3128 provides the user with a list of recent activity for the country/group defined in section 3104, much like section 422 of FIG. 4. Also, from home page 3100, users can access the fleet management functionality provided by fleet management application 102 in a role-based manner. That is, depending upon the user's role within the fleet management entity, the user's interaction with the fleet database 100 through the fleet management application 102 can be different. For example, by user selection of “vehicle acquisition” link 3130, a page can be presented to the user that is specially configured to the needs of vehicle acquisition personnel (e.g., vehicle ordering pages, etc.). Similarly, by user selection of “rental” link 3132, a page of the fleet management system can be presented to the user that is configured for access by a person concerned with rental management. For example, as shown in FIG. 31(b), selection of the “rental” link 3132 can provide a menu that list a link 3136 for accessing a one-way rental summary page, as described below in connection with FIGS. 32 and 33. Moreover, by user selection of “remarketing” link 3130, a drop down menu of various pages can be presented. This drop down menu preferably includes a link 3138 for accessing a “Values” page (see FIG. 35), a link 3140 for accessing an “Optimal Delete Point” (“ODP”) page (see FIG. 37), a link 3142 for accessing a “CGF” page (see FIG. 38), and a link 3144 for accessing a “Delete Plan” page.

Page 3100 may also include a link 3146 for accessing a “Reports” page. Another feature that may be included on home page 3100 is section 3148, which, like section 460 of FIG. 4 includes a number of links to related websites, such as links to various vehicle manufacturers websites, and others.

User selection of the “One-Way Summary” page link 3136 can be effective to display a page such as page 3200 of FIG. 32. Within section 3216, page 3200 depicts detailed one way rental information for the vehicles within the fleet defined by the parameters in section 3104. As with section 3104 in FIG. 31, the user can modify the fleet definition parameters by selecting the “edit filters” link 3106. Folder tabs 3208, 3210, 3212 and 3214 can be selected by the user to navigate to the “Values” page, “ODP” page, “CGF” page, and “Delete Plan” page respectively (folder tab 3206 is the tab for the displayed One-Way Summary page 3200).

Column 3218 lists the vehicle criteria for which one-way information will be displayed. In the example of FIG. 32, the vehicle criteria is organized by “vehicle class”, as shown in section 3104. However, it should be noted that other criteria could be used. For example, FIG. 33 depicts an exemplary One-Way Summary page that is organized by vehicle make rather than vehicle class. Items 3220 in section 3216 list different vehicle classes for which one-way activity is displayed. User selection of one of the triangular icons adjacent the listed vehicle class is effective to display a subtree of rental vehicles 3222 at a lower level of detail within the defined fleet that belong to the adjacent vehicle class. For example, this lower level of detail can be different YMMSs within each vehicle class, or even more granular detail levels that also include different vehicle trim level specifications; the lower level of detail can also optionally go down to the specific rental vehicle level which can be referred to as the “unit” level. In the example of FIG. 32, by selection of the triangular icon adjacent the “B” car class 3220, the one-way activity for three lower levels of rental vehicles 3222 belonging to the “B” car class within the defined fleet is displayed. When vehicles are displayed at a lower level and wherein each vehicle(s) within that lower level shares the same “buy type” as explained above, a flag can be included adjacent the displayed vehicle information to signify the “buy type” for that rental vehicle detail level. The inclusion of this flag helps users make informed decisions when deciding which vehicles to activate for deletion from the fleet; as explained above—the considerations for activating buyback vehicles for deletion are likely much different that the considerations for activating risk vehicles for deletion. Also adjacent each listed vehicle class in column 3218 are links 3226 and 3228 to that vehicle class's CGF and ODP pages respectively.

Section 3216 also includes a set of “gained” columns 3230 which detail the incoming one-way rentals, a set of “lost” columns 3232 which detail the outgoing one-way rentals, and a set of “net” columns 3234, which combine the data within the gained and lost columns. Within each of these column sets are an “activated” column, which lists vehicle counts for the arriving/departing one-way rental vehicles that have already been activated for deletion, an “eligible” column 3236 which lists vehicle counts of the corresponding category that are eligible for activation (the counts in the “activated” columns for the “gained” and “lost” categories should be subsets of the counts in the “eligible” columns), an “ineligible” column 3238 which lists vehicle counts of the corresponding category that are not eligible for activation, and a “total” column that sums the counts in the “activated”, “eligible” and “ineligible” columns. By including the eligible and ineligible counts in each category, the system provides users with information that helps them make informed decisions as to activations.

As noted above, FIG. 33 depicts a different version of the One-Way Summary page 3300, wherein the vehicle counts are organized by vehicle make 3302 (e.g., Chevrolet, Ford, Nissan, etc.) rather than vehicle class. As with page 3200, user selection of the triangular icon adjacent each listed vehicle make 3302 is effective to display a subtree of specific rental vehicles 3304 for that vehicle make within the defined fleet.

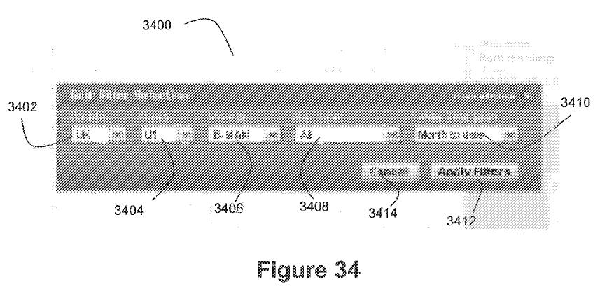

To control how the data is arranged on the One-Way Summary page, the “Edit Filters” button 3106 can be used. User selection of button 3106 can be effective to display the popup window 3400 of FIG. 34. Through this window 3400, the user can preferably define parameters for the fleet of interest as well as define how data for the defined fleet will be displayed. For example, window 3400 may include a field 3402 through which the user specifies the country for which fleet data will be retrieved from the fleet database 100 and a field 3404 through which the user specifies a “group” for which fleet data will be retrieve from the fleet database. As previously explained, this “group” can be virtually any criteria by which a fleet management entity wishes to organize its fleet. In a preferred embodiment, this organization is by geographically-segmented “groups”; however, other criteria could be used. Window 3400 may also include a field 3406 through which the user specifies how the fleet data will be displayed to the user—for example, exemplary options for organizing fleet data can be organization by vehicle class, vehicle make, specific vehicle classes, specific vehicle makes, specific vehicle makes and models, and the like. Window 3400 may also include a field 3408 through which the user can specify the “buy type” for vehicles of interest within the fleet. Through selection of an option in this field 3408, the user can constrain the defined fleet to include data for only vehicles of a specified buy type. Options for user selection in field 3408 can include all vehicles (i.e., no restriction as to vehicle buy type), buyback vehicles, risk vehicles, leased vehicles, and any other buy types that may be pertinent to the fleet. Window 3400 may also include a field 3410 through which the user specifies the time range for retrieving one-way rental activity for vehicles within the defined fleet (e.g., “month-to-date”, “24 hours”, “week-to-date”, “calendar year-to-date”, “fiscal year-to-date”, and others). Once the user has specified the desired fleet definition and fleet data viewing parameters, the user can select the “apply filters” button 3412, whereupon an appropriate query is sent to the fleet database 100 to retrieve fleet data for the fleet defined via the fields of window 3400. To cancel any entries in the fields of window 3400, the user can select the cancel button 3414.

It should be noted that additional fields can be added to the filter control window 3400. For example, a “sort by” field that allows the user to define how the fleet data will be sorted within a display area can be included. As another example, one or more fields that allow the user to constrain the desired fleet to specific vehicle classes, vehicle makes, vehicle models, vehicle trim levels, and combinations thereof can be included in the filter control window if desired by a practitioner of the invention; for example, FIG. 35 shows fleet data for a vehicle fleet that has been constrained to a specific vehicle make within a specific vehicle class. It should also be noted that fewer fields can be included in the filter control window if desired by a practitioner of the invention. The choice of which fields to include in the filter control window can vary as a function of the type of page that the filter will be applied to. In the exemplary screenshots included herein, the choice of fields can be seen as a result of the criteria that are listed within section 3104 of each page.

FIG. 35 depicts an exemplary page 3500 for user entry of residual values for vehicles within the defined fleet. Page 3500 differs from other residual value entries pages shown herein in that detailed historical sales information is not provided. However, as described hereinafter, page 3500 preferably includes a feature that allows a user to view how other group's within the fleet management entity have estimated the residual value for like-categorized vehicles, thereby providing yet another technique for aiding the user's value forecasting.

Page 3500 can be displayed upon user selection of tab 3208. This residual value entry can be performed at a variety of different vehicle levels, depending on how the user has chosen to display and view the vehicles within the defined fleet. Section 3502 of page 3500 lists vehicles in the defined fleet via column 3504. Column 3504 lists vehicles therein by their make and model 3530, and also by each make/model's trim level or other lower level of detail 3506, wherein vehicles within each trim level 3506 can be further viewed at the unit level 3508 upon selection of the triangular icon adjacent the listed trim levels 3506. Section 3510 includes columns relating to the quantity of vehicles in the defined fleet. Column 3512 displays a total count for each of the vehicles categorized in column 3504. Columns 3514 and 3516 further segment this total quantity into counts of vehicles ineligible for activation (column 3514) and counts of vehicles that are eligible for activation (column 3516).

Page 3500 provides the user with the ability to enter residual value estimates for the vehicles categorized in column 3504 via fields 3522. Fields 3522 can be organized in columns of one or more future months.

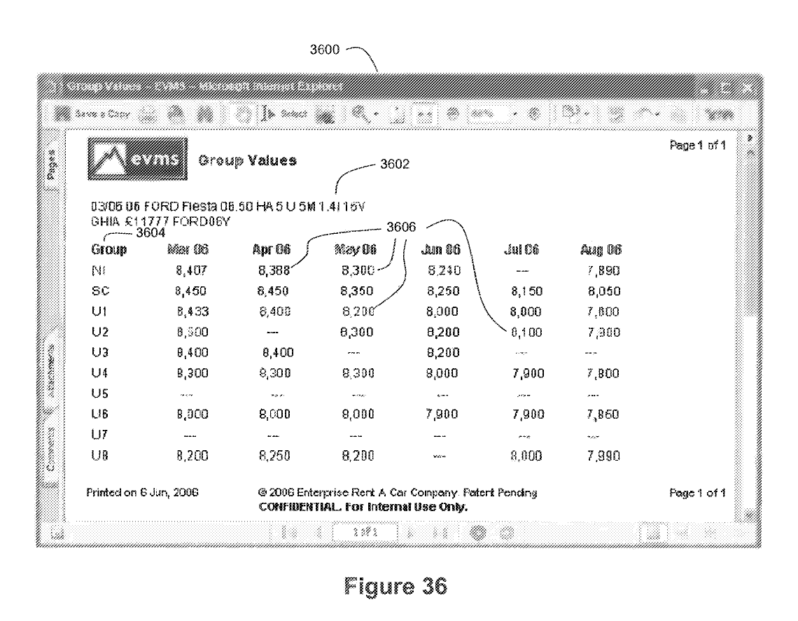

Preferably, page 3500 also includes a column 3518, which includes a plurality of links 3520 that are user-selectable to display page 3600 of FIG. 36. FIG. 36 depicts a page 3600 that identifies how other groups 3604 within the fleet management entity have estimated the residual values 3606 for the vehicle type defined in area 3602 (wherein the vehicle type in area 3602 should correspond to the vehicle type sharing the row in which the “compare” link 3520 was selected in their respective fleets). Thus, through links 3520, the user can view how other groups within the fleet management entity have estimated the residual values for like-categorized vehicles. This feature can be helpful in not only increasing the accuracy with which the user estimates future values, but it can also help fleet managers spot any potential regional differences in vehicle values. For example, through this feature, a fleet manager might learn that vehicles of a certain type have a higher residual value in one area of the country than another, which may motivate the fleet manager to encourage one-way rental for vehicles of that type such that they end up being dropped-off in the area where its residual value is highest. It should also be noted that for specific vehicles with certain “buy types”, as denoted by flags 3508 in column 3504, such a cross-group residual value comparison may not be needed, because of the special considerations that apply to certain buy types of vehicles. For example, with buyback and leased vehicles, residual value need not be estimated as those vehicles already have pre-agreed terms of repurchase/return to a manufacture or lessor once various vehicle milestones have been reached. Once the user has entered the residual value estimates in fields 3522, he/she can save those entries into the database 100 upon selection of the “save changes” button 3524.

FIG. 37 depicts an exemplary ODP page 3700 for user entry of distributed deletions for vehicles within the defined fleet. Page 3700 can be displayed upon user selection of tab 3210. Section 3702 of page 3700 provides the user with various forms of information pertaining to distributing vehicle deletions across a time period (e.g., across several months). Column 3704 organizes the data by a vehicle category as defined by the filter parameters displayed in section 3104. Items 3730 in column 3704 identify a vehicle make and model, while items 3708 identify lower vehicle specification levels (e.g., different trim levels) within that make/model. If the user selects one of the triangular icons adjacent one of the vehicle detail levels 3708, a subtree that lists still lower vehicle specification levels (including possibly specific unit vehicles) 3710 within that level 3708 will be displayed.

Row 3706 of section 3702 lists the planned deletions for the vehicle fleet defined by the country/group and vehicle class identified in section 3104, as determined by previous user interaction with a “Delete Plan” page. Row 3706 provides not only a total number of vehicle deletions to spread out across a specified time period (column 3718), but also itemized deletions for different intervals within the time period (see the columns within section 3726 which specify planned deletions per month). Row 3740 of section 3702 identifies the total vehicle counts and deletion counts for the vehicles defined by all of the filter parameters in section 3104.

Section 3712 lists fleet quantity data for the different vehicle categories in a manner similar to that of FIG. 35. Of note, the “ineligible” and “eligible” columns 3714 and 3716 provide helpful information to the user to identify how many vehicles in the applicable category are eligible for deletion. To determine which vehicles are eligible for deletion, a set of business rules can be maintained by the fleet management application 102. These business rules are then applied against data stored in database 102 to make these eligibility determinations. Examples of such rules may be rules that make a vehicle ineligible for deletion until it has been driven a certain number of miles or until it has been owned a certain length of time. To help drive such rules, vehicle data in the database 100 that pertain to vehicle odometer readings and dates vehicle purchases are queried. Other rules to govern eligibility status can be user-defined rules that process one or more data characteristics of the vehicles in the fleet to assess eligibility. For example, a rule could specify that a rental vehicle must have been in “rental service” for X number of months to be “eligible”, such “rental service” will require more than just determining a vehicle's age; the processing will also need to determine for how long the vehicle was actually in rental service (e.g., excluding time spent inactive while undergoing maintenance, repairs, etc.).

Through fields 3732 (and 3734 for any listed vehicle units 3710 (preferably buyback vehicles and leased vehicles within a detail level are listed individually on page 3700), the user can specify how many of each vehicle category are to be deleted during a given future month. To aid this process, section 3728 preferably displays each month's forecasted depreciation for each vehicle category. These depreciation values are preferably normalized to the 15^{th} of each month and computed based on the vehicle type's normalized cost basis and their user-defined residual values from page 3500.

Section 3702 also preferably includes a column 3722 dedicated to “flex” vehicles. The flex vehicle count in column 3722 for row 3706 is defined via user-entries in the “Delete Plan” page. Through fields 3734, the user can define how many vehicles within the listed vehicle categories should be denominated as “flex” vehicles. Vehicles flagged as “flex” vehicles will be counted by the fleet management application toward the total number of deletions to distribute across the fleet (see column 3718). Upon completion of desired data entry on page 3700, the user preferably saves the information to database 100 via selection of the “save changes” button 3736.

FIG. 38 depicts an exemplary CGF page 3800 for user entry of deletion counts per vehicle category for vehicles within the defined fleet. A user of the fleet management system can use the CGF page 3800 for short-term decision making with respect to deletions, whereas the ODP page can be used for longer-term decision making with respect to deletions. Page 3800 can be displayed upon user selection of tab 3212. Column 3804, rows 3806 and 3840, and vehicle categories 3830, 3808 and 3810 operate in a like manner to those of column 3704, rows 3706 and 3740, and vehicle categories 3730, 3708 and 3710 of FIG. 37. Similarly, the columns within fleet quantity section 3812 operates in a like manner to section 3712 of FIG. 37.

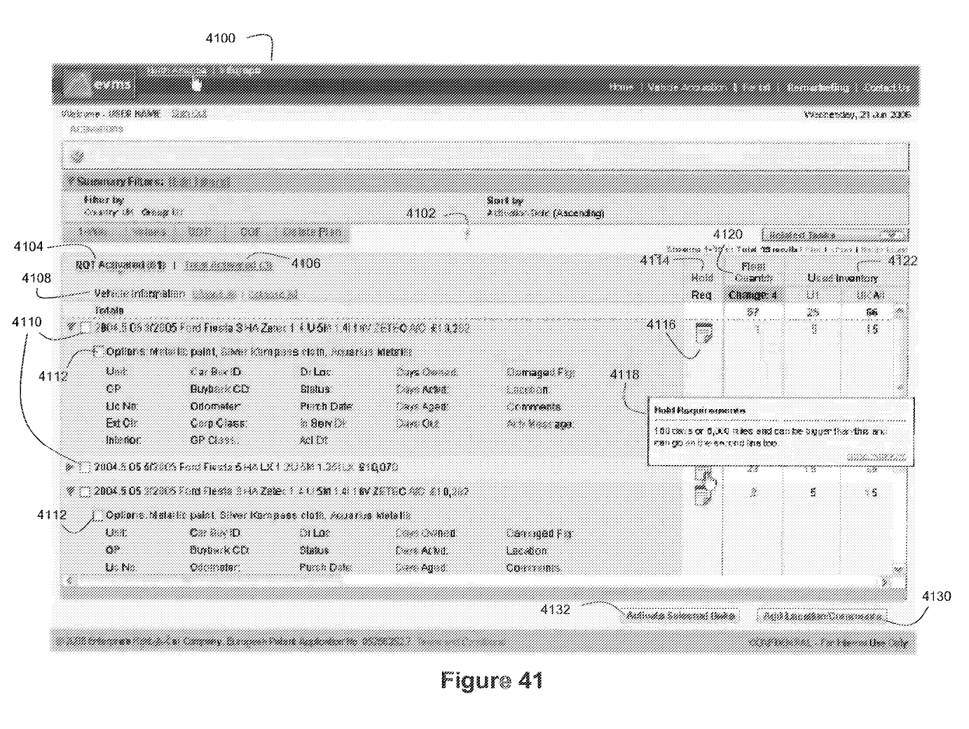

Section 3814 provides the user with activation data for the different vehicle categories. The counts in “no” column 3816 identify how many eligible vehicles with each category have not been activated for deletion. The counts in “yes” column 3818 identify how many eligible vehicles with each category have been activated for deletion. The counts in “today” column 3820 identify how many eligible vehicles with each category have been activated for deletion on the same day as the current day (the “today” counts in column 3820 should be a subset of the “yes” counts in column 3818). The counts in the “yes” and “no” columns 3818 and 3816 are preferably displayed as user-selectable links to an activations page 4100 such as that shown in FIG. 41.

Section 3822 provides the user with data about the used car inventory for the defined country/group. Column 3822 lists vehicle counts for used cars within the defined country/group on a per vehicle category basis, while column 3824 lists vehicle counts for used cars within the defined country on a per vehicle category basis. By displaying the data in section 3822 to the user, the user can take into account existing used vehicle inventories when making deletion decisions, thereby allowing the fleet manager to avoid overloading the used vehicle market with too many of the same vehicle types.

Column 3828 identifies the total number of vehicle deletions that need to be distributed across the different vehicle categories, while column 3832 identifies whether the deletions specified in column 3828 will cause the fleet to exceed or fall below the projected fleet quantity needs.

Column 3834 serves to identify the flex vehicle counts for the different vehicle categories in a like manner to that of column 3722 of FIG. 37. Through fields 3848, the user can specify how many vehicles should be designated as flex vehicles for each listed make and model and/or lower level of vehicle detail.

Section 3836 provides the user with CGF data for the different vehicle categories over a specified time span (e.g., across several months). CGF data for the listed vehicle categories (preferably at the trim level) are displayed in section 3838. The CGF values can be computed as the month-to-month differences in estimated residual values for the subject vehicle types. With the aid of this CGF data, the user can specify via fields 3842 a count of vehicles to be deleted from the fleet for each category over the specified time period. Once the user has completed these entries, he/she can select the “save changes” button 3850 to save the specified deletion counts to the database 100.

In some instances, the fleet database 100 may not have any CGF data stored because pertinent vehicle residual value forecasts have not yet been entered into the system. In such situations, section 3838 preferably displays “No Value Entered” (NVE) links 3846 when no CGF data exists for a given vehicle category in a given time period.

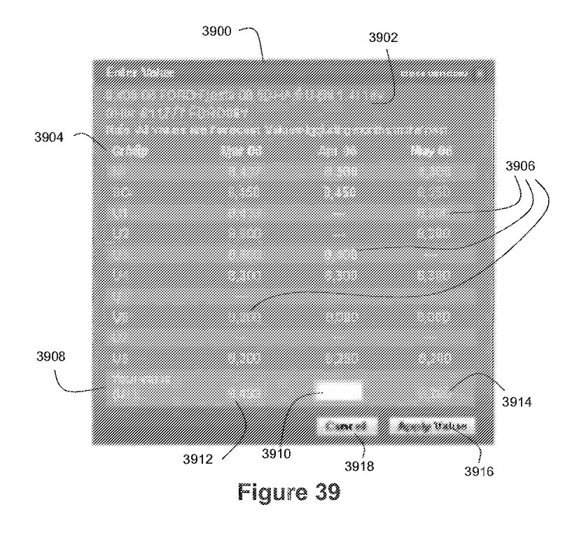

User selection of one of the NVE links 3846 can be effective to display the popup window 3900 of FIG. 39. Window 3900 identifies how other groups 3904 within the fleet management entity have forecasted residual values 3906 for the vehicle category 3902 in question for some interval of time periods before and after the time period for which no residual value data exists (e.g., one month before and one month after the month for which the residual value estimation is missing). Window 3900 also preferably includes a section 3908 in which the user is notified of how the specified group has forecasted the residual values 3912 and 3914 for the vehicle category 3902 in question before and after the time period in question. Thus, with the aid of the information displayed in window 3900, through field 3910, the user can enter an informed estimate of the residual value for the vehicle category 3902 for the missing time period. Upon user selection of the “apply value” button 3916, this residual value estimate can be saved in database 100. Once this information is saved to the database, page 3800 can be updated such that CGF data is displayed in place of the selected NVE link 3846. Alternatively, the user can cancel any data entry in field 3910 via selection of the “cancel” button 3918.

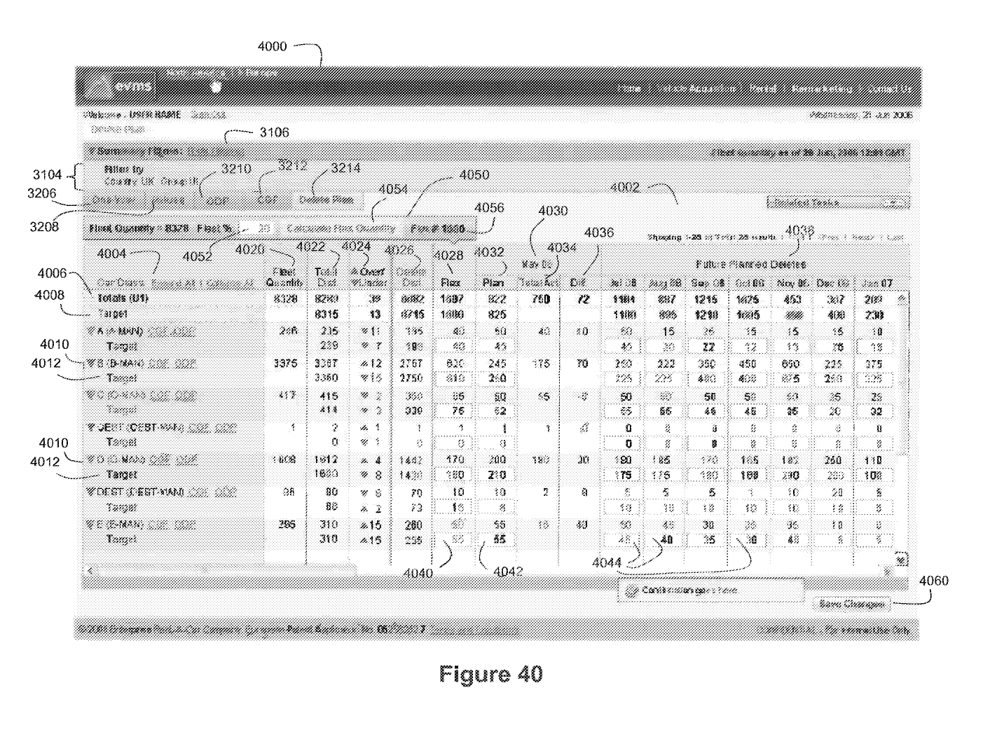

FIG. 40 depicts an exemplary Delete Plan page 4000 for user entry of planned deletions per vehicle class for vehicles within the defined fleet. Page 4000 can be displayed upon user selection of tab 3214. Section 4002 lists a variety of information for the different vehicle classes 4010 identified in the vehicle class column 4004. Also included in section 4002 is a row 4006 for showing country/group totals within the defined fleet, and a row 4008 for showing the planned target quantities of the different types of information. Columns within section 4002 include column 4020 for identifying fleet quantities for the different vehicle classes, column 4022 for identifying the total number of distributed deletions for the different vehicle classes (inclusive of both actual activations and flex vehicles), column 4024 for identifying whether the fleet quantities are over or under their respective targets in view of the applicable fleet plan, column 4026 for identifying counts of vehicle deletions to be distributed across a time period (this total will not include flex vehicles), and a column 4028 for identifying the counts of flex vehicles within the vehicle classes (the entries in columns 4026 and 4028 for each row should sum to equal the entry in column 4022). Section 4030 identifies the planned deletion activities for the current month, wherein column 4032 identifies the planned number of deletions, column 4034 identifies the current total number of actual activations, and column 4036 identifies the difference between the planned number of deletions and the actual number of activations (wherein a positive number indicates that the user may want to activate more vehicles for deletion and wherein a negative number indicates that the user may want to deactivate some of the previously activated vehicles).

Section 4038 identifies the planned number of deletions for different intervals across a future time period (e.g., monthly). Each vehicle class row 4010 can be accompanied by a row 4012 for target data applicable to that vehicle class. Accordingly, each target row 4012 preferably includes fields 4044 within section 4038 through which the user can specify an actual number of activations to be made. The target rows 4012 also preferably include fields 4040 in the flex column 4028 for entering a count of flex vehicles (which will count against distributed deletions without needing to actually activate the flex vehicles for deletion from the rental fleet) as well as fields 4042 for entering a planned number of deletions.

Page 4000 preferably includes a flex vehicle calculator 4050. This section of page 4000 preferably identifies the current fleet quantity and includes a field 4052 for user entry of a percentage of the total fleet to be designated as flex vehicles. After user entry of the percentage in field 4052, user selection of the “Calculate Flex Quantity” button 4054 is effective to display a count 4056 of flex vehicles for the fleet based on the specified percentage being applied to the fleet population. This flex vehicle quantity can then be compared by the user with the flex count for the fleet in column 4028, row 4006 to see how closely the flex count matches a desired flex percentage. The flex calculator section 4050 thus serves as an efficient tool through which the user can quickly define a desired amount of flex vehicles for the specified fleet. Row 4006 lists the total counts for the specified country/group across the columns of page 4000, and row 4008 identifies the target counts for the specified country/group across the columns of page 4000.

Once the user has entered the desired vehicle counts in the deletion fields 4044, the user can select the “save changes” button to save the entries into database 100.

Upon user selection of a link within columns 3816 or 3818 from page 3800, the activations page 4100 of FIG. 41 can be displayed. From page 4100, the user can specify individual vehicles for activation through data entry within section 4102. Links 4104 and 4106 can be selected by the user to toggle between lists of activated vehicles and lists of non-activated vehicles within the defined fleet. Link 4104 preferably identifies a count of vehicles within the defined fleet that are unactivated but eligible for activation, and link 4106 preferably identifies a count of vehicles within the defined fleet that have already been activated. Within vehicle information column 4108, entries 4110 in section 4102 identify vehicle categories that can be selected by the user for activation via their adjacent checkboxes. In this example, vehicles are listed at the trim level, wherein vehicles at the unit level 4112 within each trim level can be displayed upon user selection of the triangular icon adjacent each entry 4110. Upon drilling down to the unit level, column 4108 preferably identifies various fields of data pertaining to each individual rental vehicle, as shown in FIG. 41. Page 4100 also preferably displays the hold requirements for each vehicle or vehicle category in column 4114. The hold requirements correspond to the requirements that govern whether a given vehicle is eligible for activation. By hovering the cursor over a hold requirement icon 4116 within column 4114, a popup window 4118 that displays the hold requirements applicable to the pertinent vehicle/vehicle category can be displayed. In this manner, the user can identify whether a given vehicle should be activated.

Column 4120 identifies the quantities of the different vehicle categories listed in column 4108. Section 4122 includes columns for identifying the used vehicle inventory of the country and country/group for the listed vehicle categories.

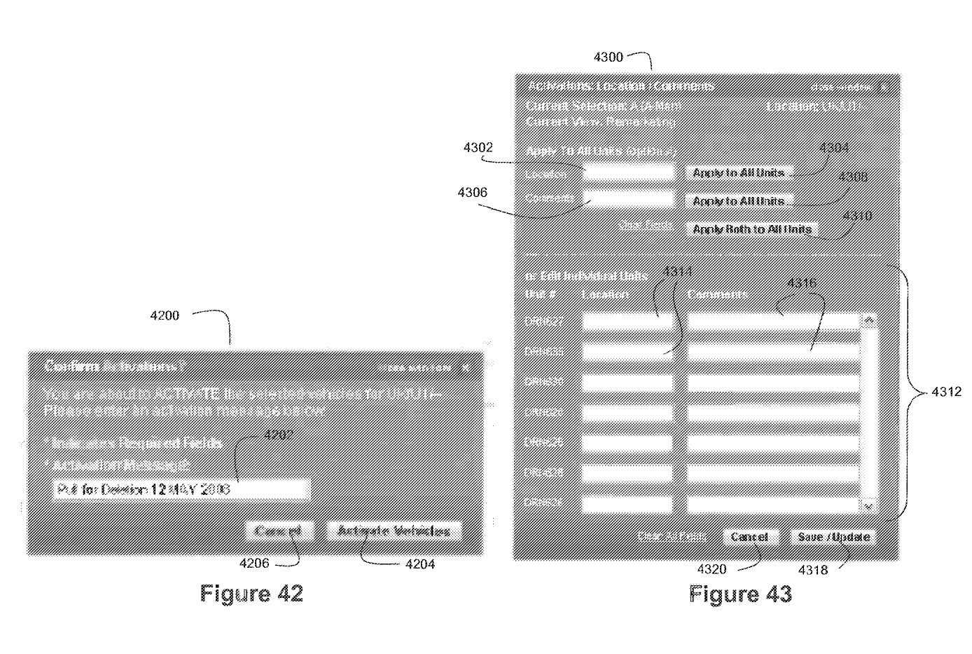

Upon user selection of a vehicle (or vehicles) for activation, the user can select the “Activate Selected Units” button 4132 if he/she desires notify the database of which units are to be pulled from the fleet. Also, upon user selection of a vehicle (or vehicles) for activation, the user can select the “Add Location/Comments” button 4130 if he/she desires to communicate additional information to the database 100 for use when activating the specified vehicle(s). Selection of button 4130 can cause either of popup windows 4200 (of FIG. 42) or 4300 (of FIG. 43) to be displayed. Preferably, window 4200 is displayed if only one vehicle has been selected for activation, while window 4300 is displayed if multiple vehicles have been selected for activation.

With respect to window 4200 of FIG. 42, the user can add an activation message for the vehicle through field 4202. For example, if it is deemed urgent to pull the vehicle from the fleet as soon as possible, the user can add a message to the activation to that effect. After entry of the activation message, the user can save the message and activate the vehicle by selecting the “activate vehicles” button 4204; otherwise he/she can cancel any message entry by selecting the “cancel” button 4206.

With respect to window 4300 of FIG. 43, the user can add a location and/or activation message to any or all of the vehicles identified for activation. In the location field, the user can identify the last known branch location where the vehicle in question resides, which can aid subsequent attempts to identify where the vehicle is located when it comes time to actually physically remove the vehicle from the fleet. To apply a location to all vehicles scheduled for activation through page 4100, the user can enter the location information in field 4302 and select the “Apply to All Units” button 4304. To apply a message to all vehicles scheduled for activation through page 4100, the user can enter the location information in field 4306 and select the “Apply to All Units” button 4308. To apply both a location and message to all vehicles scheduled for activation through page 4100, the user can enter the appropriate information in fields 4302 and 4306, followed by selection of button 4310. If the user wishes to apply individualized messages to the different vehicles scheduled for activation, he/she can do so via section 4312, wherein fields 4314 and 4316 are provided for each activated vehicle to specify a location and message respectively therefor. User selection of the “cancel” button 4320 will be effective to cancel data entries within window 4300, while user selection of the “save/update” button 4318 will be effective to save the entered location(s)/message(s) to the database 100.

According to yet another aspect of a preferred embodiment of the invention, the fleet management system is preferably configured with the capability to track post-vehicle purchase activities that will affect the unit cost basis for vehicles within the fleet. By virtue of such tracking, fleet managers can further optimize their decisions as to when vehicles should be pulled from the rental fleet for sale on the used vehicle market. One example of post-purchase events that can affect the cost basis for a vehicle can be found in Ireland. As previously noted, in Ireland, reclaims can be made at various points throughout a vehicle's life with respect to the government-imposed VRT. Thus, at different points in time following a vehicle's purchase in Ireland, what effectively amounts to tax refunds are paid to the vehicle purchaser. By tracking how many refunds have been received for a given vehicle and (optionally) when those refunds are due, the fleet management system can better inform fleet managers when vehicles should be pulled from the rental fleet. For example, if a vehicle is only one month away from receiving a 2^{nd} VRT reclaim, then the fleet manager may well want to keep that vehicle in the fleet for another month to obtain the refund and thereby reduce the cost basis therefor, even though the vehicle may otherwise be ready for activation.

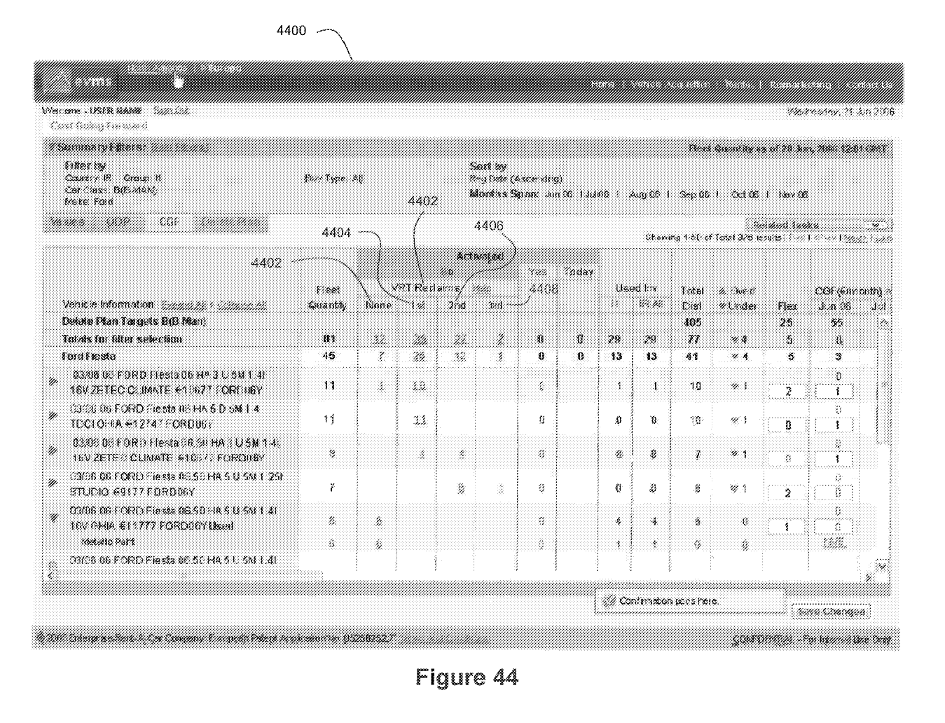

To implement such a tracking functionality in the system, the fleet management application 102 preferably includes a set of business rules that define when each vehicle is eligible for a VRT reclaim. Database 100 also preferably includes a sufficient amount of vehicle information for each vehicle subject to the VRT so that determinations as to VRT reclaim eligibility can be made. In this light, the CGF page 4400 for the system, as used in Ireland and shown in FIG. 44, can include a section 4402 dedicated to tracking VRT reclaim activity, including a column 4402 that identifies how many vehicles in the listed vehicle categories have not yet received any VRT reclaims, a column 4404 that identifies how many vehicles in the listed vehicle categories have received only a first VRT reclaim, a column 4406 that identifies how many vehicles in the listed vehicle categories have received only a first and second VRT reclaim, and a column 4408 that identifies how many vehicles in the listed vehicle categories have received the first three VRT reclaims. Preferably, the other pages in the fleet management workflow will also notify the user of such information, including how close each vehicle is to its next VRT reclaim.

While the present invention has been described above in relation to its preferred embodiment, various modifications may be made thereto that still fall within the invention's scope, as would be recognized by those of ordinary skill in the art upon review of the teachings herein. For example, while the preferred embodiment is concerned primarily with rental vehicles, the present invention can also be practiced in connection with calculating normalized historical sales prices and CGFs for leased vehicles. Also, while YMMS serves as convenient criteria for distinguishing between different vehicle types in North America, when dealing with fleets located in countries outside North America, other criteria could be useful. For example, in the United Kingdom, effective criteria would include registration year, registration letter, make, model, spec year, trim, engine size, horsepower, series, gearbox, fuel type, etc. In Ireland, effective criteria would include registration year, spec year, make, model, trim, engine size, horsepower, series, gearbox, fuel type, etc. In Germany, effective criteria would include registration year, spec year, make, model, series, engine size, kilowatts, trim, gearbox, fuel type, etc. Further still, it is worth noting that different countries may have different factors (such as taxing practices) that affect values such as original cost or replacement costs for vehicles. Also, it is worth noting that the display tables described herein that are arranged in rows and columns can be inverted such that what is disclosed herein as being included in rows is displayed in columns, and vice versa, as would be readily understood by those having ordinary skill in the art. Furthermore, while the residual values described herein can be user-defined, it should be noted that software can also be configured to automatically compute residual value estimates for future months based on the historical sales data. In such instances, these system-generated residual values can be displayed to the user and optionally the user can be given the opportunity to adjust these system-generated residual values if the user's business judgment feels that an adjustment should be made. As such, the full scope of the present invention is to be defined solely by the appended claims and their legal equivalents.

Appendix A

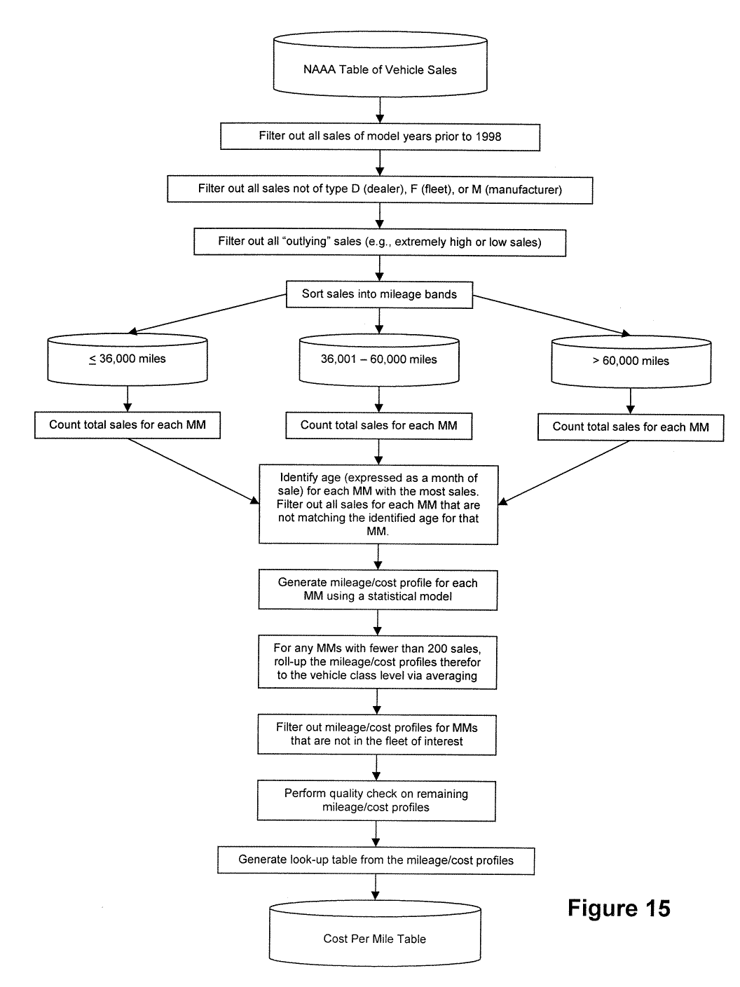

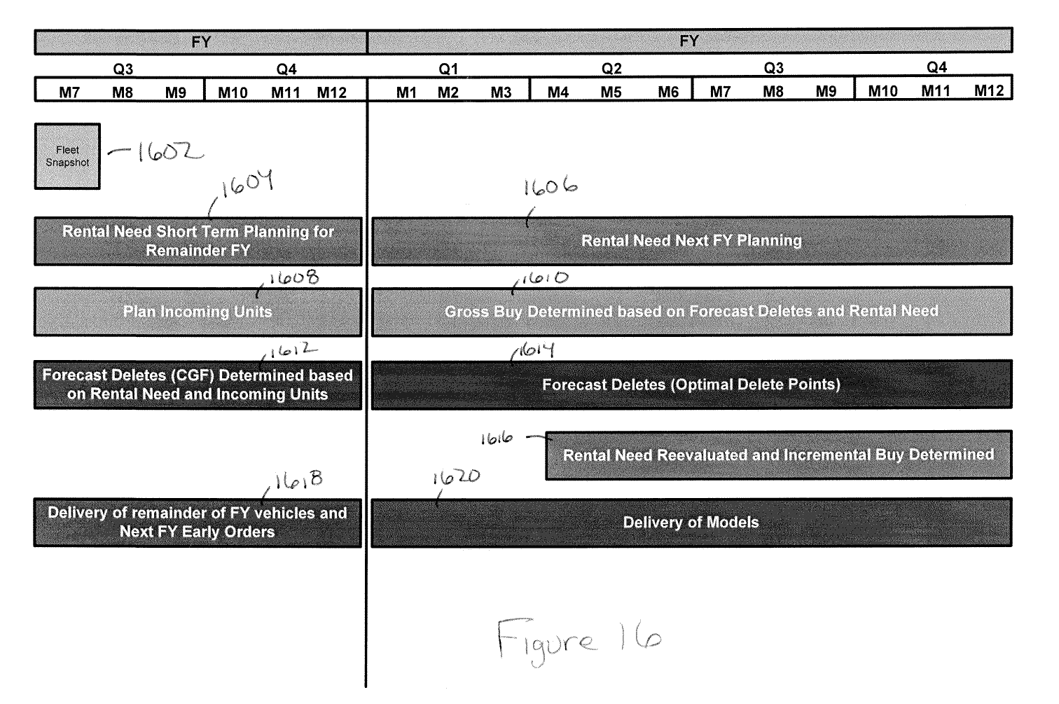

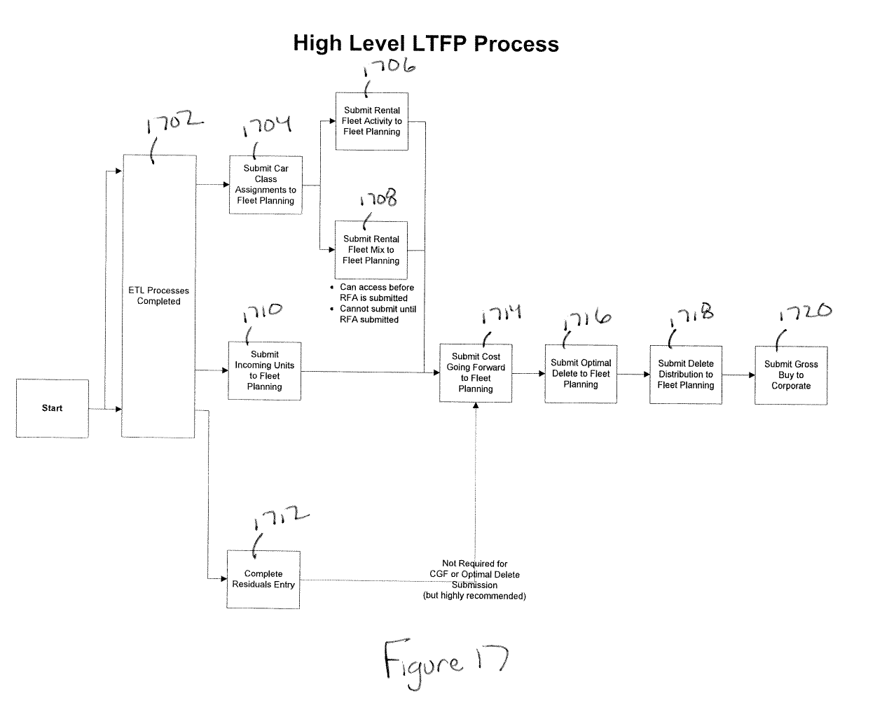

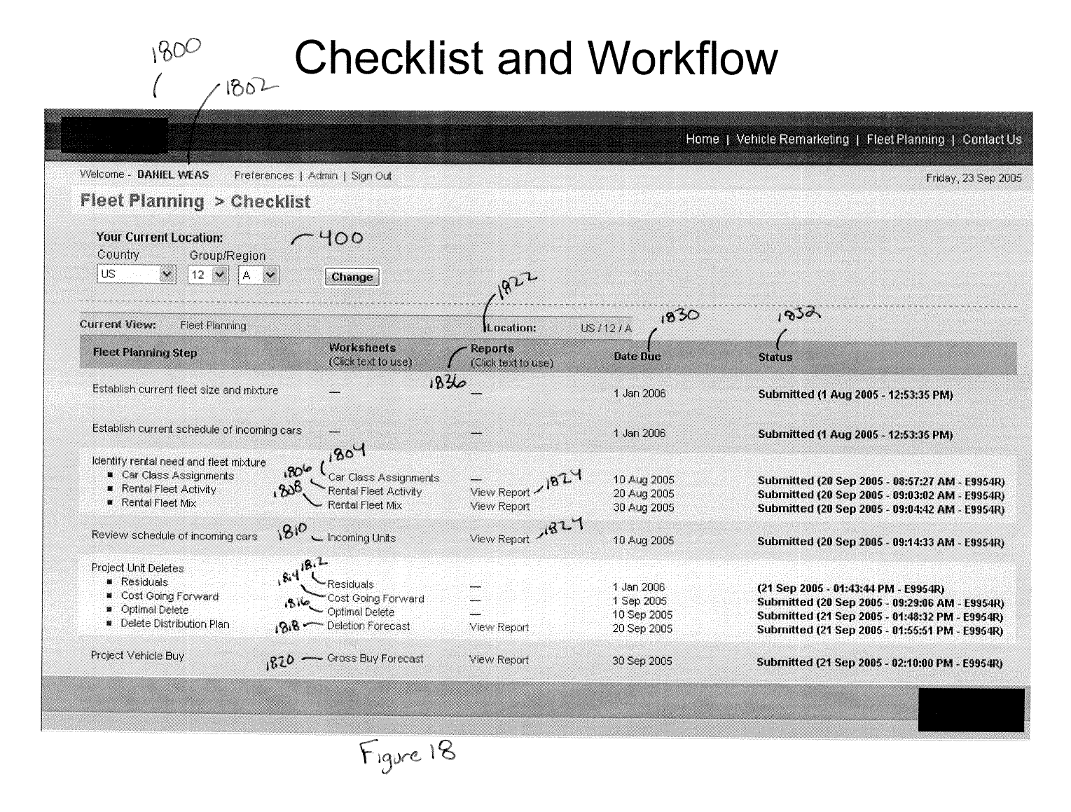

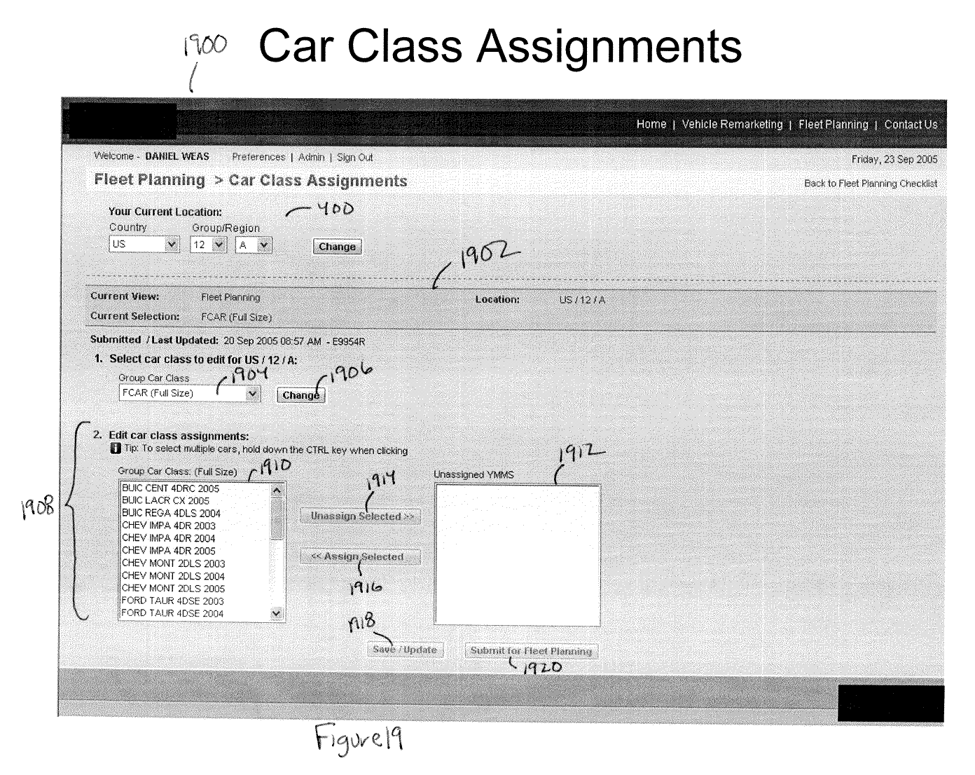

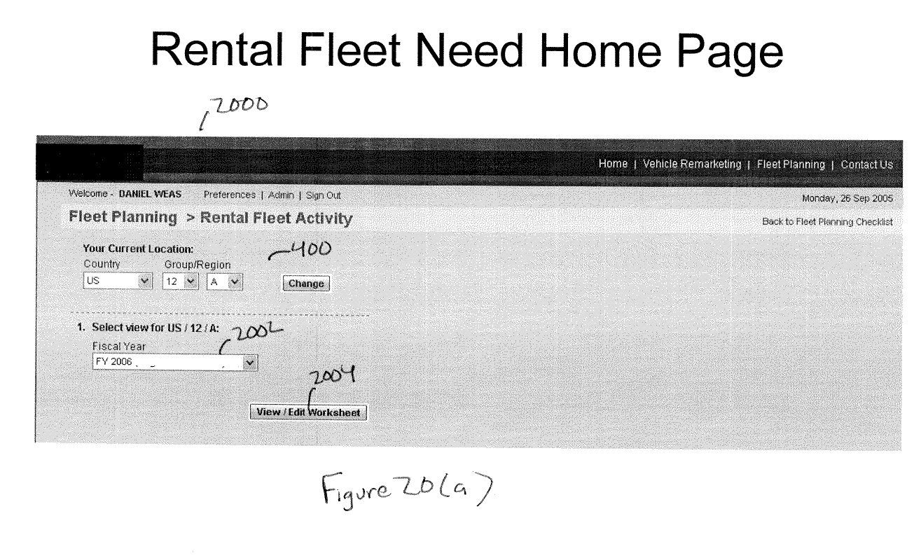

This appendix describes a preferred technique for creating a cost per mile table. FIG. 15 depicts a flowchart for this process. In order to build the tables containing the vehicle values at different mileage bands, the following steps are performed:
1. Pull vehicle sales data from a database of vehicle sales supplied by providers such as NAAA (via NADA) and/or other industry sources.
2. Filter for sales for model years 1998 and later.
3. Filter for sales type of D (dealer), F (fleet) or M (manufacturer).
4. Filter to remove outlying data such as extremely high or low sale prices.
5. Construct three mileage bands:
   1) Less than or equal to 36,000 miles
   2) 36,001-60,000 miles
   3) More than 60,000 miles
Sort sales data into the three mileage bands.
6. Count total sales in each mileage band at the make model (MM) level.
7. Identify the age (expressed as a month) of each MM with the most sales. These months are used in step 8 when generating the mileage profile for the MM.
8. For each MM within each mileage band, and for the determined month's sales, fit a statistical model where sales price is regressed on linear splines of mileage, indicators of the month sold, indicators of model years, and indicators of series to arrive at values for β₀, β₁, β₂, β₃, δₖ, γₖ, and λₖ. β₀ is a general reference level parameter. β₁, β₂, and β₃ are estimated mileage band adjustment parameters. The parameter δₖ is an adjustment parameter estimated from the pertinent sales data to adjust the level of the average sales price for month k (month k being within the sales months applicable to a particular MM). The parameter γₖ is an adjustment parameter estimated from the pertinent sales data to adjust the level of the average sales price for series k (series k being within the various series applicable to a particular MM), and wherein λₖ is an adjustment parameter estimated from the pertinent sales data to adjust the level of the average sales price for model year k (model year k being within the model years applicable to a particular MM). This statistical model is an additive model with no interaction terms. From this fit, a mileage profile is generated where the month is fixed as mentioned in the previous step. Using the values determined for β₀, β₁, β₂, β₃, δₖ, γₖ, and λₖ, a Mean_Sales_Price can be determined for a given mileage for each MM in accordance with the statistical model. A preferred statistical model is as follows for a given MM, wherein parameters β₀, β₁, β₂, β₃, δₖ, γₖ, and λₖ are estimated by minimizing the least squares error, I is the indicator function, the notation (miles-36000)₊ denotes the positive part of the expression inside the parentheses:

$$Mean\_Sales \_Price = {β}_{0} + {β}_{1} \times miles + {β}_{2} \times {( miles - 36000 )}_{+} + {β}_{3} \times {( miles - 60000 )}_{+} + {\sum }_{{month}_{k}} {δ}_{k} \times {I}_{{month}_{k}} ( month ) + {\sum }_{{series}_{k}} {γ}_{k} \times {I}_{{series}_{k}} ( series ) + {\sum }_{{model\_yr}_{k}} {λ}_{k} \times {I}_{{model\_yr}_{k}} ( model\_yr )$$
See Neter, John and Wasserman, William, Applied Linear Statistical Models, Richard Irwin, Inc., 1974 for a discussion of the statistical techniques used in this step.
9. Identify any MMs with fewer than 200 sales. For such MMs, rollup its sales data to rollup the MM's mileage profile to the vehicle class level by averaging over the profiles of the MMs with sufficient data (more than 200 per mm) sharing that vehicle class.
10. Identify all individual MM in the fleet of interest.
11. Associate the generated mileage profiles for each MM/vehicle class and each mileage band with the MMSs in the current fleet.
12. Perform quality checks on the profiles whose MM matches a MM in the fleet of interest. This quality check includes checking that the mileage profile is montonically decreasing (by identifying positive mileage coefficients) and identifying any unusually steep slopes (by identifying outlying mileage coefficients compared to coefficients associated with similar make models), checking whether the profiles extends across all mileage bands.
13. From these MMs and vehicle classes, generate the look up table for fleet MMSs containing the mileage profiles.
14. If necessary, consult with remarketing personnel for advice on mapping unusual vehicle classes to a vehicle class such that sufficient data is available for the regressions.

What is claimed is:

1. A system for managing a fleet, the fleet comprising a plurality of rental vehicles, the system comprising:
a database in which vehicle data is stored, at least a portion of the stored vehicle data corresponding to rental vehicles currently within the fleet;
a computer in communication with the database, the computer being configured to execute a software program in response to user input, the software program being configured to (1) provide a plurality of user interface screens that are configured to receive user input regarding scheduling vehicles for deletion from the fleet, (2) retrieve vehicle data from the database that corresponds to one-way rental activity for rental vehicles within the fleet, (3) determine a quantity of rental vehicles that have been added to the fleet over a predetermined time period as a result of the one-way rental activity, (4) determine a quantity of rental vehicles that have left the fleet over the predetermined time period as a result of the one-way rental activity, and (5) display the determined quantities on at least one of the user interface screens.

2. The system of claim 1 wherein the software program is further configured to define which vehicles belong to the fleet based at least in part upon user input.

3. The system of claim 2 wherein the software program is further configured to determine the quantities for a plurality of different vehicle categories.

4. The system of claim 3 wherein the software program is further configured to define the different vehicle categories based at least in part upon user input.

5. The system of claim 4 wherein the different vehicle categories comprise a plurality of different vehicle classes.

6. The system of claim 4 wherein the different vehicle categories comprise a plurality of different vehicle makes and models.

7. The system of claim 4 wherein the different vehicle categories comprise a plurality of different vehicle makes, models, and trim levels.

8. The system of claim 1 wherein the software program is further configured to adjust a total quantity of rental vehicles in the fleet based on the determined quantities.

9. The system of claim 8 wherein the software program is further configured to designate a plurality of rental vehicles for deletion from the fleet based at least in part upon user input.

10. The system of claim 2 wherein the software program is further configured to identify and display on at least one of the user interface screens a first subquantity and a second subquantity, the first subquantity comprising a count of how many vehicles within the determined quantity of rental vehicles that have been added to the fleet over a predetermined time period as a result of the one-way rental activity have already been activated for deletion from the fleet, the second subquantity comprising a count of how many vehicles within the determined quantity of rental vehicles that have left the fleet over the predetermined time period as a result of the one-way rental activity have been already been activated for deletion from the fleet.

11. A computer-implemented method for managing a fleet, the fleet comprising a plurality of rental vehicles, the method comprising:
storing vehicle data corresponding to rental vehicles currently within the fleet;
retrieving stored vehicle data that corresponds to one-way rental activity for rental vehicles within the fleet;
processing the retrieved data to (1) determine a quantity of rental vehicles that have been added to the fleet over a predetermined time period as a result of the one-way rental activity and (2) determine a quantity of rental vehicles that have left the fleet over the predetermined time period as a result of the one-way rental activity; and
displaying a plurality of user interface screens that interface a user with a software application that is configured to accept user input regarding scheduling vehicles for deletion from the fleet, wherein at least one of the user interface screens is configured to display the determined quantities thereon.

12. The method of claim 11 wherein the quantity determining steps comprise determining the quantities for a plurality of different vehicle categories.

13. The method of claim 12 further comprising:
defining the different vehicle categories based at least in part upon user input.

14. The method of claim 12 further comprising:
designating a plurality of rental vehicles for deletion from the fleet in response to user input through at least one of the user interface screens.

15. The method of claim 12 further comprising identifying and displaying on the at least one user interface screen a first subquantity and a second subquantity, the first subquantity comprising a count of how many vehicles within the determined quantity of rental vehicles that have been added to the fleet over a predetermined time period as a result of the one-way rental activity have already been activated for deletion from the fleet, the second subquantity comprising a count of how many vehicles within the determined quantity of rental vehicles that have left the fleet over the predetermined time period as a result of the one-way rental activity have been already been activated for deletion from the fleet.

16. A system for managing a fleet, the fleet comprising a plurality of vehicles, the system comprising:
a database in which vehicle data is stored, at least a portion of the stored vehicle data corresponding to vehicles currently within the fleet;
a computer in communication with the database, the computer being configured to execute a software program in response to user input, the software program being configured to (1) display a plurality of user interface screens that are configured to receive user input regarding scheduling vehicles for deletion from the fleet, (2) through at least one of the user interface screens, accept user input corresponding to a plurality of parameters for defining which vehicles for which vehicle data is stored in the database belong to the fleet, (3) retrieve vehicle data from the database corresponding to the vehicles belonging to the fleet defined by the plurality of user-specified parameters, and (4) display at least a subset of the retrieved vehicle data on at least one of the user interface screens.

17. The system of claim 16 wherein at least one of the parameters comprises a regional designation.

18. The system of claim 17 wherein at least one of the parameters comprises a vehicle category.

19. The system of claim 18 wherein the vehicle category comprises a vehicle class.

20. The system of claim 16 wherein at least one of the parameters comprises a vehicle buy type.

21. The system of claim 16 wherein the software program is further configured to (1) accept user input that defines how the retrieved vehicle data is to be organized for display on the user interface screen, (2) organize the retrieved vehicle data for display on the basis of the accepted user input, and (3) display at least a subset of the retrieved vehicle data on the user interface screen in accordance with the user-specified organization.

22. A computer-implemented method for managing a fleet, the fleet comprising a plurality of vehicles, the method comprising:
storing vehicle data corresponding to vehicles currently within the fleet;
accepting user input corresponding to a plurality of parameters for defining which vehicles for which vehicle data is stored in the database belong to the fleet;
retrieving vehicle data from the database corresponding to the vehicles belonging to the fleet defined by the plurality of user-specified parameters; and
displaying at least a subset of the retrieved vehicle data on a user interface screen, wherein the user interface screen is part of a set of user interface screens that are configured to receive user input regarding scheduling vehicles for deletion from the fleet.

23. The method of claim 22 wherein at least one of the parameters comprises a regional designation.

24. The method of claim 23 wherein at least one of the parameters comprises a vehicle category.

25. The method of claim 24 wherein the vehicle category comprises a vehicle class.

26. The method of claim 24 wherein at least one of the parameters comprises a vehicle buy type.

27. The method of claim 22 further comprising:
accepting user input that defines how the retrieved vehicle data is to be organized for display on the user interface screen;
organizing the retrieved vehicle data for display on the basis of the accepted user input; and
displaying at least a subset of the retrieved vehicle data on the user interface screen in accordance with the user-specified organization.

28. A system for managing a fleet, the fleet comprising a plurality of vehicles, the system comprising:
a database in which vehicle data is stored, at least a portion of the stored vehicle data corresponding to vehicles currently within the fleet, wherein a subset of the vehicles within the fleet are not eligible for sale as a used vehicle due to at least one pre-existing agreement, and wherein another subset of the vehicles within the fleet are eligible for sale as a used vehicle;
a computer in communication with the database, the computer being configured to execute a software program in response to user input, the software program being configured to apply a plurality of business rules to the stored vehicle data to determine which vehicles within the fleet are eligible for sale as a used vehicle and which vehicles within the fleet are not eligible for sale as a used vehicle due to the at least one pre-existing agreement.

29. The system of claim 28 wherein the software program is further configured to display data indicative of the eligibility determinations on a user interface screen.

30. The system of claim 29 wherein the user interface screen is part of a set of user interface screens that are configured to receive user input regarding scheduling vehicles for deletion from the fleet.

31. The system of claim 30 wherein the software program is further configured to define which vehicles belong to the fleet based at least in part upon user input.

32. The system of claim 31 wherein at least one of the business rules is based at least in part upon a vehicle mileage requirement to govern whether any vehicles are eligible or ineligible for sale as a used vehicle.

33. The system of claim 31 wherein at least one of the business rules is based at least in part upon a vehicle age requirement to govern whether any vehicles are eligible or ineligible for sale as a bused vehicle.

34. The system of claim 28 wherein the fleet comprises a fleet of rental vehicles.

35. A computer-implemented method for managing a fleet, the fleet comprising a plurality of vehicles, the method comprising:
storing vehicle data corresponding to vehicles currently within the fleet, wherein a subset of the vehicles within the fleet are not eligible for sale as a used vehicle due to at least one pre-existing agreement, and wherein another subset of the vehicles within the fleet are eligible for sale as a used vehicle; and
applying a plurality of business rules to the stored vehicle data to determine which vehicles within the fleet are eligible for sale as a used vehicle and which vehicles within the fleet are not eligible for sale as a used vehicle due to the at least one pre-existing agreement.

36. The method of claim 34 further comprising:
displaying data indicative of the eligibility determinations on a user interface screen.

37. The method of claim 36 wherein the user interface screen is part of a set of user interface screens that are configured to receive user input regarding scheduling vehicles for deletion from the fleet.

38. The method of claim 35 further comprising:
defining which vehicles belong to the fleet based at least in part upon user input.

39. The method of claim 35 wherein at least one of the business rules is based at least in part upon a vehicle mileage requirement to govern whether any vehicles are eligible or ineligible for sale as a used vehicle.

40. The method of claim 35 wherein at least one of the business rules is based at least in part upon a vehicle age requirement to govern whether any vehicles are eligible or ineligible for sale as a bused vehicle.

41. The method of claim 35 wherein the fleet comprises a fleet of rental vehicles.

42. A system for managing a fleet, the fleet comprising a plurality of vehicles, the system comprising:
a database in which vehicle data is stored, at least a portion of the stored vehicle data corresponding to vehicles currently within the fleet;
a computer in communication with the database, the computer being configured to execute a software program in response to user input, the software program being configured to (1) accept user input to designate a plurality of vehicles within the fleet as flex vehicles, and (2) accept user input to designate a quantity of vehicles to be deleted from the fleet and sold as a used vehicle, wherein the quantity includes the vehicles that have been designated as flex vehicles.

43. The system of claim 42 wherein the software program is further configured to accept the user input on a vehicle category basis.

44. The system of claim 42 wherein the fleet comprises a fleet of rental vehicles.

45. A computer-implemented method for managing a fleet, the fleet comprising a plurality of vehicles, the system comprising:
storing vehicle data corresponding to vehicles currently within the fleet;
accepting user input to designate a plurality of vehicles within the fleet as flex vehicles; and
accepting user input to designate a quantity of vehicles to be deleted from the fleet and sold as a used vehicle; and
wherein the quantity includes the vehicles that have been designated as flex vehicles.

46. The method of claim 44 further comprising accepting the user inputs on a vehicle category basis.

47. The method of claim 44 wherein the fleet comprises a fleet of rental vehicles.

48. A system for managing a fleet, the fleet comprising a plurality of vehicles, the system comprising:
a database in which vehicle data is stored, at least a portion of the stored vehicle data corresponding to vehicles currently within the fleet, wherein the fleet includes a plurality of different subfleets;
a computer in communication with the database, the computer being configured to execute a software program in response to user input, the software program being configured to (1) display a user interface screen that is configured to accept user input corresponding to a plurality of residual value estimates for at least one vehicle category within one of the subfleets, wherein this user interface screen includes a user-selectable link, (2) in response to user selection of the user-selectable link, display another user interface screen that lists a plurality of residual value estimates stored in the database for like-categorized vehicles within a plurality of the different subfleets, and (3) store residual value estimates in the database in response to user input.

49. The system of claim 48 wherein the user interface screens are part of a set of user interface screens that are configured to receive user input regarding scheduling vehicles for deletion from the fleet.

50. The system of claim 49 wherein the software program is further configured to display the interface screen such that a plurality of residual value estimate entry fields are organized by a vehicle category.

51. The system of claim 50 wherein the software program is further configured to display the interface screen such that the plurality of residual value estimate entry fields are organized by a plurality of user-specified vehicle categories.

52. The system of claim 49 wherein the another user interface screen is further configured to accept user input corresponding to at least one residual value estimate for a vehicle within the one of the subfleets.

53. The system of claim 49 wherein the plurality of different subfleets are geographically separated.

54. A computer-implemented method for managing a fleet, the fleet comprising a plurality of vehicles, the method comprising:
storing vehicle data corresponding to vehicles currently within the fleet, wherein the fleet includes a plurality of different subfleets;
displaying a user interface screen that is configured to accept user input corresponding to a plurality of residual value estimates for at least one vehicle category within one of the subfleets, wherein this user interface screen includes a user-selectable link;
in response to user selection of the user-selectable link, displaying another user interface screen that lists a plurality of residual value estimates stored in the database for like-categorized vehicles within a plurality of the different subfleets, and
storing the residual value estimates in a database in response to user input.

55. The method of claim 54 wherein the user interface screens are part of a set of user interface screens that are configured to receive user input regarding scheduling vehicles for deletion from the fleet.

56. The method of claim 55 wherein the user interface displaying screen comprises displaying the user interface screen such that a plurality of residual value estimate entry fields are organized by a vehicle category.

57. The method of claim 56 wherein the user interface displaying screen comprises displaying the user interface screen such that the plurality of residual value estimate entry fields are organized by a plurality of user-specified vehicle categories.

58. The method of claim 55 further comprising:
accepting user input through the another user interface screen corresponding to at least one residual value estimate for a vehicle within the one of the subfleets.

59. The method of claim 53 wherein the plurality of different subfleets are geographically separated.

60. A system for managing a fleet, the fleet comprising a plurality of vehicles, the system comprising:
a database in which vehicle data is stored, at least a portion of the stored vehicle data corresponding to vehicles currently within the fleet, wherein the vehicle data includes data corresponding to post-purchase events for at least a subset of the vehicles;
a computer in communication with the database, the computer being configured to execute a software program in response to user input, the software program being configured to determine whether a cost of continued ownership for any of the vehicles for which vehicle data is stored in the database has changed as a result of the stored data corresponding to post-purchase vehicle events.

61. The system of claim 60 wherein software program is further configured to display a user interface screen, the user interface screen displaying data indicative of whether the cost of continued ownership for any of the vehicles for which vehicle data is stored in the database has changed as a result of the stored data corresponding to post-purchase vehicle events, and wherein the user interface screen is part of a set of user interface screens that are configured to receive user input regarding scheduling vehicles for deletion from the fleet.

62. The system of claim 61 wherein the post-purchase events comprise vehicle-specific tax refunds which can be obtained after a vehicle has reached at least one milestone.

63. The system of claim 62 wherein the vehicle-specific tax refunds comprise reclaims for an Irish VRT.

64. The system of claim 62 wherein the software program is further configured to display a user interface screen that identifies how many vehicles within the fleet have received at least one vehicle-specific tax refund.

65. A computer-implemented method for managing a fleet, the fleet comprising a plurality of vehicles, the method comprising:
storing vehicle data corresponding to vehicles currently within the fleet, wherein the vehicle data includes data corresponding to post-purchase events for at least a subset of the vehicles; and
determining whether a cost basis for any of the vehicles for which vehicle data is stored in the database has changed as a result of the stored data corresponding to post-purchase vehicle events.

66. The method of claim 65 wherein the post-purchase events comprise vehicle-specific tax refunds which can be obtained after a vehicle has reached at least one milestone.

67. The method of claim 66 wherein the vehicle-specific tax refunds comprise reclaims for an Irish VRT.

68. The method of claim 66 further comprising displaying a user interface screen that identifies how many vehicles within the fleet have received at least one vehicle-specific tax refund.
